(19) United States
(12) Patent Application Publication
(10) Pub. No.: US 2016/0321406 A1
(43) Pub. Date: Nov. 3, 2016

(54) High-Risk Medication Monitoring

(71) Applicant: McKesson Corporation, San Francisico, CA (US)

(72) Inventors: Elke Timmerman, Atlanta, GA (US); Kristina Crockett, Atlanta, GA (US); Roger G. Pinsonneault, Alpharetta, GA (US)

(21) Appl. No.: 14/700,587

(22) Filed: Apr. 30, 2015

(51) Int. Cl. G06F 19/00; H04L 12/58

(52) U.S. Cl. CPC G06F 19/326; G06F 19/328; G06F 19/3456; H04L 51/24

(57) ABSTRACT

Systems, methods, and computer-readable media are provided for determining patient eligibility for one or more types of sponsored healthcare services and providing notifications thereof. An example healthcare service is high-risk medication monitoring. A program sponsor may provide an indication of a high-risk prescription drug in connection with which a patient may be eligible for medication monitoring. The program sponsor may also provide an indication of an alternative prescription drug that may be used for treating the same health condition for which the high-risk drug is used. Upon receipt of a healthcare claim transaction that includes a claims processor identifier associated with program sponsor and a prescription drug identifier that identifies the high-risk drug, a number of one or more prior healthcare claim transactions corresponding to dispensing of the high-risk drug to the same patient may be determined. If the number of prior healthcare claim transactions is determined to be less than a threshold number, an alert message may be generated that includes an indication of the high-risk drug, an indication of the alternative drug, and an indication that the alternative drug is available for prescribing as an alternative to the high-risk drug. The alert message may be transmitted to the healthcare provider computer from which the healthcare claim transaction was received. Subsequent healthcare claim transactions received form the healthcare provider computer may be monitored to determine whether the alternative drug was substituted for the high-risk drug.

### TECHNICAL FIELD

Embodiments of the disclosure relate generally to patient eligibility for healthcare services, and more particularly, to systems, methods and computer-readable media for determining patient eligibility for healthcare services and providing notifications of determined patient eligibility to various entities through various notification mechanisms. Embodiments of the disclosure also relate generally to systems, methods, and computer-readable media for generating patient eligibility data indicative of patient eligibility for healthcare services using claim transaction data. Embodiments of the disclosure further relate generally to systems, methods, and computer-readable media for tracking the completion of healthcare services for which patient eligibility notifications have been sent and for suppressing patient eligibility notifications.

### BACKGROUND

Pharmacists are becoming increasingly involved in the delivery of patient care. Healthcare services rendered in a pharmacy setting may be rendered in connection with healthcare service programs offered by organizations known as sponsors. A healthcare service program sponsor may be a payor or other entity that specifies the criteria for determining patient eligibility for healthcare services that are included within the sponsor's program and that may reimburse a healthcare provider for rendering a qualifying healthcare service to an eligible patient. Healthcare service program sponsors may notify patients who qualify for a healthcare service opportunity in a variety of ways such as through a notification sent in the mail, a call placed by a call center to the patient, or through delivery of an electronic or paper eligible patient file to a pharmacy.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope or applicability of the disclosure. In the drawings, the left-most digit(s) of a reference numeral identifies the drawing in which the reference numeral first appears. The use of the same reference numerals indicates similar or identical components; however, different reference numerals may be used to identify similar or identical components as well. Various embodiments may utilize element(s) and/or component(s) other than those illustrated in the drawings and some element(s) and/or component(s) may not be present in various embodiments. The use of singular terminology to describe a component or element may, depending on the context, encompass a plural number of such components or elements and vice versa.

FIG. 1 depicts an illustrative system architecture for, among other things, determining patient eligibility for a sponsored healthcare service and providing a notification of determined patient eligibility in accordance with one or more example embodiments of the disclosure.

FIGS. 2A-2C depict illustrative data flows for processing healthcare transactions in accordance with one or more example embodiments of the disclosure including, among other things, determining patient eligibility for a sponsored healthcare service and providing a notification of determined patient eligibility

FIGS. 3A-3B depict process flow diagrams of an illustrative method for generating a new healthcare service eligibility sponsor profile for a contracted healthcare service program sponsor in accordance with one or more example embodiments of the disclosure.

FIG. 4 depicts a process flow diagram of an illustrative method for editing an existing healthcare service eligibility sponsor profile for a contracted healthcare service program sponsor in accordance with one or more example embodiments of the disclosure.

FIGS. 5A-5B depict process flow diagrams of an illustrative method for associating a healthcare service eligibility sponsor program with a client profile in accordance with one or more example embodiments of the disclosure.

FIG. 6 depicts a process flow diagram of an illustrative method for modifying one or more client configuration parameters for a healthcare service eligibility sponsor program associated with a client profile in accordance with one or more example embodiments of the disclosure.

FIGS. 7A-7B depict process flow diagrams of an illustrative method for receiving patient eligibility data file(s) from a healthcare service eligibility sponsor, validating the program sponsor and data extracted from the patient eligibility data file(s), generating additional data associated with the extracted data, and storing the extracted data and the generated data in one or more data stores in accordance with one or more example embodiments of the disclosure.

FIG. 8 depicts a process flow diagram of an illustrative method for receiving updated patient eligibility data file(s) from a healthcare service eligibility sponsor, validating data extracted from the updated patient eligibility data file(s), generating additional data associated with the extracted data, and storing the extracted data and the generated data in one or more data stores in accordance with one or more example embodiments of the disclosure.

FIGS. 9A-9B depict process flow diagrams of an illustrative method for receiving a healthcare claim transaction, determining whether the transaction qualifies for a patient eligibility notification, and determining a client notification preference responsive to a determination that the transaction is a qualified transaction in accordance with one or more example embodiments of the disclosure.

FIG. 10 depicts a process flow diagram of an illustrative method for providing a patient eligibility notification to a healthcare provider as part of a pre-adjudication rejection in accordance with one or more example embodiments of the disclosure.

FIG. 11 depicts a process flow diagram of an illustrative method for providing a patient eligibility notification to a healthcare provider as part of a post-adjudication message in accordance with one or more example embodiments of the disclosure.

FIG. 12 depicts a process flow diagram of an illustrative method for providing a patient eligibility notification to a recipient designated by a healthcare provider in accordance with one or more example embodiments of the disclosure.

FIG. 13 depicts a process flow diagram of an illustrative method for determining whether a healthcare claim reversal transaction corresponds to a prior healthcare claim transaction in connection with which a patient eligibility notification was provided and performing processing responsive thereto in accordance with one or more example embodiments of the disclosure.

FIG. 14 depicts a process flow diagram of an illustrative method for determining that a patient is eligible for a healthcare service using healthcare claim transaction data corresponding to one or more healthcare claim transactions, generating an eligibility data record indicating that the patient is eligible for the healthcare service, and generating and transmitting an eligibility notification message in response to receipt of an additional healthcare claim transaction that identifies the patient in accordance with one or more example embodiments of the disclosure.

FIGS. 15A-15B depict process flow diagrams of an illustrative method for determining that a patient is eligible for medication adherence counseling using healthcare claim transaction data corresponding to a plurality of healthcare claim transactions, generating an eligibility data record indicating that the patient is eligible for the medication adherence counseling, and generating and transmitting an eligibility notification message in response to receipt of an additional healthcare claim transaction that identifies the patient in accordance with one or more example embodiments of the disclosure.

FIG. 16 depicts a process flow diagram of an illustrative method for monitoring the dispensing of a high-risk prescription drug in accordance with one or more example embodiments of the disclosure.

FIG. 17 depicts a process flow diagram of an illustrative method for initiating a patient counseling session in connection with the monitoring of the dispensing of a high-risk prescription drug, receiving a resubmitted healthcare claim transaction including an override reason code indicating a reason that an alternative prescription drug was not substituted for the high-risk prescription drug or receiving an alternative healthcare claim transaction that identifies the alternative prescription drug, and performing appropriate processing based on whether the resubmitted healthcare claim transaction or the alternative healthcare claim transaction is received in accordance with one or more example embodiments of the disclosure.

FIG. 18 depicts a process flow diagram of an illustrative method for storing an eligibility data record including patient identifying information of a patient and a description of a healthcare service for which the patient is eligible, transmitting an eligibility notification message indicating that the patient is eligible for the healthcare service, receiving a healthcare claim transaction, determining that the healthcare claim transaction corresponds to a rendering of the healthcare service to the patient, and modifying the eligibility data record to indicate that the healthcare service has been rendered to the patient in accordance with one or more example embodiments of the disclosure.

### DETAILED DESCRIPTION OF EXAMPLE EMBODIMENTS

Embodiments of the disclosure relate to systems, methods, and computer-readable media for, among other things, determining patient eligibility for a sponsored healthcare service and providing a notification of determined patient eligibility. Embodiments of the disclosure further relate to systems, methods, and computer-readable media for generating healthcare service eligibility sponsor profiles corresponding to healthcare service sponsor programs and specifying various parameters for each sponsor profile relating to the types of healthcare services included in the sponsor's program, the types of patient information that may be utilized to determine patient eligibility, and so forth. Embodiments of the disclosure still further relate to systems, methods, and computer-readable media for generating client profiles corresponding to healthcare providers that have contracted with a service provider to receive patient eligibility notifications for sponsored healthcare services, associating healthcare service sponsor programs with the client profiles, and configuring the associated sponsor programs based on configuration parameters specified by the clients.

As used herein, the term “client” may refer to a healthcare provider organization that provides healthcare services and that has contracted with a service provider to receive or direct the receipt of notifications of patient eligibility for healthcare service opportunities available under a healthcare service sponsor program. A client may include, but is not limited to, a collection of pharmacies (e.g., a pharmacy chain under the same corporate umbrella), a pharmacy group purchasing organization (GPO), a pharmacy software vendor, a physician's clinic, a hospital or hospital system, and so forth. The terms “client” and “financial sponsor” may be used interchangeably herein.

As used herein, the term “sponsor” may refer to an organization that establishes and/or manages a healthcare service sponsor program and that potentially reimburses healthcare providers for rendering healthcare services covered under the sponsor's healthcare service program. The terms “sponsor,” “healthcare service sponsor,” “healthcare service eligibility sponsor,” and variations thereof, may be used interchangeably herein. Various types of healthcare services may be covered under a sponsor's program including, but not limited to, comprehensive medication review (CMR), drug regimen review (DRR), medication regimen review (MRR), MTM services, targeted medication review (TMR), and so forth. Healthcare services, as that term is used herein, may further include any of variety of monitoring or messaging services that may be provided by a service provider system including, but not limited to, cash prescription monitoring, immunization messaging, medication adherence monitoring (e.g., refill adherence monitoring), high-risk medication monitoring, end stage renal disease (ESRD) messaging, hospice coordination of benefits, prescription fraud and abuse monitoring, and so forth. Any of the aforementioned monitoring or messaging services may include services performed by a healthcare provider (e.g., a pharmacist) based on notifications or other messages received by a healthcare provider system from the service provider system. It should be appreciated that the aforementioned types of healthcare services are merely illustrative and not exhaustive.

In accordance with one or more example embodiments of the disclosure, methods for determining patient eligibility for a sponsored healthcare service and providing a notification of patient eligibility to a healthcare provider or other recipient designated by the healthcare provider are provided. In various example embodiments, the methods may be implemented, at least in part, by a service provider system associated with a service provider. The service provider system may be further configured to perform a wide variety of functions associated with the routing of healthcare transactions and adjudicated responses thereto between healthcare providers and claims processors. In certain example embodiments, methods disclosed herein may be implemented, at least in part, by a healthcare service eligibility determination module which may include any suitable combination of hardware and/or software module(s) configured to performing processing in connection with the disclosed methods. In various example embodiments, the healthcare service eligibility determination module may be communicatively coupled to the service provider system via one or more networks, and may perform desired processing at the request or instruction of the service provider system. In other example embodiments, the healthcare service eligibility determination module may form at least part of the service provider system.

The service provider system may include one or more processing units that may be provided across any number of computing devices in accordance with any suitable configuration. The service provider system may further include at least one memory provided across any number of computing devices and storing computer-executable instructions that, when executed by at least one of the one or more processing units, causes operations of methods to be performed in accordance with example embodiments of the disclosure. For example, in certain example embodiments, the service provider system may be a distributed processing system in which one or more processors of one or more computing devices may execute computer-executable instructions to perform a respective one or more operations of a method disclosed herein in a distributed manner. It should be appreciated that the service provider system may further include any of a variety of other hardware or software components such as, for example, data stores, communication links, network interfaces, input/output interfaces, networking devices, and so forth. Further, in accordance with one or more example embodiments of the disclosure, one or more computer-readable media may be provided that store computer-executable instructions that, when executed by one or more processing units, cause operations of a method disclosed herein to be performed. It should be noted that any processing described as being performed by a service provider computer may be performed, at least in part, in a distributed manner by multiple service provider computers forming part of a service provider system. Further, any such processing may be performed, at least in part, by a healthcare service eligibility determination module that may form part of the service provider system. Similarly, any processing described as being performed by the healthcare service eligibility determination module may be performed, at least in part, by a service provider computer, or in a distributed manner by multiple service provider computers forming part of a service provider system.

A method in accordance with one or more example embodiments of the disclosure may include receiving a healthcare transaction from a healthcare provider computer on behalf of a healthcare provider; determining, based at least in part on information included in the healthcare transaction, that the healthcare transaction meets one or more qualifying criteria for a healthcare service sponsor program; identifying at least one patient identifier included in the healthcare transaction; accessing patient eligibility data associated with the healthcare service sponsor program; determining, based at least in part on the at least one patient identifier and the patient eligibility data, that a patient identified by the at least one patient identifier is eligible for at least one type of healthcare service associated with the healthcare service sponsor program; generating a patient eligibility notification, wherein the patient eligibility notification indicates eligibility of the patient for the at least one type of healthcare service; and directing transmission of the patient eligibility notification to the healthcare provider computer or another entity designated by the healthcare provider.

In one or more example embodiments of the disclosure, a notification preference associated with the healthcare provider may be determined and the patient eligibility notification may be generated based at least in part on the determined notification preference. The notification preference may be a pre-adjudication rejection of the healthcare transaction, a post-adjudication message appended to or otherwise associated with the adjudicated reply to the healthcare transaction, a combination of a pre-adjudication rejection and a post-adjudication message, a notification communicated to a third party recipient designated by the healthcare provider, and so forth. It should be appreciated that the above examples of notification preferences are merely illustrative and not exhaustive. It should further be appreciated that processing described herein as being performed by a device or module (e.g., a service provider computer, the healthcare service eligibility determination module, etc.) may be performed responsive to execution of computer-executable instructions stored on or forming part of the device or module.

In one or more example embodiments, a service provider computer may receive a healthcare transaction from a healthcare provider computer on behalf of a healthcare provider. Upon receipt of the healthcare transaction, the service provider computer and/or the healthcare service eligibility determination module may perform processing to determine whether information included in the healthcare transaction satisfies one or more qualifying criteria for a healthcare service sponsor program.

The qualifying criteria may include whether the transaction is formatted in accordance with an appropriate standard (e.g., a National Council for Prescription Drug Programs (NCPDP) Telecommunication Standard); whether the transaction is a billing transaction (which may be determined, for example, based on a transaction code included in the transaction); whether the healthcare provider on whose behalf the transaction was submitted has contracted with the service provider to receive patient eligibility notification services (which may be determined, for example, based on a healthcare service provider ID included in the transaction); whether the transaction is qualified for one or more third party payor plans (which may be determined, for example, based on a Bank Identification Number (BIN Number), BIN Number and a Processor Control Number (PCN), or a BIN Number and Group ID identifying a claims processor and included in the transaction); whether the transaction qualifies for the sponsor program's date of service range (which may be determined, for example, based on a comparison of a date of service identified from an appropriate field in the transaction to stored information indicative of a date of service range associated with the sponsor program); and so forth.

The qualifying criteria may additionally, or alternatively, include whether the sponsor program has been linked to or is otherwise associated with a client profile that corresponds to the healthcare provider. For example, a client profile may include one or more data records, data files, etc. that specify various client identifying information and that further specify those sponsor programs for which the client has contracted with a service provider to receive patient eligibility notification services and/or for which the client has been authorized to render healthcare services covered under the sponsor program. A sponsor program may be associated with a client profile by storing an identifier of the sponsor and/or the sponsor program (e.g., a sponsor ID) and various client configured parameters for the sponsor program in one or more same data records or one or more data records that are linked to one or more data records storing the client profile that includes an identifier of the client (e.g., a client ID). In certain example embodiments, although the client may have contracted with the service provider to receive patient eligibility notifications in connection with certain sponsor programs, the healthcare transaction may nonetheless be assessed with respect to all sponsor programs for which healthcare service eligibility sponsors have contracted with the service provider to provide patient eligibility notification services. It should be appreciated that the above examples of qualifying criteria are merely illustrative and not exhaustive.

If it is determined, based on the above-described processing performed by the service provider computer and/or the healthcare service eligibility determination module, that the claim transaction fails to satisfy qualifying criteria for any sponsor program with respect to which the transaction is assessed, the healthcare service eligibility determination processing may halt, and the transaction may be routed to an appropriate claims processor for adjudication. On the other hand, if it is determined that the transaction satisfies applicable qualifying criteria for one or more sponsor programs, the healthcare service eligibility determination processing may continue with processing to determine whether information included in the healthcare transaction indicates that patient eligibility criteria for one or more of the qualified sponsor programs is satisfied. The term “qualified sponsor program” may be used herein to refer to a sponsor program associated with qualifying criteria satisfied by a healthcare transaction.

As part of such processing, the service provider computer and/or healthcare service eligibility determination module may identify patient information and, optionally, claims processor information included in the received healthcare transaction and compare the information identified from the claim transaction to data extracted from patient eligibility file(s) received from program sponsors and stored in one or more data stores. For example, in certain example embodiments, such as those in which a program sponsor is also a claims processor, a BIN Number and optionally a PCN or Group ID; a cardholder identifier (e.g., a cardholder ID) assigned by the claims processor to the patient; and a person code may be identified from data fields in the healthcare transaction and compared to stored patient eligibility data to determine whether a match exists.

More specifically, in certain example embodiments, the BIN Number (and optionally the PCN) identified from the healthcare transaction may be compared to a BIN Number (and optionally a PCN or Group ID) stored in each sponsor profile corresponding to each qualified sponsor program. If a match is found for a particular sponsor profile, the Cardholder ID or Cardholder ID and Person Code identified from the healthcare transaction may be compared against Cardholder IDs or Cardholder IDs and Person Codes included in the patient eligibility data associated with the sponsor profile to determine if a match exists. If a match is found, it may be determined that the patient identified in the healthcare transaction is also identified in the patient eligibility data associated with the sponsor profile, and thus, that the patient is eligible for one or more types of healthcare services included in the sponsor program to which the sponsor profile corresponds.

It should be appreciated that any of a variety of types of patient identifying information may be identified from the healthcare transaction and compared to patient eligibility data to determine whether a patient match can be detected. For example, a patient name (e.g., first and/or last name), patient address information (e.g., zip code), a patient's date of birth, or any other suitable patient identifying information may be used in addition to, or as an alternative to, the patient identifying information discussed earlier. In certain example embodiments, such as those in which a program sponsor is not a payor or claims processor for an insurance plan under which the patient is covered, and thus, does not have access to a patient's cardholder ID, various types of patient information identified from the healthcare transaction may be compared against corresponding types of patient information included in the patient eligibility data of sponsor profiles to determine if a match exists. As a non-limiting example, the patient's last name, date of birth, and address zip code may be identified from the healthcare transaction and compared to corresponding data types in patient eligibility data of sponsor profiles associated with qualified sponsor programs. In certain example embodiments, probabilistic matching algorithms or techniques may be employed as various types of patient identifying information may be non-unique to a particular patient.

If a patient match is detected for any particular sponsor program, further data comparisons may be performed to determine whether the healthcare transaction satisfies other eligibility criteria for the sponsor program. For example, a date of service may be identified from the healthcare transaction and compared to a patient initiation date, a patient termination date, and/or a patient opportunity due date identified in the patient eligibility data included in or linked to the sponsor profile corresponding to the sponsor program. The patient initiation date may correspond to the date on which the patient became eligible for one or more healthcare services associated with the sponsor program. The patient termination date (if applicable) may correspond to the date on which the patient ceased being eligible for one or more healthcare services associated with the sponsor program. A patient opportunity due date may correspond to a date by which a particular healthcare service should be rendered to a patient in order to be eligible for reimbursement under the sponsor program. In certain example embodiments, if it is determined that the date of service identified from the healthcare transaction is greater than or equal to the patient initiation date, less than or equal to a patient termination date, and less than or equal to a patient opportunity due date, the patient may be determined to be eligible for the corresponding type of healthcare service offered under the sponsor program. It should be appreciated that the above-described data comparisons and eligibility criteria are merely illustrative and not exhaustive, and that any suitable information identified from the healthcare transaction may be compared to any suitable corresponding types of information included in patient eligibility data to determine whether patient eligibility criteria are met.

In certain example embodiments, the healthcare transaction may satisfy patient eligibility criteria for multiple sponsor programs. In such example embodiments, the service provider computer and/or the healthcare service eligibility determination module may perform further processing to identify a highest priority sponsor program. The highest priority sponsor program may be identified based at least in part on configuration parameters specified in a stored client profile associated with the healthcare provider. In certain example embodiments, a patient eligibility notification may be generated and communicated to the healthcare provider computer from which the healthcare transaction is received (or a third party recipient designated by the healthcare provider) in connection with only the highest priority sponsor program. In other example embodiments, one or more patient eligibility notifications may be generated and communicated for multiple sponsor programs with patient eligibility criteria met by the healthcare transaction, potentially in order of priority assigned to the sponsor programs.

Upon determining that the healthcare transaction satisfies patient eligibility criteria for a sponsor program, the service provider computer and/or the healthcare service eligibility determination module may perform further processing to determine a client notification preference for receiving the patient eligibility notification. The client notification preference may be specified as a configuration parameter in the client profile, and as previously noted, may correspond to a pre-adjudication rejection, a post-adjudication message appended or otherwise associated with an adjudicated reply, a pre-adjudication rejection in combination with a post-adjudication message, a message communicated to a recipient designated by the client, or any other suitable notification mechanism.

In those example embodiments in which the client's notification preference is a pre-adjudication rejection, the service provider computer and/or the healthcare service eligibility determination module may generate a claim transaction rejection that may include a rejection code and a patient eligibility notification message that identifies a type of healthcare service for which the patient is eligible (e.g., CMR) and optionally additional information such as an access token. The access token may be an identifier that uniquely identifies the combination of the particular eligible patient and the specific healthcare service opportunity for which the patient is eligible. A configuration parameter (e.g., a Boolean variable) associated with the sponsor profile corresponding to the sponsor program may determine whether an access token is to be included in the patient eligibility notification message. In certain example embodiments, an employee of the healthcare provider (e.g., a pharmacist, pharmacy employee, prescriber, etc.) may access a healthcare application and utilize the access token to locate information associated with the specific healthcare service opportunity identified by the access token. The user application may be further utilized to input information relating to rendering of the healthcare service to the patient and, potentially, to generate a healthcare transaction for the rendered healthcare service. The pre-adjudication rejection may further include override information such as an override code that may be included in a resubmitted healthcare transaction received from the healthcare provider computer in order to bypass healthcare service eligibility determination processing in connection with the resubmitted healthcare transaction.

Upon delivery of the claim transaction rejection to the healthcare provider computer, the service provider computer and/or the healthcare service eligibility determination module may perform processing to store data indicating that the patient eligibility notification was generated and communicated. The stored data may include an identifier of the healthcare provider (e.g., a healthcare service provider ID), patient identifying information (e.g., cardholder ID, patient name, person code, address information, contact information, etc.), an identifier of the sponsor (e.g., a sponsor ID), data indicative of the type of sponsor (e.g., a pharmacy benefit manager (PBM)), data indicative of the type of notification (e.g., pre-adjudication rejection), a date and/or time the notification was sent, and so forth. It should be appreciated that the above-described information that is captured in relation to the patient eligibility notification is merely illustrative and not exhaustive.

Upon receipt of the pre-adjudication rejection by the healthcare provider computer, an employee of the healthcare provider may identify the patient eligibility notification included therein. In particular, the type of healthcare service identified in the notification may be identified. The healthcare provider computer may then generate, potentially responsive to user input, a resubmission of the healthcare transaction that includes the override code provided in the received claim transaction rejection. The resubmitted healthcare transaction may be transmitted by the healthcare provider computer and received by the service provider computer. Upon receipt of the resubmitted healthcare transaction, the service provider computer and/or the healthcare service eligibility determination module may identify the override code included in the resubmitted healthcare transaction, bypass the healthcare service eligibility determination processing, perform any desired pre-processing on the claim transaction, and route the transaction to an appropriate claims processor for adjudication. Upon receipt of the adjudicated reply, the service provider computer may perform optional post-processing on the adjudicated reply and communicate the adjudicated reply to the healthcare provider computer.

In those example embodiments in which the client notification preference is a post-adjudication message, healthcare service eligibility determination processing similar to that described above may be performed to identify one or more sponsor programs having qualifying criteria met by the healthcare transaction, and for any such qualified sponsor program that is identified, to determine whether the healthcare transaction satisfies patient eligibility criteria for the qualified sponsor program. If it is determined that a patient identified in the received healthcare transaction is eligible for one or more types of healthcare services offered under a sponsor program, a patient eligibility notification message may be appended to or otherwise associated with an adjudicated reply to the healthcare transaction, and the adjudicated reply and the eligibility notification may be communicated to the healthcare provider computer.

In particular, in one or more example embodiments in which it is determined that the client notification preference is a post-adjudication message, the healthcare transaction may be routed by the service provider computer to an appropriate claims processor computer for adjudication. Upon receipt of the adjudicated reply, the service provider computer and/or the healthcare service eligibility determination module may append the patient eligibility notification to the adjudicated reply and communicate the adjudicated reply and the notification to the healthcare provider computer. In certain example embodiments, the service provider computer and/or healthcare service eligibility determination module may determine whether the adjudicated reply indicates that the claim transaction was approved or denied and transmit the patient eligibility notification is the transaction was approved.

As previously noted with respect to the example embodiment in which the client notification preference is a pre-adjudication rejection, the patient eligibility notification message that is appended to or otherwise associated with the adjudicated reply may include an identification of a type of healthcare service for which the patient is eligible (e.g., TMR) and optionally additional information such as an access token. Further, upon delivery of the patient eligibility notification and adjudicated reply to the healthcare provider computer, the service provider computer and/or the healthcare service eligibility determination module may perform processing to store data indicating that the patient eligibility notification was generated and communicated. The stored data may include any of the types of data previously described through reference to the pre-adjudication rejection example embodiment discussed above.

In other example embodiments, a client notification preference may specify that a patient eligibility notification is to be delivered as part of both a pre-adjudication rejection and a post-adjudication message appended to an adjudicated reply. In still other example embodiments, a client notification preference may specify that the patient eligibility notification is to be delivered to a third party recipient designated by the healthcare provider. The third party recipient may be identified by a configuration parameter specified as part of a client profile, within the healthcare transaction, or via any other suitable mechanism. In those example embodiments in which the patient eligibility notification is to be communicated to a designated third party recipient, the notification may be delivered as part of an e-mail message, a message delivered to a pharmacy call center, or via any other suitable mechanism.

In certain example embodiments, the service provider computer may receive a healthcare claim reversal transaction (e.g., a billing reversal). Upon receipt of the healthcare claim reversal transaction, the service provider computer and/or the healthcare service eligibility determination module may perform processing to determine whether the reversal transaction satisfies one or more qualifying criteria. The qualifying criteria may include, but are not limited to, whether the reversal transaction is formatted in accordance with an appropriate standard (e.g., a NCPDP Telecommunication Standard); whether the reversal transaction is for a billing reversal request (which may be determined, for example, based on a transaction code included in the reversal transaction); whether the healthcare provider on whose behalf the reversal transaction was submitted has contracted with the service provider to receive patient eligibility notification services (which may be determined, for example, based on a healthcare provider ID included in the reversal transaction); whether the reversal transaction is qualified for one or more third party payor plans (which may be determined, for example, based on a BIN Number, and optionally a PCN and/or a Group ID included in the reversal transaction); and so forth.

If it is determined that the reversal transaction satisfies applicable qualifying criteria, a further determination may be made as to whether claim transaction reversals are tracked. Responsive to a positive determination, the service provider computer and/or the healthcare service eligibility determination module may perform processing to determine whether the reversal transaction corresponds to a previously submitted healthcare claim transaction. More specifically, various information included in the reversal transaction may be identified (e.g., a BIN Number, an identifier associated with the healthcare provider such as a healthcare provider ID, an identifier associated with a prescription product or healthcare service such as a National Drug Code (NDC), a fill number, a date of service, etc.) and compared against data included in previously received healthcare claim transactions in connection with which patient eligibility notifications were sent to determine whether any such healthcare claim transaction includes information that matches the information identified from the reversal transaction. In various example embodiments, a threshold may be specified for determining whether a match exists (e.g., a number of matching data fields). In certain example embodiments, probabilistic matching may be utilized.

If it is determined that the reversal transaction matches a previously received healthcare claim transaction for which a patient eligibility notification was sent, data may be stored in association with the client profile and/or the sponsor profile (e.g., as one or more data records included in or linked to the client profile or the sponsor profile) indicating that a reversal transaction has been received for a corresponding claim transaction in connection with which a patient eligibility notification was sent. The data may be stored in association with or otherwise linked to the patient via patient identifying information (e.g., patient demographic information, cardholder ID, an identifier assigned by the service provider system to the patient, etc.). In certain example embodiments, a subsequent patient eligibility notification for the same patient may be sent with greater frequency (e.g., upon receipt of the next healthcare transaction that meets applicable qualifying criteria and patient eligibility criteria) in those scenarios in which a reversal transaction is received for a previous healthcare claim transaction for which a patient eligibility notification was sent as compared to those scenarios in which a reversal transaction is not received.

In various example embodiments of the disclosure, upon receipt of a patient eligibility notification by a healthcare provider computer, an employee of a healthcare provider (e.g., a pharmacist, a prescriber, etc.) may render the healthcare service identified in the patient eligibility notification to the patient, and may subsequently submit a request to the healthcare provider computer to generate a healthcare claim transaction (e.g., a billing transaction) to seek reimbursement for the rendered service. The generated healthcare claim transaction may be communicated to the service provider computer which may, in turn, route the healthcare claim transaction to the program sponsor or other payor for adjudication.

It should be appreciated that the above-described example embodiments are merely illustrative of systems, methods, and computer-readable media disclosed herein. These and other example embodiments of the disclosure are described in more detail hereinafter through reference to the accompanying drawings. This disclosure may, however, be embodied in many different forms and should not be construed as being limited to the example embodiments set forth herein; rather, these embodiments are provided merely by way of example to illustrate the scope of the disclosure to those skilled in the art.

### Illustrative System Architecture

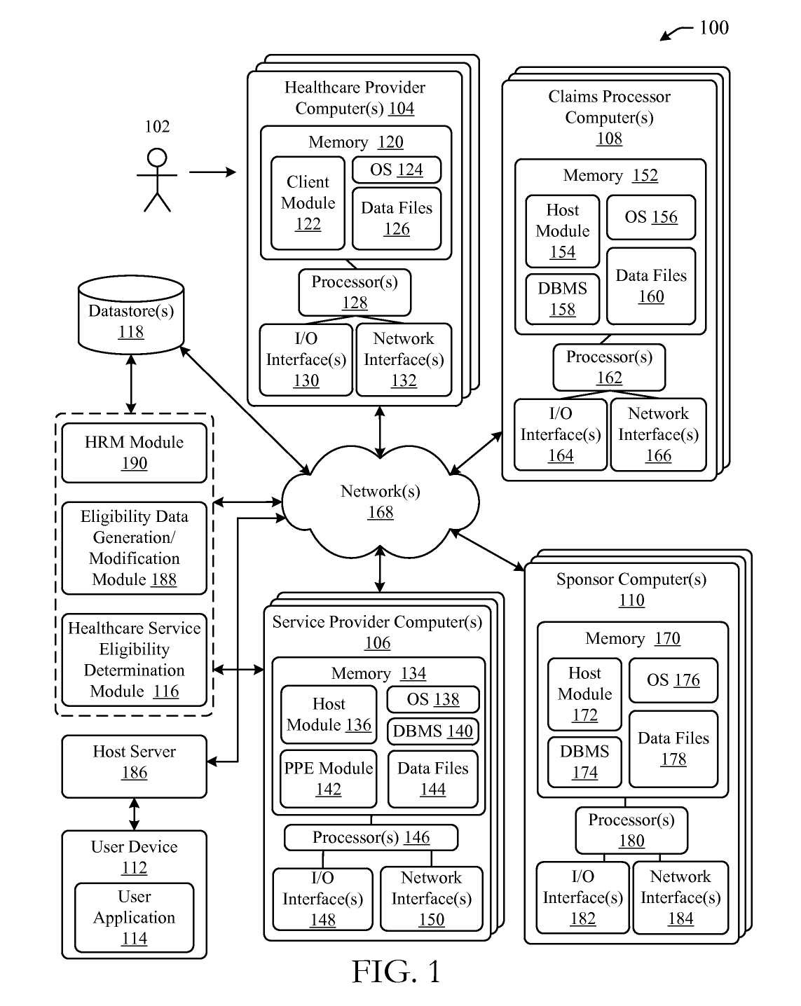

FIG. 1 depicts an illustrative system architecture for, among other things, determining patient eligibility for a sponsored healthcare service and providing a notification of determined patient eligibility in accordance with one or more example embodiments of the disclosure.

As shown in FIG. 1, the example system architecture 100 may include one or more healthcare provider computers 104, one or more service provider computers 106, one or more claims processor computers 108, and one or more sponsor computers 110. Each of the healthcare provider computer(s) 104, the service provider computer(s) 106, the claims processor computer(s) 108, and the sponsor computer(s) 110 may include one or more respective processor-driven devices that may be configured for accessing and reading associated computer-readable media having stored thereon data and/or computer-executable instructions for implementing various embodiments of the disclosure. The healthcare provider computer(s) 104, service provider computer(s) 106, the claims processor computer(s) 108, and the sponsor computer(s) 110 may be referred to herein in the singular for ease of explanation; however, it should be appreciated that a plural number of any of these devices may be provided in one or more example embodiments of the disclosure.

The service provider computer 106 may include or otherwise be in communication with a healthcare service eligibility determination module 116. As will be described in more detail hereinafter, the healthcare service eligibility determination module 116 may include any combination of hardware and software components configured to receive information associated with a healthcare transaction and perform, at least in part, healthcare service eligibility determination processing to determine whether the healthcare transaction satisfies qualifying criteria of one or more sponsor programs and whether the transaction further satisfies patient eligibility criteria for any such qualified sponsor program.

In addition, the service provider computer 106 may include or otherwise be in communication with an eligibility data generation/modification module 188. As will be described in more detail hereinafter, the eligibility data generation/modification module 188 may include any combination of hardware and software components configured to receive a claims process identifier identifying a claims processor (e.g., a payor, a healthcare service program sponsor, etc.), and optionally, a patient eligibility file including one or more patient identifiers associated with the claims processor identifier. The patient identifier(s) may correspond to patients who are members of a health plan administered by or otherwise associated with the claims processor. In those example embodiments in which a patient eligibility file is not received, all patients associated with the claims processor may potentially be eligible for healthcare services sponsored in connection with a health plan associated with the claims processor. The eligibility data generation/modification module 188 may be further configured to receive healthcare claim transaction data corresponding to one or more healthcare claim transactions and determine patient eligibility for a healthcare service using the healthcare claim transaction data. In certain example embodiments, the eligibility data generation/modification module 188 may be configured to determine a longitudinal patient medication history for a patient. A longitudinal patient medical history may include, for example, data corresponding to multiple dispenses of a prescription drug over a period of time.

As previously mentioned, the eligibility data generation/modification module 188 may receive a patient eligibility file that includes a set of patient identifiers identifying patients who are members of a health plan or healthcare service sponsor program and who may be eligible for one or more healthcare services available under the health plan or healthcare service sponsor program if one or more eligibility criteria are satisfied. A patient identifier included in the patient eligibility file may be a Master Patient Index (MPI) that uniquely identifies a particular patient and that is linked to other identifying information for the patient such as, for example, a cardholder ID for the patient, patient demographic information (e.g., patient first name, patient last name, date of birth, address information, etc.), and so forth. Any of the other patient identifying information described above may be included in the patient eligibility file in addition to, or in lieu of, the MPI for a patient. Alternatively, if no patient eligibility file is received, any patient who is a member of a health plan or healthcare service sponsor program may be eligible for the healthcare service(s) as long as the one or more eligibility criteria are satisfied.

The one or more eligibility criteria may be configurable by the claims processor or sponsor who administers, provides, sponsors, or is otherwise associated with the health plan or healthcare service sponsor program. The configurable eligibility criteria may include, for example, a predetermined set of prescription drug identifiers (e.g., NDCs) to monitor healthcare claim transactions for to determine patient eligibility for healthcare service(s), a threshold number of days that a patient is past a next expected refill date for a prescription drug having an identifier included among the predetermined set of identifiers, a proportion of days covered (PDC) threshold (e.g., a threshold percentage) for a prescription drug having an identifier included among the predetermined set of identifiers, a number of days that a patient has not been covered by a prescription fill for a prescription drug having an identifier included among the predetermined set of identifiers, and so forth. In certain example embodiments, the configurable eligibility criteria may specify a Generic Product Identifier (GPI) that corresponds to a particular therapeutic class of prescription drugs. The eligibility data generation/modification module 188 may also receive from the claims processor (or program sponsor if different from the claims processor), or otherwise access, prescription drug data that identifies, by NDC, those prescription drugs that fall within the therapeutic class corresponding to the GPI. In such example embodiments, in order to determine patient eligibility for healthcare service(s), healthcare claim transactions may be monitored to determine whether a healthcare claim transaction is received that includes an NDC that corresponds to the GPI.

A PDC threshold used as part of a determination as to whether an eligibility condition is met may include a minimum PDC threshold against which a current PDC for a patient is compared to determine the patient's eligibility for a healthcare service such as medication adherence counseling. For example, if a patient's PDC for a monitored prescription drug over some period of time (e.g., the current calendar year to date) falls below the minimum PDC threshold, the patient may become eligible for the medication adherence counseling service. The minimum PDC threshold to be maintained at any given time over the course of a monitoring period (e.g., a calendar year) may be established by a claims processor or other healthcare service program sponsor and may correspond, for example, to an overall minimum PDC threshold that must be achieved for the monitoring period. As another example, a patient may be determined to be eligible for a medication adherence counseling service if the patient is more than the threshold number of days past a next expected refill date for a prescription drug that is being monitored. In certain example embodiments, multiple eligibility conditions may need to be met before a patient is determined to eligible for a sponsored healthcare service. For example, a patient may need to be past the threshold number of days for a prescription refill and below a PDC threshold in order to be deemed eligible medication adherence counseling. In other example embodiments, if a single eligibility condition is satisfied for a monitored prescription drug (e.g., the patient is past the threshold number of days for a prescription refill or below a PDC threshold), the patient may be deemed eligible for the healthcare service.

In an example scenario in which the healthcare service is a medication adherence counseling service, the healthcare claim transaction data analyzed by the eligibility data generation/modification module 188 may include data included in multiple healthcare claim transactions, each of which includes patient identifying information for a particular patient and a prescription drug identifier (e.g., a National Drug Code (NDC)) identifying a particular prescription drug. The prescription drug identifier may be included among a set of prescription drug identifiers being monitored on behalf of a claims processor or other healthcare service program sponsor. Additionally, or alternatively, a prescription drug identifier included in a healthcare claim transaction analyzed by the eligibility data generation/modification module 188 may correspond to a prescription drug (e.g., a generic alternative) that is within the same therapeutic class as a prescription drug having an identifier included among the set of prescription identifiers being monitored. In other example embodiments, the eligibility data generation/modification module 188 may receive a GPI and may further receive or otherwise access prescription drug data that identifies the group of prescription drugs, by NDC, that fall within the therapeutic class represented by the GPI. In such example embodiments, the eligibility data generation/modification module 188 may determine whether a prescription drug identifier included in a healthcare claim transaction (e.g., an NDC) matches an NDC within the group of NDCs corresponding to the GPI. A prescription drug identified in an analyzed healthcare claim transaction may be used to treat a chronic condition or other type of condition that typically requires periodic prescription refills for the prescription drug.

Based on an analysis of the healthcare claim transaction data, the eligibility data generation/modification module 188 may determine a series of dispensing dates associated with refills of the prescription drug (or a generic alternative) dispensed to the patient. The eligibility data generation/modification module 188 may then determine whether one or more eligibility conditions are satisfied. For example, the eligibility data generation/modification module 188 may determine whether the refill period since the most recent prescription refill for the patient has expired by more than a threshold period of time (e.g., whether the patient is more than a threshold number of days past due for a prescription refill), whether the patient is below the PDC threshold, and/or whether the patient has been uncovered for more than a threshold number of days.

In certain example embodiments, a patient may also become eligible for medication adherence counseling even if the patient is not currently more than the threshold number of days late on a prescription refill. For example, a patient may become eligible for medication adherence counseling if it is determined that the patient is at risk of being non-adherent based on the patient's previous prescription refill pattern. For example, if the patient's previous prescription refill pattern indicates that there is a greater than a threshold likelihood that the patient may become past due for a prescription refill by more than the threshold number of days, then the patient may become eligible for pro-active medication adherence counseling to attempt to prevent the patient from becoming past due in the future. Additionally, or alternatively, a patient may become eligible for medication adherence counseling even if the patient's current year-to-date PDC is above the overall PDC that needs to be maintained over the course of the monitoring period (e.g., over the course of a calendar year). For example, the claims processor (or program sponsor if different from the claims processor) may specify both an overall minimum PDC that must be achieved for the monitoring period as well as a PDC trigger threshold that is above the minimum PDC but below which eligibility for medication adherence counseling is triggered. For example, if the overall minimum PDC is 80%, the eligibility data generation/modification module 188 may determine that a patient is eligible for pro-active medication adherence counseling if the patient's current PDC, as determined from the patient's prescription refill pattern, falls below the PDC trigger threshold. In certain example embodiments, the eligibility data generation/modification module 188 may be configured to extrapolate, from the patient's current PDC, an expected PDC for a patient over the course of a calendar year. If this extrapolated PDC falls below the overall minimum PDC that must be maintained, the eligibility data generation/modification module 188 may determine that the patient is eligible for medication adherence counseling. Additionally, or alternatively, if this extrapolated PDC falls below the PDC trigger threshold.

In response to a determination that one or more eligibility conditions are satisfied, the eligibility data generation/modification module 188 may generate an eligibility data record indicating eligibility of the patient for medication adherence counseling. The eligibility data record may include the prescription drug identifier (e.g., NDC) identifying the prescription drug for which one or more eligibility conditions are met and healthcare service identifying information (e.g., descriptive text, a numeric identifier, an alphanumeric identifier, etc.) identifying the healthcare service (e.g., medication adherence counseling) for which the patient is eligible. The eligibility data record may further include a patient identifier (e.g., an MPI) identifying the patient, a GPI identifying a therapeutic class of drugs to which the prescription drug identified by the NDC in the eligibility data record belongs, a claims processor identifier (e.g., BIN, PCN, and/or Group ID) identifying a claims processor, and so forth. Upon receipt of a subsequent healthcare claim transaction that includes the patient identifying information (e.g., cardholder ID, patient demographic information, etc.) that matches the MPI included in the eligibility data record, the eligibility data generation/modification module 188 may generate an eligibility notification message that indicates the eligibility of the patient for the medication adherence counseling. The subsequent healthcare claim transaction may include a prescription drug identifier corresponding to a different prescription drug (e.g., a drug in a different therapeutic class) than the drug for which the patient is eligible for medication adherence counseling. The eligibility data generation/modification module 188 may transmit the eligibility notification message to the healthcare provider computer from which the subsequent healthcare claim transaction was received. The eligibility notification message may be transmitted as part of a pre-adjudication rejection of the subsequent healthcare claim transaction, a post-adjudication message, or an alternative communication channel such as via email or facsimile. In certain example embodiments, the eligibility notification message may include patient identifying information for the patient who is eligible for a healthcare service. For example, if the eligibility notification message is an email message, the message may include the patient identifying information (e.g., cardholder ID, patient demographic information, etc.). In those example embodiments in which the eligibility notification message is a pre-adjudication rejection of the subsequent healthcare claim transaction or a post-adjudication response, it may not be necessary to include patient identifying information in the eligibility notification message because the message may be linked to the subsequent healthcare claim transaction which may include the patient identifying information. For example, a pre-adjudication rejection or a post-adjudication response may be embedded in the subsequent healthcare claim transaction and sent to the healthcare provider computer. Further, in some example embodiments, in addition to or as an alternative to the prescription drug identifier, the eligibility notification message may include the name of the drug identified by the prescription drug identifier. The eligibility notification message may optionally include additional data such as, for example, a number of days that the patient is overdue for his/her current prescription refill (e.g., the number of days that have passed since the most recent expected refill date without having received a prescription claim transaction corresponding to a refill of the prescription drug or a generic alternative), the current PDC for the patient, the number of additional days that can be uncovered by prescription claim transactions for the prescription drug while still achieving a minimum PDC threshold (e.g., 80%), and so forth.

In certain example embodiments, upon receiving the eligibility notification message, a healthcare provider (e.g., a pharmacist) may provide medication adherence counseling services to the patient. Upon receiving a medication adherence counseling service, the patient may request a refill of the prescription drug to which the medication adherence counseling relates. If additional refills are not available for the current prescription, the patient may be required to obtain a new prescription for the prescription drug from his/her prescriber. The healthcare provider (e.g., pharmacist) may then provide input to a healthcare provider computer to generate a healthcare claim transaction for the prescription refill. Upon receipt of the healthcare claim transaction, the eligibility data generation/modification module 188 may determine that the healthcare service has been rendered by comparing various data in the received healthcare claim transaction to corresponding data included in the eligibility data record and/or the eligibility notification message. If a threshold number of data elements match between the healthcare claim transaction and the eligibility data record and/or eligibility notification message and if the healthcare claim transaction is received within a threshold number of days after the eligibility notification message is sent, the eligibility data generation/modification module 188 may determine that the healthcare service (e.g., medication adherence counseling) was rendered to the patient. The threshold number of days may be a configurable parameter set by the claims processor (or the program sponsor if the program sponsor is a different entity than the claims processor).

For example, the eligibility data generation/modification module 188 may determine that patient identifying information (e.g., a cardholder ID, patient demographic information, etc.) included in the healthcare claim transaction matches an MPI (or other patient identifier) included in the eligibility data record. The eligibility data generation/modification module 188 may further determine that a healthcare provider identifier (e.g., a National Provider Identifier (NPI) for the pharmacy, a National Association of Boards of Pharmacy (NABP) identifier for the pharmacy, etc.) included in the healthcare claim transaction matches a corresponding healthcare provider identifier included in the eligibility data record. In addition, if the healthcare service is medication adherence counseling, the eligibility data generation/modification module 188 may also determine that a prescription drug identifier (e.g., an NDC) included in the healthcare claim transaction corresponds to a GPI included in the eligibility data record. In certain example embodiments, the eligibility data generation/modification module 188 may first determine whether the NDC included in the healthcare claim transaction matches an NDC included in the eligibility data record. If a match is not detected, the eligibility data generation/modification module 188 may then determine whether the NDC is among a set of NDCs corresponding to prescription drugs within the same therapeutic class represented by the GPI included in the eligibility data record. As previously noted, as part of the completion tracking process described above, the eligibility data generation/modification module 188 may further determine that the healthcare claim transaction was received within a threshold number of days from when the eligibility notification message was sent. In certain example embodiments, additional criteria may need to be met in order for the eligibility data generation/modification module 188 to determine that a healthcare claim transaction corresponds to completion of a healthcare service for which a patient is eligible. For example, the eligibility data generation/modification module 188 may determine whether a claims processor identifier included in the healthcare claim transaction matches a claims processor identifier included in an eligibility data record. Further, in certain example embodiments, the eligibility data generation/modification module 188 may compare data included in the eligibility notification message in addition to, or in lieu of, data included in the eligibility data record to data included in a healthcare claim transaction to determine whether the healthcare claim transaction corresponds to completion of healthcare service identified in the eligibility notification message.

If the above-mentioned data matches, the eligibility data record may be modified to indicate that the patient is no longer eligible for the specific instance of the healthcare service to which the eligibility data record relates. However, it should be appreciated that the patient may again become eligible for the healthcare service (e.g., medication adherence counseling) if subsequent healthcare claim transaction data for the patient indicates a failure to adhere to a prescription drug refill regimen or a likelihood of non-adherence in the future.

While the example scenario discussed above involves medication adherence counseling, it should be appreciated that healthcare claim transaction data may be used to determine a patient's eligibility for any type of healthcare service, including any of those previously described, as well as to determine whether the healthcare service for which a patient is eligible has been completed. For example, if the healthcare service is cash prescription monitoring, as part of completion tracking processing, the eligibility data generation/modification module 188 may determine whether patient identifying information included in a healthcare claim transaction corresponds to a patient identifier (e.g., an MPI) included in the eligibility data record, whether a healthcare provider identifier (e.g., an NABP, an NPI, etc.) included in the healthcare claim transaction matches a healthcare provider identifier included in the eligibility data record, and whether the healthcare claim transaction was received within a threshold number of days from when the eligibility notification message was sent. The eligibility data generation/modification module 188 may further determine whether a prescription drug identifier (e.g., an NDC) included in the healthcare claim transaction matches an NDC included in the eligibility data record. In the case of cash prescription monitoring, the eligibility data record may not include a specific NDC or GPI, but may instead include an identification of a set of NDCs for which a program sponsor has requested cash prescription monitoring to be performed. Accordingly, when a cash prescription claim transaction is received for an NDC included among the set of NDCs identified by the program sponsor, an eligibility notification message (e.g., a pre-adjudication rejection of the cash prescription claim transaction, a post-adjudication message, etc.) may be generated and sent to the healthcare provider computer from which the cash prescription claim transaction was received. If the eligibility notification message is a pre-adjudication rejection or a post-adjudication response, the healthcare claim transaction to which it corresponds may include the NDC as well as a claims processor identifier (e.g., a BIN, PCN, and/or Group ID). If the eligibility notification message is not linked to the original healthcare claim transaction that triggered the message (e.g., the eligibility notification message is an e-mail, facsimile, or Short Message Service (SMS) message), then the eligibility notification message may specify the NDC and the claims processor identifier. Regardless of the form that the eligibility notification message takes, it may include an instruction to the healthcare provider to seek consent from the patient to route the transaction to a claims processor computer associated with the claims processor identifier. When a subsequent healthcare claim transaction is received, the eligibility data generation/modification module 188 may determine that the transaction corresponds to the original cash prescription transaction by determining that an NDC included in the subsequent healthcare claim transaction matches the NDC included in the original healthcare claim transaction that triggered the eligibility notification message.

In the case of an immunization monitoring service, as part of completion tracking processing, the eligibility data generation/modification module 188 may similarly determine whether patient identifying information included in a healthcare claim transaction corresponds to a patient identifier (e.g., an MPI) included in the eligibility data record, whether a healthcare provider identifier (e.g., an NABP, an NPI, etc.) included in the healthcare claim transaction matches a healthcare provider identifier included in the eligibility data record, and whether the healthcare claim transaction was received within a threshold number of days from when the eligibility notification message was sent. In addition, the eligibility data generation/modification module 188 may further determine whether an NDC included in the healthcare claim transaction matches an NDC in a set of NDCs identified by a program sponsor in connection with immunization messaging. Each NDC identified by the program sponsor may correspond to a particular vaccine class into which various vaccine types may be categorized. The vaccine types categorized into a particular vaccine class (e.g., corresponding to a same NDC) may have different dosages, may include vaccine components for different numbers of viruses/diseases (e.g., quadrivalent v. trivalent), and so forth. The set of NDCs identified by the program sponsor for immunization messaging may be stored in the eligibility data record, and thus, the NDC data included in the eligibility data record may not be specific to a particular patient as is the case with medication adherence counseling. Thus, in order to determine whether a healthcare claim transaction corresponds to a vaccination for which an eligibility notification message was previously sent, the eligibility data generation/modification module 188 may compare the NDC included in the healthcare claim transaction to the set of NDCs identified in the eligibility data record to determine whether the NDC included in the healthcare claim transaction matches an NDC in the eligibility data record. Alternatively, if the eligibility notification message included an NDC corresponding to a particular vaccine class, the eligibility data generation/modification module 188 may compare the NDC included in the healthcare claim transaction to the NDC included in the eligibility notification message. If a match is detected, and if the other matching criteria described above are met, the eligibility data generation/modification module 188 may determine that the healthcare claim transaction corresponds to a completion of the vaccination opportunity identified in the eligibility notification message.

In any of the scenarios described above (e.g., medication adherence counseling, cash prescription monitoring, immunization messaging, etc.), after a healthcare claim transaction is identified as a completion of a healthcare service opportunity for which an eligibility notification message was previously sent, the healthcare claim transaction may be routed, using a claims processor identifier included in the healthcare claim transaction (which corresponds to a claims processor identifier included in the eligibility data record), to an appropriate claims processor for adjudication. The claims processor identifier included in the healthcare claim transaction may correspond to the claims processor identifier included in the eligibility data record. In certain example scenarios, such as those involving immunization messaging, the program sponsor may specify one or more additional claims processor identifiers representing alternative destinations to which the healthcare claim transaction may be routed. For example, a program sponsor may specify that a healthcare claim transaction corresponding to an immunization service needs to be submitted as a medical claim transaction rather than a pharmacy claim transaction. In such example embodiments, the program sponsor may specify a claims processor identifier (e.g., a BIN, PCN, and/or Group ID) corresponding to a third party claims processor configured to accept a pharmacy claim transaction from a healthcare provider and convert the pharmacy claim transaction into a medical claim transaction. In such example embodiments, the eligibility notification message triggered by a particular healthcare claim transaction may specify the claims processor identifier corresponding to the third party claims processor and may include an instruction to direct a healthcare claim transaction for the immunization service to the third party claims processor identified by the claims processor identifier rather than a typical claims processor identifier for the program sponsor.

In certain example embodiments, the service provider computer 106 may also include or otherwise be in communication with a high-risk medication (HRM) module 190. As will be described in more detail hereinafter, the HRM module 190 may include any combination of hardware and software components configured to perform monitoring of the dispensing of high-risk medications. A high-risk medication or prescription drug may be any medication identified as having the potential to cause serious side effects when taken to treat a condition for which the medication is designated and for which safer alternative prescription drugs are available. For example, a side effect of a high-risk drug may be dizziness, which may increase the chances of a fall, and which may lead to hospitalization and long term complications for patients, particular the elderly. In certain example embodiments, a high-risk prescription drug may be identified as having the potential to cause serious side effects in a particular patient population (e.g., an elderly population). Despite being identified as high-risk, a significant percentage of the Medicare patient population receives multiple prescription fills of a high-risk drug each year. Some payors or claims processors (e.g., pharmacy benefit managers (PBMs)) utilize a prior authorization mechanism in an attempt to prevent the dispensing of high-risk prescription drugs. However, such prior authorization schemes may be circumvented if a patient pays in cash for a prescription. Further, a patient may abandon the prescription and not receive a dispensing of the drug which may cause the patient's condition to become exacerbated. In addition, prior authorization schemes do not allow for comprehensive tracking of HRM intervention to determine whether an alternative medication was dispensed or whether the patient abandoned the prescription and did not receive the high-risk medication. Some vendor solutions provide an indication of dispenses of high-risk medications after they have occurred. However, these solutions do not allow for real-time monitoring of the dispensing of high-risk medications, and thus, do not provide the capability to prevent the dispensing of a high-risk drug before it occurs.

In certain example embodiments, the HRM module 190 may be configured to perform real-time monitoring of the dispensing of high-risk medications that addresses some or all of the aforementioned drawbacks. The HRM module 190 may be configured to receive a claims processor identifier identifying a claims processor (e.g., a payor, a healthcare service program sponsor, etc.), and optionally, a patient eligibility file including one or more patient identifiers associated with the claims processor identifier. The patient identifier(s) may correspond to patients who are members of a health plan administered by or otherwise associated with the claims processor. The patient identifier(s) included in the patient eligibility file may be MPIs or may be other patient identifying information (e.g., cardholder ID, patient demographic information, etc.) that the HRM module 190 is capable of using to determine corresponding MPIs. In those example embodiments in which a patient eligibility file is not received, high-risk medication monitoring may be performed for all patients associated with the claims processor (or program sponsor if different from the claims processor). The HRM module 190 may be further configured to receive from, for example, a claims processor or other healthcare service program sponsor, first prescription drug data including prescription drug identifiers for one or more prescription drugs identified as high-risk drugs. The HRM module 190 may also receive second prescription drug data including prescription drug identifiers for one or more prescription drugs designated as alternative drugs for treating the same health conditions for which the high-risk prescription drugs are designated. For example, for each high-risk drug identified in the first prescription drug data, one or more corresponding alternative drugs may be identified in the second prescription drug data.

The HRM module 190 may then monitor healthcare claim transactions received over a claims transaction network to determine if a first healthcare claim transaction is received that includes patient identifying information (e.g., a cardholder ID, patient demographic information, etc.) that matches patient identifying information in the patient eligibility file or that corresponds to a patient identifier (e.g., an MPI) included in the patient eligibility file. If a match is detected, or if no patient eligibility file is available and the patient identifying information is determined to be associated with the claims processor identifier identifying the claims processor on whose behalf the high-risk medication monitoring is being provided, the first healthcare claim transaction may be further parsed to determine whether the transaction includes a prescription drug identifier (e.g., an NDC) that matches an identifier included in the first prescription drug data (e.g., an identifier of a high-risk drug). If a match is detected, the HRM module 190 may perform additional processing to determine whether various conditions are met for generating an HRM alert message.

More specifically, the HRM module 190 may determine a number of prior healthcare claim transactions that were received that included the patient identifying information and the prescription drug identifier corresponding to a high-risk drug. Of these prior healthcare claim transactions, the HRM module 190 may determine which (if any) transaction(s) were received within a predetermined period of time (e.g., within the current calendar year, within the last 365 days, within the last 6 months, etc.). If any prior healthcare claim transactions were received that satisfy these criteria, the HRM module 190 may further determine whether any such transaction(s) were adjudicated and approved. The HRM module 190 may compare the number of prior healthcare transactions that satisfy these criteria against a predetermined threshold. If the number is less than the threshold, the HRM module 190 may generate an alert message that includes a second prescription drug identifier (or a name) of a second prescription drug that is an alternative to the first prescription drug (e.g., the high-risk prescription drug) identified in the first healthcare claim transaction. The alert message may further include the identifier (or a name) of the high-risk prescription drug and a specific indication that the second prescription drug is an alternative drug for treating a condition for which the high-risk prescription drug is designated. In addition to, or as an alternative to the identifier of the high-risk prescription drug, the alert message may include the name of the high-risk drug. The HRM module 190 may transmit or direct the transmission of the alert message to the healthcare provider computer 104 from which the first healthcare claim transaction is received as part of a pre-adjudication rejection of the first healthcare transaction or as part of a separate message such as, for example, via email. In certain example embodiments, the HRM module 190 may also generate a supplemental message that includes clinical content corresponding to the high-risk prescription drug and the alternative prescription drug. The clinical content may include information detailing why the first prescription drug has been designated as a high-risk drug and why the second prescription drug is considered a safer alternative. In certain example embodiments, the supplemental message may be transmitted as part or in association with the HRM alert message or may be transmitted to a contact identifier associated with a healthcare provider location (e.g., a pharmacy location of a pharmacy chain) with which the healthcare provider computer is associated. For example, the supplemental message may be transmitted to a designated e-mail address, facsimile number, or the like.

Upon receipt of the HRM alert message, and optionally, the supplemental message, a healthcare provider (e.g., a pharmacist) may facilitate interaction between the patient and the prescriber of the high-risk medication to attempt to cause the prescriber to prescribe the alternative prescription drug in lieu of the high-risk drug. In certain example embodiments, the healthcare provider may provide input to the healthcare provider computer 104 to generate a second healthcare claim transaction that may be received by the HRM module 190. For example, the healthcare provider computer 104 may transmit the second healthcare transaction to the service provider computer 106 which may, in turn, communicate the second healthcare transaction (or at least a portion of the data included therein) to the HRM module 190. The second healthcare claim transaction may be a resubmission of the first healthcare transaction (e.g., may include the same patient identifying information, prescription drug identifier for the high-risk prescription drug, prescriber identifier, etc.), but may further include a code that indicates that a patient counseling session is to be initiated between the patient and a clinical pharmacist, a call center, or the like. For example, the code may indicate that a high-risk medication intervention initiated by the pharmacist in response to the HRM alert message is to be reassigned to a clinical pharmacist, call center, or the like. Upon determining that the second healthcare claim transaction includes the code, the HRM module 190 may generate a notification message indicating that the patient counseling session is to be initiated and may transmit or direct transmission of the notification message to a contact identifier associated with the clinical pharmacist, the call center, or the like. The notification message may be an e-mail message delivered to an e-mail address, an automated voice message delivered to a voicemail inbox, or the like.

In certain example embodiments, the patient counseling session may be successful in persuading the patient to switch to the alternative prescription drug and obtain a prescription from the prescriber for the alternative prescription drug. In such example embodiments, the healthcare provider may provide input to the healthcare provider computer 104 to generate a healthcare claim transaction for the alternative prescription drug. The healthcare claim transaction for the alternative prescription drug may include a prescription drug identifier of the alternative prescription drug, the patient identifying information, a prescriber identifier (e.g., Prescriber ID), a healthcare provider identifier (e.g., an NABP, an NPI, etc.), and so forth. The HRM module 190 may determine that the healthcare claim transaction for the alternative prescription drug corresponds to the original healthcare claim transaction for the high-risk drug by determining that the patient identifying information in both transactions corresponds to the same patient identifier (e.g., MPI), that the healthcare provider identifiers for the two transactions match, that the healthcare claim transaction for the alternative prescription drug was received within a threshold number of days from when the HRM alert message was sent, and that the prescription drug identifier (e.g., NDC) included in the healthcare claim transaction for the alternative prescription drug matches an NDC among a set of NDCs designated as alternatives to the NDC included in the original healthcare claim transaction. The HRM module 190 may then generate reporting data indicating that the high-risk medication intervention was successful in causing the alternative drug to be substituted for the high-risk drug. The HRM module 190 may transmit or direct transmission of the reporting data to a claims processor computer or a system/device associated with another entity (e.g., a healthcare service program sponsor) on whose behalf the high-risk medication monitoring is performed. The HRM module 190 may further transmit or direct the transmission of the healthcare claim transaction for the alternative drug to a claims processor computer for adjudication. The claims processor computer may be determined using the claims processor identifier that was previously received and with which the patient identifying information is associated. It should be appreciated that the claims processor computer that adjudicates the healthcare claim transaction for the alternative prescription drug and the computer/system to which the reporting data is transmitted may correspond to a same entity.

In other example embodiments, the patient counseling session may be unsuccessful in persuading the patient to switch to the alternative drug and/or in persuading the patient to obtain a prescription for the alternative drug from the prescriber. In such example embodiments, the healthcare provider may provide input to the healthcare provider computer 104 to generate a second healthcare claim transaction for the high-risk drug. The second healthcare claim transaction may be a resubmission of the first healthcare transaction and may include an override reason code indicating a reason that the high-risk medication intervention was unsuccessful. For example, the override reason code included in the second healthcare claim transaction may correspond to a predefined reason that the alternative drug was not substituted for the high-risk drug (e.g., the patient did not approve the switch, the prescriber did not issue a prescription for the alternative drug, etc.). Upon receiving the second healthcare claim transaction, the HRM module 190 may determine that the second healthcare claim transaction is a resubmission of the first healthcare claim transaction for the high-risk drug by determining that various data included in the second healthcare claim transaction (e.g., the patient identifying information, the prescriber identifier, the healthcare provider identifier, etc.) matches data in corresponding data fields of the first healthcare claim transaction. In other example embodiments, the second healthcare claim transaction may include a transaction code that indicates that it is a resubmission of the first healthcare claim transaction. The HRM module 190 may then determine that the second healthcare claim transaction includes the override reason code and may increment a counter representative of prior prescription fills for the high-risk drug within the predetermined period of time. The HRM module 190 may further generate reporting data indicating that the high-risk medication intervention was unsuccessful in causing the alternative drug to be substituted for the high-risk drug. The HRM module 190 may transmit or direct transmission of the reporting data to a claims processor computer 108 or a system/device associated with another entity (e.g., a healthcare service program sponsor if different from the claims processor) on whose behalf the high-risk medication monitoring is performed. The HRM module 190 may further transmit or direct the transmission of the resubmitted healthcare claim transaction to a claims processor computer 108 for adjudication. The claims processor computer 108 may be determined using the claims processor identifier that was previously received and with which the patient identifying information is associated. It should be appreciated that the claims processor computer that adjudicates the healthcare claim transaction for the alternative prescription drug and the computer/system to which the reporting data is transmitted may correspond to a same entity.

In order to perform the healthcare service eligibility determination processing, the healthcare service eligibility determination module 116 may access at least one of the data store(s) 118 to retrieve patient eligibility data and/or other data stored in association with sponsor profiles and compare the retrieved data to information identified from the healthcare transaction in order to determine whether the transaction qualifies for a sponsor program, and to further determine whether patient identifying information included in the transaction indicates a match between the patient and a patient who is identified in the retrieved data as being eligible for one or more healthcare services included in the sponsor program.

Referring again to other components of the system architecture 100, the healthcare provider computer 104, service provider computer 106, claims processor computer 108, and the sponsor computer 110 may include or otherwise be associated with suitable hardware and/or software for transmitting and receiving data and/or computer-executable instructions over one or more communication links or networks. These devices and systems may also include any number of processors for processing data and executing computer-executable instructions, as well as other internal and/or peripheral components. These devices and systems may include or be in communication with any number of suitable memory devices operable to store data and/or computer-executable instructions. By executing computer-executable instructions for performing methods disclosed herein, each of these processor-driven devices may form a special-purpose computer or particular machine.

The system architecture 100 may further include a user device 112 on which a user application 114 is executable. The user device 112 may be communicatively coupled to a host server 186. The host server 186 may be communicatively coupled to the service provider computer 106, the healthcare service eligibility determination module 116, or other components of the illustrative architecture 100 via one or more networks 168 or via one or more direct communication links (not shown). Although not shown in FIG. 1, the user device 112 may communicate with the host server 186 via one or more networks (which may include any of the network(s) 168)). The host server 186 and/or the user device 112 may include any suitable combination of hardware and software including any of the types of illustrative hardware or software components depicted as part of other devices forming part of the illustrative architecture 100.

The user application 114 may be configured to communicate with one or more program modules executable on the host server 186. The user application 114 and program module(s) executable on the host server 186 may include respective computer-executable instructions that responsive to execution by one or more processing units of the user device 112 and host server 186, respectively, may cause various operations to be performed as described herein.

For example, program module(s) executable on the host server 186 may include computer-executable instructions for receiving input data, via the user application 114, that identifies a healthcare service program sponsor that has contracted with a service provider associated with the service provider computer 106 for patient eligibility notification services in connection with a sponsor program as well as input data indicative of various parameters of the sponsor program, and for generating a sponsor profile based on the received input data. The input data that identifies a healthcare service program sponsor may include, for example, a sponsor name, sponsor contact information, and so forth. The sponsor program parameters may specify, for example, types of healthcare services included in the sponsor program, whether patient medication history may be accessed in determining patient eligibility for sponsored healthcare services, whether an access token is to be provided as part of a patient eligibility notification, start and end dates for the sponsor program and/or specific healthcare services included in the sponsor program, payor information (e.g., a BIN Number and, optionally, a PCN and/or Group ID), whether all clients or only a subset of clients qualify for receiving patient eligibility notifications, and so forth. In various example embodiments, the input data may be specified in a contract between the program sponsor and the service provider.

The program module(s) executable on the host server 186 may further include computer-executable instructions for receiving, via the user application 114, input data that identifies a client (e.g., a healthcare provider) that has contracted with the service provider to receive patient eligibility notifications and for generating a client profile based on the received data. In addition, the program module(s) may include computer-executable instructions for associating a sponsor program with a client profile responsive to user input received via the user application 114. As a non-limiting example, upon user selection of a particular client profile, the user application 114 may be configured to present an indication of those sponsor programs that are available for association with the selected client profile. The user application 114 may receive an indication of a user selection of a sponsor program to associate with the selected profile, and may further receive input indicating selections for various client configurable parameters. The program module(s) executable on the host server 186 may receive this information from the user application 114 and may associate the selected sponsor program with the selected client profile and configure the associated sponsor program in accordance with the selections for the configurable parameters.

The configurable parameters may include, for example, a client notification preference for patient eligibility notifications generated in connection with the sponsor program (e.g., pre-adjudication rejection, post-adjudication message, etc.), a specified notification frequency (e.g., 1 patient eligibility notification each X number of days, potentially per patient), a type and/or format for a reject code and reject message to include in a patient eligibility notification provided as part of a pre-adjudication rejection, a type and/or format of an approved message code and message to include in a patient eligibility notification to include in a post-adjudication message, a notification priority assigned to the sponsor program, and so forth. It should be appreciated that the above examples of client identifying information, sponsor identifying information, sponsor program parameters, and client configurable parameters are merely illustrative and not exhaustive.

As shown in FIG. 1, the healthcare provider computer 104, the service provider computer 106, the claims processor computer 108, the sponsor computer 110, the host server 186, and/or the healthcare service eligibility determination module 116 may be in communication with each other via the one or more networks 168. The network(s) 168 may include, but are not limited to, any one or a combination of different types of suitable communications networks such as, for example, cable networks, public networks (e.g., the Internet), private networks, wireless networks, cellular networks, a public-switched telephone network (PSTN), or any other suitable private and/or public networks. Further, the network(s) 168 may have any suitable communication range associated therewith and may include, for example, global networks (e.g., the Internet), metropolitan area networks (MANs), wide area networks (WANs), local area networks (LANs), or personal area networks (PANs). In addition, the network(s) 168 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof. In other example embodiments, one or more of these devices or systems may communicate via direct connections and/or communication links.

Each healthcare provider computer 104 may be associated with a healthcare provider such as, for example, a pharmacy or other prescription drug dispensing entity, a physician's office, a hospital setting, and so forth. The healthcare provider computer 104 may be any suitable processor-driven device that executes or facilitates the execution, at least in part, of computer-executable instructions to process requests (e.g., prescription fill requests, requests to generate electronic prescriptions, etc.) made by or on behalf of patients or other consumers and generate healthcare transactions (e.g., healthcare claim transactions, electronic prescriptions, etc.) based on such requests. A user 102 is illustratively depicted in FIG. 1 as interacting with the healthcare provider computer 104 to, for example, input information to the healthcare provider computer 104 corresponding to the aforementioned requests. The healthcare provider computer 104 may be further configured to communicate such healthcare transactions to the service provider computer 106 and process or facilitate the processing of adjudicated responses thereto received from the service provider computer 106.

The healthcare provider computer 104 may include any suitable processor-driven computing device such as, for example, a server computer; a mainframe computer; a workstation; a desktop computer; a personal computer; a mobile device such as a smartphone, digital assistant, personal digital assistant, or tablet device; and so forth. The healthcare provider computer 104 may further include any number of application-specific integrated circuits, microcontrollers, minicomputers, or other processing units. In certain example embodiments, the healthcare provider computer 104 may be a point-of-sale device associated with a healthcare provider. The healthcare provider computer 104 having computer-executable instructions stored thereon may form a special-purpose computer or other particular machine that is operable to perform any of a variety of operations described herein. In various example embodiments, the operations and/or control of the healthcare provider computer 104 may be distributed among several processing components. In an illustrative configuration, the healthcare provider computer 104 may include one or more processors 128, one or more memories 120 (generically referred to herein as memory 120), one or more input/output (“I/O”) interface(s) 130, and one or more network interface(s) 132.

The memory 120 may include volatile memory (memory that maintains its state when supplied with power) such as random access memory (RAM) and/or non-volatile memory (memory that maintains its state even when not supplied with power) such as read-only memory (ROM), flash memory, and so forth. In various implementations, the memory 120 may include multiple different types of memory, such as various types of static random access memory (SRAM), various types of dynamic random access memory (DRAM), various types of unalterable ROM, writeable variants of ROM such as electrically erasable programmable read-only memory (EEPROM) or flash memory, and so forth.

The memory 120 may store computer-executable instructions that are loadable and executable by the processor(s) 128, as well as data manipulated and/or generated by the processor(s) 128 during the execution of the computer-executable instructions. For example, the memory 120 may store one or more operating systems (O/S) 124; one or more database management systems (DBMS) (not shown); one or more data files 126; and one or more program modules, applications, or the like such as, for example, a client module 122. The client module 122 depicted as being loaded into the memory 120 may include computer-executable instructions that in response to execution by the processor(s) 128 may cause various processing described herein to be performed. In order to perform such processing, the client module 122 may utilize at least a portion of the data files 126 and/or data stored in one or more external data stores (not shown). It should be appreciated that the client module 122 may correspond to a collection of program modules, applications, or the like that may support any of variety of types of functionality.

The data files 126 may include any suitable data that facilitates the receipt and/or processing by the healthcare provider computer 104 of requests made by or on behalf of patients or consumers, and/or the generation of healthcare requests and the processing of adjudicated responses thereto. For example, the data files 126 may include, but are not limited to, information associated with the service provider computer 106, information associated with one or more claims processors or payors, information associated with one or more pharmacies or other drug dispensing entities, prescriber information, and/or information associated with one or more healthcare requests.

The (O/S) 124 loaded into the memory 120 may provide an interface between other application software (e.g., the client module 122) executing on the healthcare provider computer 104 and hardware resources of the healthcare provider computer 104. More specifically, the O/S 124 may include a set of computer-executable instructions for managing hardware resources of the healthcare provider computer 104 and for providing common services to other application programs (e.g., managing memory allocation among various application programs). The O/S 124 may include any operating system now known or which may be developed in the future including, but not limited to, any server operating system, any mainframe operating system, or any other proprietary or freely available operating system.

While not depicted in FIG. 1, the healthcare provider computer 104 may further include additional data storage such as removable storage and/or non-removable storage including, but not limited to, magnetic storage, optical disk storage, and/or tape storage. Such data storage may provide non-transient storage of computer-executable instructions and other data. The memory 118 and/or such additional data storage, removable and/or non-removable, are each examples of computer-readable storage media (CRSM) as that term is used herein.

It should be appreciated that any data and/or computer-executable instructions stored in the memory 120 may be additionally, or alternatively, stored in additional data storage and/or one or more external data stores (not shown). A DBMS (not shown) may support functionality for accessing, retrieving, storing, and/or manipulating data stored in external data store(s), data stored in the memory 120 and/or data stored in additional data storage. Such a DBMS may use any of a variety of database models (e.g., relational model, object model, etc.) and may support any of a variety of query languages.

The client module 122 may be an Internet browser application or other software application (e.g., a dedicated application) that facilitates user interaction with the healthcare provider computer 104. For example, a user 102, such as a pharmacist or other pharmacy employee, a prescriber, or the like may utilize the client module 122 to generate and transmit a healthcare request (e.g., a healthcare claim transaction, an e-prescribing transaction, etc.) to the service provider computer 106 for eventual routing to one or more appropriate claims processor computers 108 for adjudication or other coverage/benefits determination, or to an intended recipient such as a pharmacy computer when the request corresponds to an e-prescribing transaction. The healthcare provider computer 104 may additionally utilize the client module 122 to receive or otherwise access data, messages, or responses from the service provider computer 106 and/or other components of the architecture 100.

The processor(s) 128 may be configured to access the memory 120 and execute computer-executable instructions stored therein. For example, the processor(s) 128 may be configured to execute computer-executable instructions of the client module 122 to cause or facilitate various operations to be performed in accordance with one or more example embodiments of the disclosure. The processor(s) 128 may include any suitable processing unit capable of accepting digital data as input, processing the input data in accordance with stored computer-executable instructions, and generating output data. The processor(s) 128 may include, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), and so forth.

As previously noted, the healthcare provider computer 104 may further include one or more I/O interfaces 130 that may facilitate the receipt of input information by the healthcare provider computer 104 via an I/O device as well as the output of information from the healthcare provider computer 104 to an I/O device. The I/O devices with which the healthcare provider computer 104 may communicate using the I/O interface(s) 130 may include one or more user interface devices that facilitate interaction between a user and the healthcare provider computer 104 including, but not limited to, a display, a keypad, a pointing device, a control panel, a touch screen display, a remote control device, a microphone, a speaker, and so forth. The one or more I/O interfaces 130 may, for example, facilitate input of information associated with a healthcare request to the healthcare provider computer 104 via one or more I/O devices.

As previously noted, the healthcare provider computer 104 may be configured to communicate with any of a variety of other systems, platforms, devices, and so forth (e.g., the service provider computer 106, the host server 186, etc.) via one or more of the network(s) 168. The healthcare provider computer 104 may include one or more network interfaces 132 that may facilitate communication between the healthcare provider computer 104 and any of the above-mentioned systems, platforms or devices.

In operation, the healthcare provider computer 104 may receive information associated with a healthcare request (e.g., a request to fill a prescription, a prescription order, a prescription refill authorization, other e-prescribing transactions, etc.) from a patient or other individual (e.g., a healthcare provider). As a non-limiting example, the healthcare provider computer 104 may receive information associated with a healthcare request at a point-of-sale located at a pharmacy, a physician's office, or at another prescription drug dispensing location. As another non-limiting example, the healthcare provider computer 104 may electronically receive a request from a user device on behalf of a patient or other authorized party. The healthcare provider computer 104 may be configured to generate a healthcare transaction based on the received information and communicate the healthcare transaction to the service provider computer 106. The service provider computer 106 may then optionally perform pre-processing on the healthcare transaction and route the transaction to an intended recipient such as a claims processor computer 108 for adjudication or to a pharmacy computer when the healthcare transaction is an e-prescription. In those example embodiments in which the healthcare transaction is routed to a claims processor computer 108 for adjudication, the service provider computer 106 may receive the adjudicated reply, optionally perform post-processing on the adjudicated reply, and communicate the adjudicated reply to the healthcare provider computer 104. As described in more detail hereinafter, the service provider computer 106 may additionally perform, request or instruct the healthcare service eligibility determination module 116 to perform healthcare service eligibility determination processing in connection with the received healthcare transaction prior to, concurrently with, or subsequent to adjudication of the transaction.

The service provider computer 106 may be associated with a service provider that provides, among other services, healthcare transaction routing and processing services. The service provider computer 106 may include, but is not limited to, any suitable processor-driven device (e.g., a switch, router, server, etc.) configured to process and route healthcare transactions received from the healthcare provider computer 104 and/or adjudicated replies thereto received from the claims processor computer 108. For example, the service provider computer 106 may route billing requests and/or other healthcare transactions received from a healthcare provider computer 104 to a claims processor computer 108 associated with a claims processor such as a pharmacy benefits manager (“PBM”), an insurer, a government payor, or a claims clearinghouse. As another non-limiting example, the service provider computer 106 may route an electronic prescription order received from a first healthcare provider computer 104 (e.g., a physician's computer) to a second healthcare provider computer 104 (e.g., a pharmacy computer). In certain example embodiments, prior to routing the electronic prescription order to a pharmacy computer, the service provider computer 106 may first route the e-prescription transaction to a claims processor computer 108 for adjudication (e.g., coverage benefits determination). In certain example embodiments, the service provider computer 106 may include a suitable host server, host module, or other software that facilitates the receipt of a healthcare transaction or adjudicated reply and/or the routing of the transaction or adjudicated reply to an appropriate recipient.

The service provider computer 106 may include any number of special-purpose computers or other particular machines, application-specific integrated circuits, microcontrollers, personal computers, minicomputers, mainframe computers, servers, and/or other processor-driven devices. In certain example embodiments, the operations of the service provider computer 106 may be controlled by computer-executed or computer-implemented instructions that may be executed by one or more processors associated with the service provider computer 106 to form a special-purpose computer or other particular machine that is operable to facilitate the receipt, routing, and/or processing of healthcare transactions and adjudicated replies thereto. The one or more processors that control the operations of the service provider computer 106 may be incorporated into the service provider computer 106 and/or may be in communication with the service provider computer 106 via one or more suitable networks. In certain example embodiments, the operations and/or control of the service provider computer 106 may be distributed among several processing components. In an illustrative configuration, the service provider computer 106 may include one or more processors 146, one or more memories 134 (generically referred to herein as memory 134), one or more input/output (“I/O”) interface(s) 148, and one or more network interface(s) 150.

The memory 134 may include any of the types of memory described through reference to the memory 120 of the healthcare provider computer 104. The memory 134 may store computer-executable instructions that are loadable and executable by the processor(s) 146, as well as data manipulated and/or generated by the processor(s) 146 during the execution of the computer-executable instructions. For example, the memory 134 may store one or more operating systems (O/S) 138; one or more database management systems (DBMS) 140; one or more data files 144; and one or more program modules, applications, or the like such as, for example, a host module 136, a pre- and post-edit (“PPE”) module 142, and so forth. In certain example embodiments, the service provider computer 106 may further include the healthcare service eligibility determination module 116. Additionally, or alternatively, in certain example embodiments, the user application 114 may be executable on the service provider computer 106. The program modules depicted as being loaded into the memory 134 (which may include the healthcare service eligibility determination module 116 in certain example embodiments) may include computer-executable instructions that in response to execution by the processor(s) 146 may cause various processing described herein to be performed. In order to perform such processing, these program modules may utilize at least a portion of the data files 144 and/or data stored in one or more external data stores 118. It should be appreciated that the host module 136, the PPE module 142, and/or the healthcare service eligibility determination module 116 may each correspond to a collection of program modules, applications, or the like that may support associated functionality.

The PPE module 142 may be operable to perform one or more pre-edits on a received healthcare transaction prior to routing or otherwise communicating the transaction to an intended recipient, such as the claims processor computer 108 or another healthcare provider computer 104 (e.g., a pharmacy computer). Additionally, the PPE module 142 may be operable to perform one or more post-edits on an adjudicated reply or other response that is received from the claims processor computer 108 for a healthcare transaction prior to routing the adjudicated reply or other response to the healthcare provider computer 104 from which the healthcare transaction was received. A wide variety of different pre-edits and/or post-edits may be performed as desired in various example embodiments. In certain example embodiments, the healthcare service eligibility determination module 116 may be incorporated into the PPE module 142 and/or in communication with the PPE module 142. As desired, the PPE module 142 may selectively invoke the healthcare service eligibility determination module 116 in order to initiate the healthcare service eligibility determination processing disclosed herein.

The host module 136 may receive, process, and respond to requests from the client module 122 of the healthcare provider computer 104, and may further receive, process, and respond to requests of a host module 154 of the claims processor computer 108 and/or a host module 172 of the sponsor computer 110.

The data files 144 may store healthcare transaction records associated with communications received from various healthcare provider computers 104 and/or various claims processor computers 108. The data files 144 may also store any number of suitable routing tables that identify various potential destinations for communications received from a healthcare provider computer 104 or a claims processor computer 108. The data files 144 may further include, without limitation, client profile data; sponsor profile data; client configuration data for sponsor programs associated with a client profile; patient eligibility data received from the sponsor computer 110; data generated by the service provider computer 106 and/or the healthcare service eligibility determination module 116 such as, for example, patient eligibility notification delivery data, data associated with received patient eligibility data, etc.; or any other suitable data. Any portion of the data files 144 may be stored in the data store(s) 118 and retrieved therefrom.

The (O/S) 138 loaded into the memory 134 may provide an interface between other application software (e.g., the host module 136, the PPE module 142, etc.) executing on the service provider computer 106 and hardware resources of the service provider computer 106. More specifically, the O/S 138 may include a set of computer-executable instructions for managing hardware resources of the service provider computer 106 and for providing common services to other application programs (e.g., managing memory allocation among various application programs). The O/S 138 may include any type of operating system described through reference to the O/S 124 of the healthcare provider computer 104.

While not depicted in FIG. 1, the service provider computer 106 may further include additional data storage such as any of the types of data storage described through reference to the healthcare provider computer 104. It should be appreciated that any data and/or computer-executable instructions stored in the memory 134 may be additionally, or alternatively, stored in additional data storage and/or one or more external data stores (e.g., the data store(s) 118). The DBMS 140 may support functionality for accessing, retrieving, storing, and/or manipulating data stored in the external data store(s) 116, data stored in the memory 134 and/or data stored in additional data storage. The DBMS 140 may use any of a variety of database models (e.g., relational model, object model, etc.) and may support any of a variety of query languages.

The processor(s) 146 may be configured to access the memory 134 and execute computer-executable instructions stored therein. For example, the processor(s) 146 may be configured to execute computer-executable instructions of the host module 136, the PPE module 142, the healthcare service eligibility determination module 116, and/or the user application 114 to cause the performance of various operations in accordance with one or more example embodiments of the disclosure. The processor(s) 146 may include any suitable processing unit capable of accepting digital data as input, processing the input data in accordance with stored computer-executable instructions, and generating output data. The processor(s) 146 may include any of the types processors described through reference to the processor(s) 128 of the healthcare provider computer 104.

As previously noted, the service provider computer 106 may further include one or more I/O interfaces 148 that may facilitate the receipt of input information by the service provider computer 106 via an I/O device as well as the output of information from the service provider computer 106 to an I/O device. The I/O devices with which the service provider computer 106 may communicate using the I/O interface(s) 148 may include one or more user interface devices that facilitate interaction between a user and the service provider computer 106 including, but not limited to, any of the types of I/O devices described through reference to the healthcare provider computer 104.

As also previously noted, the service provider computer 106 may be configured to communicate with any of a variety of other systems, platforms, devices, and so forth (e.g., the healthcare provider computer 104, the claims processor computer 108, the host server 186, the healthcare service eligibility determination module 116, etc.) via one or more of the network(s) 168. The service provider computer 106 may include one or more network interfaces 150 that may facilitate communication between the service provider computer 106 and any of the above-mentioned systems, platforms or devices.

In operation, the service provider computer 106 may receive a healthcare transaction from a healthcare provider computer 104. The service provider computer 106 may communicate at least a portion of the information included in the healthcare transaction to the healthcare service eligibility determination module 116 which may, in turn, perform healthcare service eligibility determination processing based on the received information. In one or more example embodiments, the healthcare service eligibility determination processing may be performed prior to communication of the healthcare transaction to a claims processor computer 108 for adjudication, while any patient eligibility notification may be communicated as a pre-adjudication rejection, a post-adjudication message appended to or otherwise associated with an adjudicated response, or via an alternate notification mechanism upon determining that an adjudicated response indicates approval of the healthcare transaction. However, it should be appreciated that any portion of the healthcare service eligibility determination processing may be performed prior to, concurrently with, or subsequent to adjudication of the healthcare transaction.

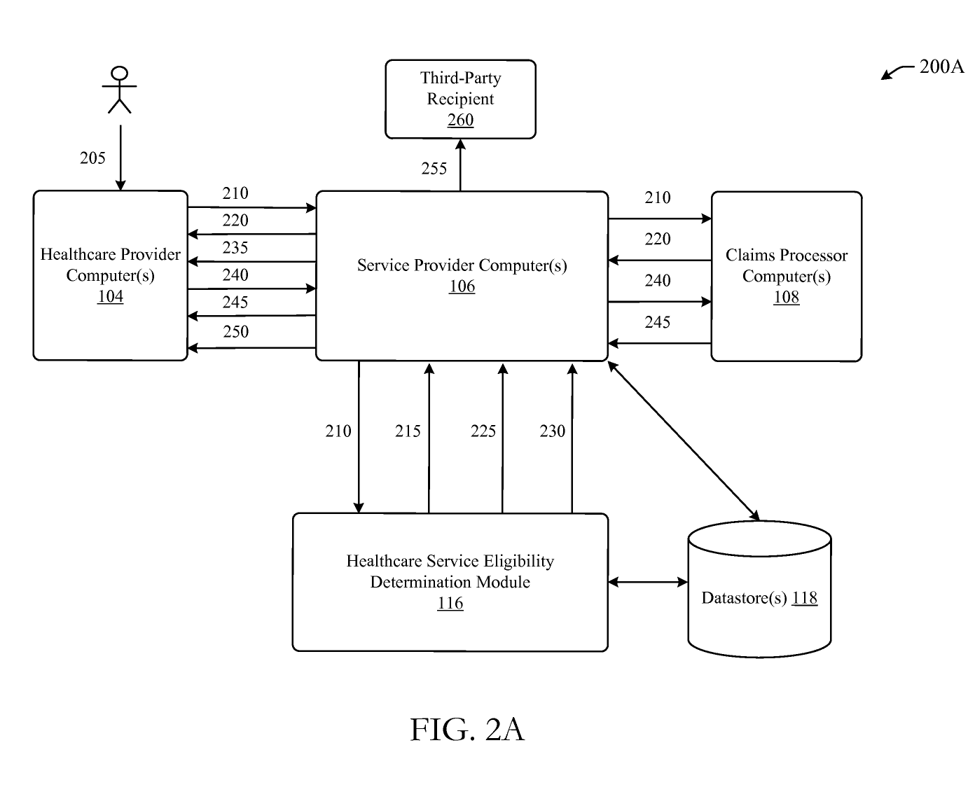

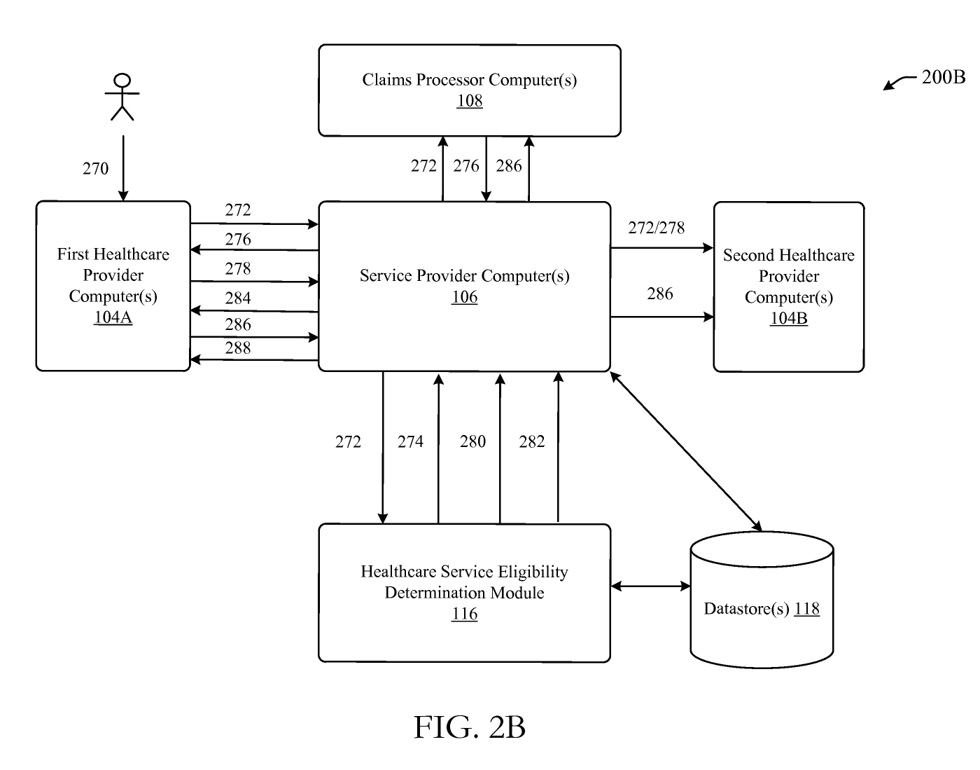

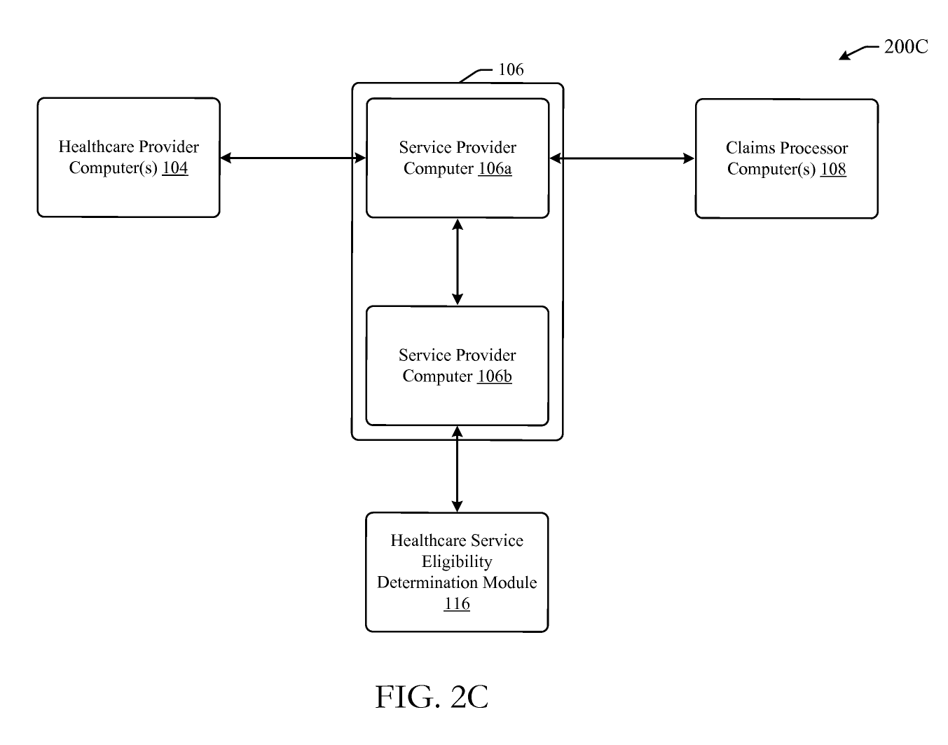

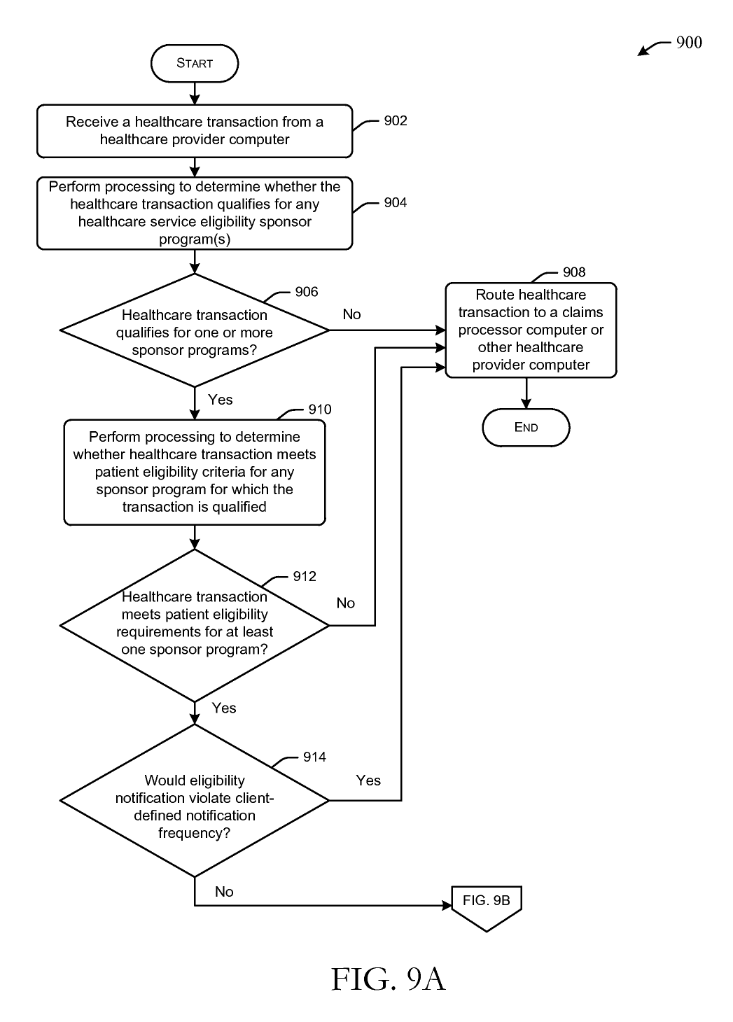

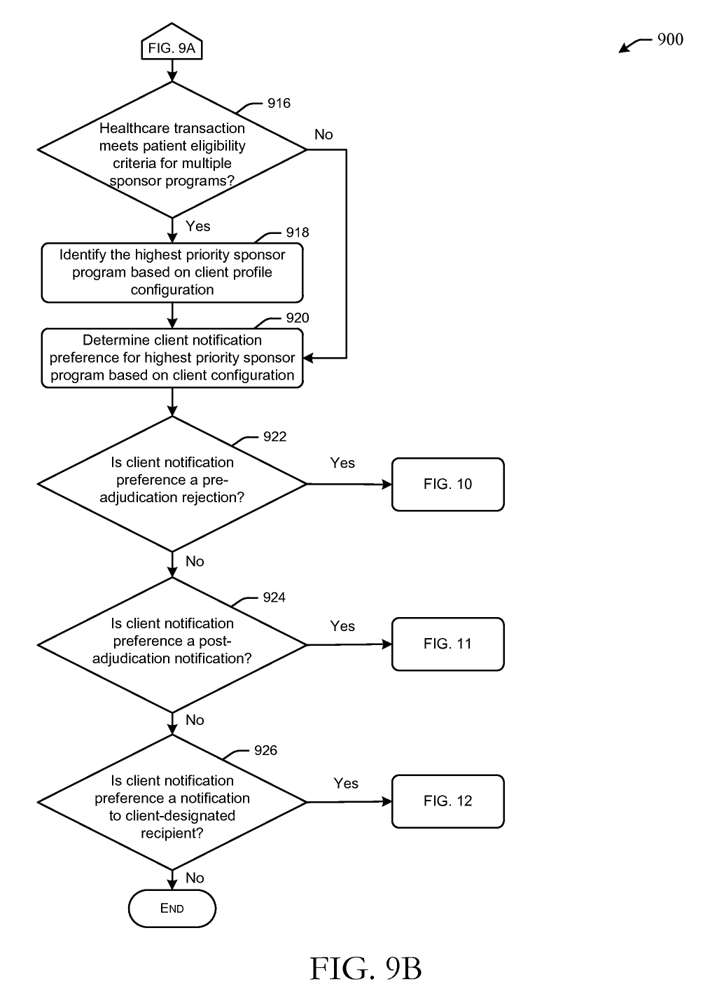

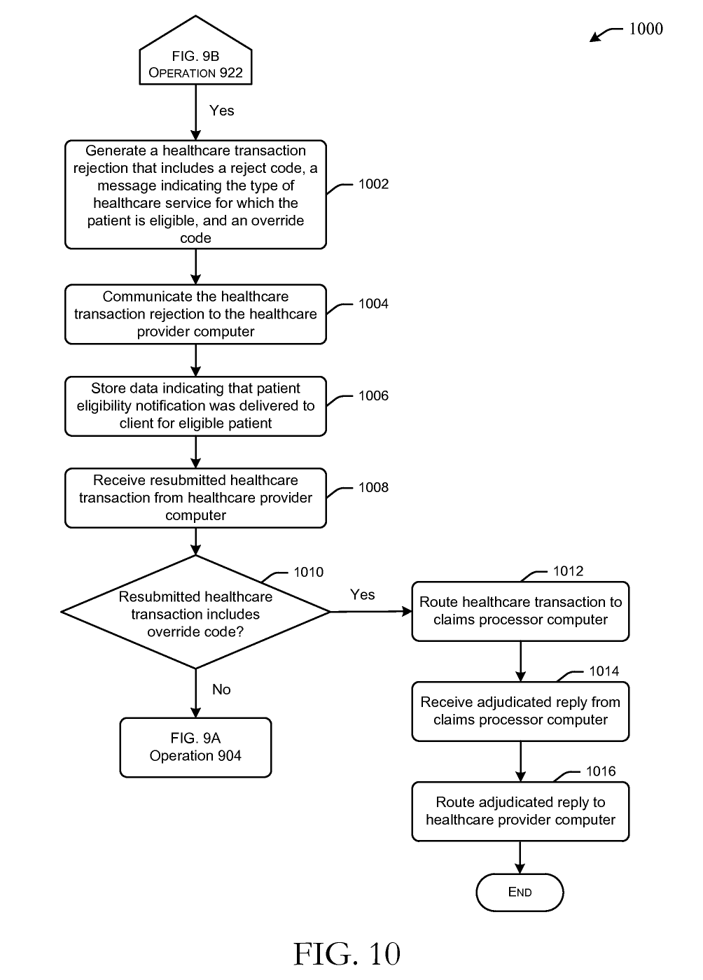

The healthcare service eligibility determination module 116 may include any combination of hardware and software which may, in various example embodiments, form part of a service provider system that includes, among any number of other components, one or more service provider computers 106. In other example embodiments, the healthcare service eligibility determination module 116 may be distinct from but controlled by the service provider computer 106 or the service provider system generally. In still other example embodiments, the healthcare service eligibility determination module 116 may be distinct from the service provider computer 106 or service provider system generally and independently controlled (e.g., executed on a server operated by a third party), and may perform the healthcare service eligibility determination processing in response to a request or instruction received from the service provider computer 106. The healthcare service eligibility determination processing performed by the healthcare service eligibility determination module 116 will be described in more detail through reference to the illustrative data flows of FIGS. 2A-2B and the illustrative methods depicted in the process flow diagrams of FIGS. 9A-13.

A wide variety of different types of reports may be generated as desired in various example embodiments of the disclosure. Additionally, a wide variety of different information may be incorporated into generated reports including, but not limited to, information associated with the results of various processing performed by the healthcare service eligibility determination module 116 such as, for example, statistical information relating to number or percentage of patients for whom patient eligibility notifications are delivered, statistical information relating to a number of patient eligibility notifications delivered for one or more program sponsors, and so forth. Reports may be sorted or formatted utilizing a wide variety of different criteria, parameters, and/or techniques. Additionally, the healthcare service eligibility determination module 116 may communicate or direct the communication of generated reports to one or more other devices in the architecture 100.

A wide variety of different techniques and/or software programs may be utilized to format a generated report. For example, a report may be formatted as a comma-separated-value (“csv”) file, as a spreadsheet file, as a word processor file, as a text file, and so forth. Additionally, a wide variety of different communication techniques may be utilized to communicate a report to a recipient. For example, a report may be “pushed” to a recipient by the healthcare service eligibility determination module 116 or other reporting module, or alternatively, may be “pulled” from the healthcare service eligibility determination module 116 by a recipient submitting a request for one or more reports. Additionally, in certain example embodiments, a report may be made available for download from an appropriate website or server, such as a website hosted by the service provider computer 106.

Still referring to FIG. 1, a claims processor computer 108 may be associated with any suitable claims processor including, but not limited to, a private or government payor, a benefits manager such as a pharmacy benefits manager (PBM), an insurer, a claims clearinghouse, and so forth. The claims processor computer 108 may be any suitable processor-driven device that facilitates receiving, processing, and/or adjudicating healthcare transactions received from the service provider computer 106.

As desired, the claims processor computer 108 may include any number of special-purpose computers or other particular machines, application-specific integrated circuits, microcontrollers, personal computers, minicomputers, mainframe computers, servers, or the like. In certain example embodiments, the operations of the claims processor computer 108 may be controlled by computer-executed or computer-implemented instructions that are executed by one or more computer processors associated with the claims processor computer 108 to form a special-purpose computer or other particular machine that is operable to facilitate the receipt, processing, and/or adjudication of healthcare transactions received from the service provider computer 106. The one or more computer processors that control the operations of a claims processor computer 108 may be incorporated into the claims processor computer 108 and/or may be in communication with the claims processor computer 108 via one or more suitable networks. In certain example embodiments, the operations and/or control of the claims processor computer 108 may be distributed among several processing components. In an illustrative configuration, the claims processor computer 108 may include one or more processors 162, one or more memories 152 (generically referred to herein as memory 152), one or more input/output (“I/O”) interface(s) 164, and one or more network interface(s) 166.

The memory 152 may include any of the types of memory described through reference to the memory 120 of the healthcare provider computer 104 and/or the memory 134 of the service provider computer 106. The memory 152 may store computer-executable instructions that are loadable and executable by the processor(s) 162, as well as data manipulated and/or generated by the processor(s) 162 during the execution of the computer-executable instructions. For example, the memory 152 may store one or more operating systems (O/S) 156; one or more database management systems (DBMS) 158; one or more data files 160; and one or more program modules, applications, or the like such as, for example, a host module 154. The host module 154 may include computer-executable instructions that in response to execution by the processor(s) 162 may cause various processing described herein to be performed. In order to perform such processing, these program modules may utilize at least a portion of the data files 160 and/or data stored in one or more external data stores (not shown). It should be appreciated that the host module 154 may correspond to a collection of program modules, applications, or the like that may support associated functionality.

The data files 160 may include any suitable information that is utilized by the claims processor computer 108 to process healthcare transactions such as, for example, patient profiles, patient insurance information, other information associated with a patient, information associated with a healthcare provider, and so forth.

The host module 154 may initiate, receive, process, and/or respond to requests, such as requests for adjudication of healthcare transactions received from the host module 136 of the service provider computer 106. The claims processor computer 108 may further include any number of additional program modules for performing other processing such as pre-processing or post-processing healthcare transactions and/or adjudicated replies.

The (O/S) 156 loaded into the memory 152 may provide an interface between other application software (e.g., the host module 154) executing on the claims processor computer 108 and hardware resources of the claims processor computer 108. More specifically, the O/S 156 may include a set of computer-executable instructions for managing hardware resources of the claims processor computer 108 and for providing common services to other application programs (e.g., managing memory allocation among various application programs). The O/S 160 may include any of the types of operating systems described through reference to the O/S 124 of the healthcare provider computer 104 and/or the O/S 138 of the service provider computer 106.

While not depicted in FIG. 1, the claims processor computer 108 may further include additional data storage such as any of the types of additional data storage described through reference to the healthcare provider computer 104 and/or the service provider computer. It should be appreciated that any data and/or computer-executable instructions stored in the memory 152 may be additionally, or alternatively, stored in additional data storage and/or one or more external data stores. The DBMS 158 may support functionality for accessing, retrieving, storing, and/or manipulating data stored in external datastore(s), data stored in the memory 152 and/or data stored in additional data storage. The DBMS 158 may use any of a variety of database models (e.g., relational model, object model, etc.) and may support any of a variety of query languages.

The processor(s) 162 may be configured to access the memory 152 and execute computer-executable instructions stored therein. For example, the processor(s) 162 may be configured to execute computer-executable instructions of the host module 154 to cause the performance of various operations in accordance with one or more example embodiments of the disclosure. The processor(s) 162 may include any suitable processing unit capable of accepting digital data as input, processing the input data in accordance with stored computer-executable instructions, and generating output data. The processor(s) 162 may include any of the types of processors described through reference to the processor(s) 128 of the healthcare provider computer 104 and/or the processor(s) 146 of the service provider computer 106.

As previously noted, the claims processor computer 108 may further include one or more I/O interfaces 164 that may facilitate the receipt of input information by the claims processor computer 108 via an I/O device as well as the output of information from the claims processor computer 108 to an I/O device. The I/O devices with which the claims processor computer 108 may communicate using the I/O interface(s) 164 may include any of the types of I/O devices described through reference to the healthcare provider computer 104 and/or the service provider computer 106.

As previously noted, the claims processor computer 108 may be configured to communicate with any of a variety of other systems, platforms, devices, and so forth (e.g., the healthcare provider computer 104, the service provider computer 106, etc.) via one or more of the network(s) 168. The claims processor computer 108 may include one or more network interfaces 166 that may facilitate communication between the claims processor computer 108 and any of the above-mentioned systems, platforms or devices.

Still referring to FIG. 1, the sponsor computer 110 may be associated with any healthcare service program sponsor that develops, coordinates, and/or manages one or more healthcare service sponsor programs. In various example embodiments, the healthcare service program sponsor may be a payor or other claims processor. In other example embodiments, the program sponsor may be an entity other than a payor.

The sponsor computer 110 may include any number of special-purpose computers or other particular machines, application-specific integrated circuits, microcontrollers, personal computers, minicomputers, mainframe computers, servers, or the like. In certain example embodiments, the operations of the sponsor computer 110 may be controlled by computer-executed or computer-implemented instructions that are executed by one or more computer processors associated with the sponsor computer 110 to form a special-purpose computer or other particular machine that is operable to, among other things, generate and communicate patient eligibility data to the service provider computer 106. In certain example embodiments, the sponsor computer 110 may be further operable to facilitate the receipt, processing, and/or adjudication of healthcare transactions received from the service provider computer 106. The one or more computer processors that control the operations of a sponsor computer 110 may be incorporated into the sponsor computer 110 and/or may be in communication with the sponsor computer 110 via one or more suitable networks. In certain example embodiments, the operations and/or control of the sponsor computer 110 may be distributed among several processing components. In an illustrative configuration, the sponsor computer 110 may include one or more processors 180, one or more memories 170 (generically referred to herein as memory 170), one or more input/output (“I/O”) interface(s) 182, and one or more network interface(s) 184.

The memory 170 may include any of the types of memory described through reference to the memory 120 of the healthcare provider computer 104, the memory 134 of the service provider computer 106, and/or the memory 152 of the claims processor computer 108. The memory 170 may store computer-executable instructions that are loadable and executable by the processor(s) 180, as well as data manipulated and/or generated by the processor(s) 180 during the execution of the computer-executable instructions. For example, the memory 170 may store one or more operating systems (O/S) 176; one or more database management systems (DBMS) 174; one or more data files 178; and one or more program modules, applications, or the like such as, for example, a host module 172. The host module 172 may include computer-executable instructions that in response to execution by the processor(s) 180 may cause various processing described herein to be performed. In order to perform such processing, these program modules may utilize at least a portion of the data files 178 and/or data stored in one or more external data stores (not shown). It should be appreciated that the host module 172 may correspond to a collection of program modules, applications, or the like that may support associated functionality.

The data files 178 may include any suitable information such as, for example, patient eligibility data associated with one or more sponsor programs. The patient eligibility data may include data that identifies each patient that has been deemed eligible for one or more types of healthcare services included in one or more sponsor programs. The data files 178 may further include data indicative of criteria used to determine patient eligibility for sponsored healthcare services. Such criteria may include, for example, a number and/or type of medical conditions of a patient, a number and/or type of prescription products taken by a patient, and so forth.

The host module 172 may initiate, receive, process, and/or respond to requests, such as requests for patient eligibility data or updates thereto, requests for adjudication of healthcare transactions received from the host module 136 of the service provider computer 106, and so forth.

The (O/S) 176 loaded into the memory 170 may provide an interface between other application software (e.g., the host module 172) executing on the sponsor computer 110 and hardware resources of the sponsor computer 110. More specifically, the O/S 176 may include a set of computer-executable instructions for managing hardware resources of the sponsor computer 110 and for providing common services to other application programs (e.g., managing memory allocation among various application programs). The O/S 176 may include any of the types of operating systems described through reference to the O/S 124 of the healthcare provider computer 104, the O/S 138 of the service provider computer 106, and/or the O/S 156 of the claims processor computer 108.

While not depicted in FIG. 1, the sponsor computer 110 may further include additional data storage such as any of the types of additional data storage described through reference to the healthcare provider computer 104, the service provider computer 106, and/or the claims processor computer 108. It should be appreciated that any data and/or computer-executable instructions stored in the memory 170 may be additionally, or alternatively, stored in additional data storage and/or one or more external data stores. The DBMS 174 may support functionality for accessing, retrieving, storing, and/or manipulating data stored in external datastore(s), data stored in the memory 170 and/or data stored in additional data storage. The DBMS 174 may use any of a variety of database models (e.g., relational model, object model, etc.) and may support any of a variety of query languages.

The processor(s) 180 may be configured to access the memory 170 and execute computer-executable instructions stored therein. For example, the processor(s) 180 may be configured to execute computer-executable instructions of the host module 172 to cause the performance of various operations in accordance with one or more example embodiments of the disclosure. The processor(s) 180 may include any suitable processing unit capable of accepting digital data as input, processing the input data in accordance with stored computer-executable instructions, and generating output data. The processor(s) 180 may include any of types of processors described through reference to the processor(s) 128 of the healthcare provider computer 104, the processor(s) 146 of the service provider computer 106, and/or the processor(s) 162 of the claims processor computer 108.

As previously noted, the sponsor computer 110 may further include one or more I/O interfaces 182 that may facilitate the receipt of input information by the sponsor computer 110 via an I/O device as well as the output of information from the sponsor computer 110 to an I/O device. The I/O devices with which the sponsor computer 110 may communicate using the I/O interface(s) 182 may include any of the types of I/O devices described through reference to the healthcare provider computer 104, the service provider computer 106, and/or the claims processor computer 108.

As previously noted, the sponsor computer 110 may be configured to communicate with any of a variety of other systems, platforms, devices, and so forth (e.g., the healthcare provider computer 104, the service provider computer 106, the claims processor computer 110, etc.) via one or more of the network(s) 168. The sponsor computer 110 may include one or more network interfaces 184 that may facilitate communication between the sponsor computer 110 and any of the above-mentioned systems, platforms or devices.

Various methodologies as described herein may be practiced in the context of distributed computing environments. For example, the network(s) 168 may include a plurality of networks, each with devices such as gateways and routers for providing connectivity between or among the components of the system 100. Instead of or in addition to the network(s) 168, dedicated communication links may be used to connect various devices in accordance with one or more example embodiments. For example, the service provider computer 106 may form the basis of a network 168 that interconnects the healthcare provider computer 104, the claims processor computer 108, and/or the sponsor computer 110.

Those of ordinary skill in the art will appreciate that any of the components of the architecture 100 may include alternate and/or additional hardware, software or firmware components beyond those described or depicted without departing from the scope of the disclosure. More particularly, it should be appreciated that software, firmware or hardware components depicted or described as forming part of any of the illustrative components of the architecture 100, and the associated functionality that such components support, are merely illustrative and that some components may not be present or additional components may be provided in various example embodiments. While various program modules have been depicted and described with respect to various illustrative components of the architecture 100, it should be appreciated that functionality described as being supported by the program modules may be enabled by any combination of hardware, software, and/or firmware.

It should further be appreciated that each of the above-mentioned modules may, in various example embodiments, may represent a logical partitioning of supported functionality. This logical partitioning is depicted for ease of explanation of the functionality and may not be representative of the structure of software, firmware and/or hardware for implementing the functionality. Accordingly, it should be appreciated that functionality described as being provided by a particular module may, in various example embodiments, be provided at least in part by one or more other modules. Further, one or more depicted modules may not be present in certain example embodiments, while in other example embodiments, additional modules not depicted may be present and may support at least a portion of the described functionality and/or additional functionality. Further, while certain modules may be depicted and described as sub-modules of another module, in certain example embodiments, such modules may be provided as independent modules.

Those of ordinary skill in the art will appreciate that the system architecture 100 depicted in FIG. 1 is provided by way of example only. Numerous other operating environments, system architectures, and device and network configurations are possible. Other system embodiments can include fewer or greater numbers of components and may incorporate some or all of the functionality described with respect to the system components shown in FIG. 1. For example, in an illustrative embodiment, the service provider computer 106 and/or other devices forming part of the architecture 100 may be implemented as a specialized processing machine that includes hardware and/or software for performing the methods described herein. In addition, at least a portion of the processor(s) 146 and/or the processing capabilities of the service provider computer 106 and/or the healthcare service eligibility determination module 116 may be implemented as part of a claims processor computer 108 and/or a sponsor computer 110. Accordingly, embodiments of the disclosure should not be construed as being limited to any particular operating environment, system architecture, or device or network configuration.

### Illustrative Operational Overview

FIGS. 2A-2C are block diagrams illustrating example data flows in connection with the processing of a healthcare transaction as the transaction is communicated through a system or device operated by a service provider, such as the service provider computer 106 illustrated in FIG. 1. The illustrative data flows depicted in FIGS. 2A-2C assume that patient eligibility data files corresponding to one or more sponsor programs have been received from one or more sponsor computers 110 by a service provider system and that patient eligibility data has been extracted therefrom and stored in one or more data stores (e.g., one or more of the datastore(s) 118). By storing the patient eligibility in one or more of the datastore(s) 118, the service provider computer 106 and/or the healthcare service eligibility determination module 116 is provided access to the data for utilization as part of the healthcare service eligibility determination processing. The illustrative data flows of FIGS. 2A-2C further assume that sponsor profile data, client profile data, and data that associates sponsor programs with client profiles and that configures the associated sponsor programs in accordance with client specifications have been stored in one or more of the data store(s) 118.

Referring to FIG. 2A, a healthcare provider computer, such as the healthcare provider computer 104 illustrated in FIG. 1, may receive a request 205 from a patient or other entity acting at the authorization of the patient. According to one or more example embodiments of the disclosure, the request 205 may be a request to fill a prescription communicated to the healthcare provider computer 104 at a location associated with the healthcare provider (e.g., a pharmacy). In other example embodiments, the request 205 may be communicated to a healthcare provider computer 104 via one or more suitable network connections. For example, a purchase request may be communicated to a healthcare provider computer 104 from a customer computer via a web portal hosted by the healthcare provider computer 104.

The healthcare provider computer 104 may receive and process the request 205 to generate a healthcare transaction 210 such as a prescription claim transaction. While the illustrative data flows depicted in FIG. 2A will be described in the context of a healthcare claim transaction such as billing transaction, it should be appreciated that other types of healthcare transactions (e.g., predetermination of benefits transactions, healthcare order transactions, etc.) may be encompassed as well. The illustrative data flows of FIG. 2B will be described in the context of an electronic prescription order (an “e-prescription transaction” or simply an “e-prescription”).

According to the illustrative embodiment depicted in FIG. 2A, the healthcare transaction 210 may be formatted in accordance with a version of the National Council for Prescription Drug Programs (“NCPDP”) Telecommunication Standard, although other standards may be utilized as well. As desired, the healthcare transaction 210 may include a BIN Number, a BIN Number and a PCN, or a BIN Number and Group ID for identifying a claims processor computer (or other designated recipient), such as the claims processor computer 108 illustrated in FIG. 1, as a destination of the healthcare transaction 210. In addition, the healthcare transaction 210 may also include information relating to a patient, a payor, a prescriber, a healthcare provider, and/or a prescription drug or other medical product or service.

As an example, the healthcare transaction 210 received by the service provider computer 106 may include one or more of the following types of information:

Payor ID/Routing Information for each Identified Payor or Other Designated Recipient
BIN Number, BIN Number and PCN, or BIN Number and Group ID that designates an intended destination of the healthcare transaction 210

Patient Information
Name (e.g., Patient Last Name, Patient First Name, etc.)
Date of Birth of Patient
Age of Patient
Gender Code
Patient ID or other identifier (e.g., a Social Security Number)

Insurance/Coverage Information
Cardholder Name (e.g., Cardholder First Name, Cardholder Last Name)
Cardholder ID and/or other identifier (e.g., person code)

Provider (e.g., Prescriber, Pharmacy) Information
Primary Care Provider ID or other identifier (e.g., National Provider Identifier (NPI) code)
Primary Care Provider Name (e.g., Last Name, First Name)
Prescriber ID or other identifier (e.g., NPI code)
Prescriber Name (e.g., Last Name, First Name)
Prescriber Contact Information (e.g., Telephone Number)
Pharmacy or other Healthcare Provider Information (e.g., store name, chain identifier, etc.)
Pharmacy or other Healthcare Provider ID (e.g., NPI code)

Claim Information
Drug, product or healthcare service information (e.g., National Drug Code (NDC))
Prescription/Service Reference Number
Date Prescription Written
Quantity Dispensed
Days Supply
Diagnosis/Condition
Pricing information for the drug or product (e.g., network price, Usual & Customary price, etc.)

Diagnostic equipment and/or medical testing facilities available at the Pharmacy or other Healthcare Provider

Laboratory Results for Patient

Certification information relating to Pharmacy or other Healthcare Provider

Date of Service.

In certain example embodiments, information included in a healthcare transaction may be arranged and/or organized into one or more data fields. Additionally, the healthcare transaction may include any number of message fields that may be utilized to provide additional information and/or to communicate messages.

While the following description may, at times, state that a device or entity (e.g., healthcare provider computer 104, service provider computer 106, claims processor computer 108, healthcare service eligibility determination module 116, etc.) communicates a request, message, reply, and so forth to another device or entity, it should be appreciated that a device or entity directing, at least in part, the communication of a request, message, reply, and so forth to another device or entity is also encompassed.

Referring to FIG. 2A, the service provider computer 106 may receive the healthcare transaction 210 from the healthcare provider computer 104. Upon receipt of the transaction 210, the service provider computer 106 may optionally perform one or more pre-edits on the healthcare transaction 210. The pre-edits may verify, add, and/or edit information included in the healthcare transaction 210 prior to the healthcare transaction 210 being communicated to an appropriate claims processor computer 108 or other designated recipient.

In one or more example embodiments of the disclosure, the service provider computer 106 may parse the healthcare transaction 210 to determine if the transaction 210 includes override information (e.g., an override code) for bypassing healthcare service eligibility determination processing. If the service provider computer 106 determines that the healthcare transaction 210 does not include override information, the service provider computer 106 may transmit the healthcare transaction 210, a copy of the healthcare transaction 210, or at least some portion of the information included in the healthcare transaction 210 to the healthcare service eligibility determination module 116 as part of a request or an instruction to perform healthcare service eligibility determination processing.

While the healthcare transaction 210 will be described as being transmitted by the service provider computer 106 to the healthcare service eligibility determination module 116 in the following discussion, it should be appreciated that, in various example embodiments, a portion of the information included in the transaction 210 may be extracted and transmitted to the healthcare service eligibility determination module 116, or a copy of the transaction 210 may be made and transmitted. It should further be noted that determinations made or processing performed in response to execution of computer-executable instructions provided as part of the healthcare service eligibility determination module 116 may be described at times as being performed by the module 116 itself. Further, in various example alternative embodiments, the healthcare service eligibility determination module 116 may include one or more processing units for executing computer-executable instructions for performing one or more aspects of the healthcare service eligibility determination processing. In such example alternative embodiments, the computer-executable instructions may be provided as part of the module 116 or externally to the module 116. In addition, although various processing is described below as being performed by the healthcare service eligibility determination module 116, it should be appreciated that any portion of the described functionality may be provided by the service provider computer 106.

Upon receipt of the healthcare transaction 210, computer-executable instructions provided as part of the healthcare service eligibility determination module 116 may be executed to perform processing to determine whether information included in the healthcare transaction 210 satisfies one or more qualifying criteria for a healthcare service sponsor program. As previously described, the qualifying criteria may include whether the transaction is formatted in accordance with an appropriate standard (e.g., a NCPDP Telecommunication Standard); whether the transaction 210 is a billing transaction (which may be determined, for example, based on a transaction code included in the transaction 210); whether the healthcare provider on whose behalf the transaction 210 was submitted has contracted with the service provider to receive patient eligibility notification services (which may be determined, for example, based on a healthcare provider ID (e.g., an NPI code) included in the transaction 210); whether the transaction 210 is qualified for one or more third party payor plans (which may be determined, for example, based on a BIN Number, and optionally a PCN or Group ID, identifying a claims processor); whether the transaction 210 qualifies for the sponsor program's date of service range (which may be determined, for example, based on a comparison of a date of service retrieved from an appropriate field in the transaction 210 to stored information indicative of a date of service range associated with the sponsor program); and so forth.

The qualifying criteria may additionally, or alternatively, include whether the sponsor program has been linked to or otherwise associated with a client profile that corresponds to the healthcare provider. A sponsor program may be associated with a client profile by storing an identifier of the sponsor and/or the sponsor program (e.g., a sponsor ID) in a same data record or a data record that is linked to a data record storing an identifier of the client (e.g., a client ID). In certain example embodiments, although the client may have contracted with the service provider to receive patient eligibility notifications in connection with certain sponsor programs, the healthcare transaction may nonetheless be assessed with respect to all sponsor programs for which healthcare service eligibility sponsors have contracted with the service provider to provide patient eligibility notification services.

In order to determine whether the transaction 210 satisfies qualifying criteria of one or more sponsor programs, the healthcare service eligibility determination module 116 may compare certain information extracted from the healthcare transaction 210 to expected values (e.g., the transaction code), while other information extracted from the transaction 210 (e.g., healthcare service provider ID, BIN number, PCN, etc.) may be compared against eligibility data stored in one or more of the data store(s) 118 to determine if matching records exist. For example, the healthcare provider ID extracted from the transaction 210 may be compared against healthcare provider IDs for which corresponding client profiles exist to determine if a matching healthcare service provider is found, in which case it may be determined that the healthcare provider associated with the transaction 210 contracted with the service provider to receive patient eligibility notifications. As another non-limiting example, date of service information may be identified in the transaction 210 and compared against information stored in or as part of sponsor profiles to determine whether the date of service for the transaction 210 falls within date of service ranges for sponsor programs that correspond to the sponsor profiles.

If the healthcare service eligibility determination module 116 determines that the claim transaction 210 fails to satisfy qualifying criteria for any sponsor program with respect to which the transaction is assessed, the healthcare service eligibility determination module 116 may communicate a message 215 to the service provider computer 106 indicative of this determination and the healthcare service eligibility determination processing may halt. Upon receipt of the message 215, the service provider computer 106 may route the transaction 210 to the claims processor computer 108 for adjudication. The service provider computer 106 may, according to one or more example embodiments of the disclosure, utilize at least a portion of the information included in the healthcare transaction 210, such as a BIN Number, a BIN Number and PCN, or a BIN Number and Group ID, to determine the appropriate claims processor computer 108 (or other designated recipient) to which the healthcare transaction 210 is to be routed. The service provider computer 106 may also include a routing table, optionally stored in memory, for identifying the designated recipient.

The claims processor computer 108 (or other designated recipient) may receive and adjudicate or otherwise process the healthcare transaction 210. For example, the claims processor computer 108 may determine benefits coverage for the healthcare transaction 210. The results of the adjudication processing performed by the claims processor computer 108 may be communicated in an adjudicated reply 220 or response to the service provider computer 106. As desired, the service provider computer 106 may optionally perform post-processing on the adjudicated reply 215, which may include any number of post-edits to the reply 215. Thereafter, the service provider computer 106 may route or otherwise direct communication of the adjudicated reply 220 to the healthcare provider computer 104. Prior to routing the reply 220 to the healthcare provider computer 104, the service provider computer 106 may determine whether the reply 220 indicates that the transaction 210 was approved or rejected and store information indicative of this determination.

On the other hand, if the healthcare service eligibility determination module 116 determines that the healthcare transaction 210 satisfies applicable qualifying criteria for one or more sponsor programs, the healthcare service eligibility determination module 116 may perform additional healthcare service eligibility determination processing to determine whether information included in the healthcare transaction 210 indicates that patient eligibility criteria for one or more of the qualified sponsor programs is satisfied.

As part of such processing, the healthcare service eligibility determination module 116 may identify patient information and, optionally, claims processor information included in the healthcare transaction 210 and compare the information identified from the healthcare transaction 210 to data extracted from patient eligibility files received from program sponsors and stored in one or more of the data store(s) 118. For example, in certain example embodiments, such as those in which a program sponsor is also a claims processor, a BIN Number (and optionally a PCN or Group ID), a cardholder identifier (e.g., a cardholder ID) assigned by the claims processor to the patient, and a person code may be identified from corresponding data fields in the healthcare transaction 210 and compared to stored patient eligibility data to determine whether a match exists.

More specifically, in certain example embodiments, the BIN Number, the BIN Number and PCN, the BIN Number and Group ID, or the BIN Number, PCN and Group ID may be identified from the healthcare transaction 210 and compared to data stored in corresponding data fields of each sponsor profile corresponding to each qualified sponsor program. If a match is found for a particular sponsor profile, the Cardholder ID Cardholder ID and Person Code identified from the healthcare transaction 210 may be compared against Cardholder IDs and/or Cardholder IDs and Person Codes included in the patient eligibility data for that sponsor profile in order to determine if a match exists. If a match is found, the healthcare service eligibility determination module 116 may determine that the patient identified in the healthcare transaction 210 is also identified in the patient eligibility data of the sponsor profile, and thus, that the patient is eligible for one or more types of healthcare services included in the sponsor program to which the sponsor profile corresponds.

It should be appreciated that any of a variety of types of patient identifying information may be identified from the healthcare transaction 210 and compared to patient eligibility data to determine whether a patient match can be detected. For example, a patient name (e.g., first and/or last name), patient address information (e.g., zip code), a patient's date of birth, or any other suitable patient identifying information may be used in addition to, or as an alternative to, the patient identifying information discussed earlier. For example, in certain example embodiments, such as those in which a program sponsor is not a payor or claims processor for an insurance plan under which the patient is covered, and thus, does not have access to a patient's Cardholder ID or Cardholder ID and Person Code, various types of patient information identified from the healthcare transaction 210 may be compared against corresponding types of patient information included in patient eligibility data to determine if a match exists. As a non-limiting example, the patient's last name, date of birth, and address zip code may be identified from the healthcare transaction 210 and compared to corresponding data types in patient eligibility data corresponding to sponsor profiles associated with qualified sponsor programs. In certain example embodiments, probabilistic matching algorithms or techniques may be employed as various types of patient identifying information may be non-unique to a particular patient.

If a patient match is detected, the healthcare service eligibility determination module 116 may perform further data comparisons to determine whether the healthcare transaction 210 satisfies other eligibility criteria for the sponsor program. For example, a date of service may be identified from the healthcare transaction and compared to a patient initiation date, a patient termination date, and/or a patient opportunity due date identified in the patient eligibility data included in or linked to the sponsor profile corresponding to the sponsor program. More specifically, in certain example embodiments, if it is determined that the date of service identified from the healthcare transaction 210 is on or after the patient initiation date, on or before a patient termination date, and on or before a patient opportunity due date, the patient may be determined to be eligible for the corresponding type of healthcare service offered under the sponsor program.

If the healthcare service eligibility determination module 116 fails to detect a patient match for any particular qualified sponsor program, or if other eligibility criteria are not met, the module 116 may communicate a message 225 to the service provider computer 106 indicating the results of the healthcare service eligibility determination processing, and the healthcare service eligibility determination processing may halt. It should be appreciated that in various example embodiments, the at least a portion of the information included in the message 215 may be combined with at least a portion of the information included in the message 225 as part of a single message or a set of one or more messages communicated together to the service provider computer 106.

Upon receipt of the message 225, the service provider computer 106 may route the transaction 210 to the claims processor computer 108 for adjudication, optionally performing pre-processing on the transaction 210 prior to routing the transaction 210 to the claims processor computer 108. The service provider computer 106 may receive the adjudicated reply 220 to the transaction 210, optionally perform post-processing on the adjudicated reply 220, and route the reply 220 to the healthcare provider computer 104. Prior to routing the reply 220 to the healthcare provider computer 104, the service provider computer 106 may determine whether the reply 220 indicates that the transaction 210 was approved or rejected and store information indicative of this determination in, for example, one or more of the data store(s) 118.

Upon determining that the healthcare transaction satisfies patient eligibility criteria for at least one qualified sponsor program, the service provider computer 106 and/or the healthcare service eligibility determination module 116 may perform further processing to determine a client notification preference for receiving the patient eligibility notification. The client notification preference may be specified as a configuration parameter in a client profile associated with the healthcare provider and stored in one or more of the data store(s) 118. As previously noted, the client notification preference may correspond to a pre-adjudication rejection, a post-adjudication message appended to or otherwise associated with an adjudicated reply, a pre-adjudication rejection in combination with a post-adjudication message, a message communicated to a recipient designated by the client, or any other suitable notification mechanism.

The healthcare service eligibility determination module 116 may communicate a message 230 to the service provider computer 106 that includes an indication that the patient is eligible for one or more types of healthcare services under one or more sponsor programs. The message 230 may further include an indication of the client notification preference, an indication of the healthcare service(s) for which the patient is eligible, an indication (e.g., sponsor ID(s)) of the sponsor program(s) that include the healthcare service(s) for which the patient is eligible, and optionally, one or more access tokens if required by the sponsor(s).

In those example embodiments in which the client's notification preference is a pre-adjudication rejection, upon receipt of the message 230, the service provider computer 106 may generate a claim transaction rejection 235 that may include a rejection code and a patient eligibility notification message that identifies a type of healthcare service for which the patient is eligible (e.g., CMR) and optionally additional information such as an access token. The pre-adjudication rejection 235 may further include override information such as an override code that may be included in a resubmitted healthcare transaction 240 received from the healthcare provider computer in order to bypass healthcare service eligibility determination processing in connection with the resubmitted healthcare transaction 240. The override code may be provided by the healthcare service eligibility determination module 116 or another source. Alternatively, the service provider computer 106 may generate the override code.

In certain example embodiments, the healthcare transaction 210 may satisfy patient eligibility criteria for multiple sponsor programs. In such example embodiments, the healthcare service eligibility determination module 116 may perform further processing to identify a highest priority sponsor program. The highest priority sponsor program may be identified based at least in part on a configuration parameter specified for a sponsor program associated with a client profile associated with the healthcare provider. In certain example embodiments, a patient eligibility notification may be generated and communicated to the healthcare provider computer 104 from which the healthcare transaction 210 is received (or a third party recipient designated by the healthcare provider) in connection with only the highest priority sponsor program. In other example embodiments, one or more patient eligibility notifications may be generated and communicated for multiple sponsor programs with patient eligibility criteria met by the healthcare transaction 210, potentially in order of priority assigned to the sponsor programs.

Upon receipt of the pre-adjudication rejection 235 by the healthcare provider computer 104, an employee of the healthcare provider may identify the patient eligibility notification included therein. In particular, the type of healthcare service identified in the notification may be identified. The healthcare provider computer 104 may then generate, potentially responsive to user input, a resubmission 240 of the healthcare transaction 210 that includes the override code provided in the received claim transaction rejection 235. The resubmitted healthcare transaction 240 may be transmitted by the healthcare provider computer 104 to the service provider computer 106. Upon receipt of the resubmitted healthcare transaction 240, the service provider computer 106 may identify the override code included in the resubmitted healthcare transaction 240, compare the included override code to a set of override codes stored, for example, in one or more of the data store(s) 118, to identify a match and determine a function of the included override code, bypass the healthcare service eligibility determination processing in response to determining the function of the included override code, perform any desired pre-processing on the claim transaction 240, and route the transaction 240 to the claims processor computer 108 for adjudication. Upon receipt of the adjudicated reply 245, the service provider computer 106 may perform optional post-processing on the adjudicated reply 245 and communicate the adjudicated reply 245 to the healthcare provider computer 104.

In those example embodiments in which the client notification preference is indicated in the message 230 to be a post-adjudication message, the service provider computer 106 may perform any desired pre-processing on the claim transaction 210, and route the transaction 210 to the claims processor computer 108 for adjudication. Upon receipt of the adjudicated reply 220, the service provider computer 106 may perform optional post-processing on the adjudicated reply 220, generate and append or otherwise associate a patient eligibility notification message with the adjudicated reply 220 (such as by inserting the message into one or more data fields of the adjudicated reply 220), and communicate the adjudicated reply and associated patient eligibility notification 250 to the healthcare provider computer 104. As previously noted with respect to the example embodiment in which the client notification preference is a pre-adjudication rejection, the patient eligibility notification message that is appended to or otherwise associated with the adjudicated reply may include an identification of a type of healthcare service for which the patient is eligible (e.g., TMR) and optionally additional information such as an access token. In certain example embodiments, prior to routing the adjudicated reply and associated patient eligibility notification 250 to the healthcare provider computer 104, the service provider computer 106 may determine whether the adjudicated reply 220 indicates that the claim transaction 210 was approved or denied and store data indicative of this determination. In certain example embodiments, the patient eligibility notification may be generated and communicated to the healthcare provider computer 104 only in those scenarios in which the claim transaction 210 was approved.

In other example embodiments, a client notification preference may specify that a patient eligibility notification is to be delivered as part of both the pre-adjudication rejection 235 and the adjudicated reply with patient eligibility message 250 appended thereto. In still other example embodiments, a client notification preference may specify that a patient eligibility notification message 255 is to be delivered to a third party recipient 260 designated by the healthcare provider. The third party recipient 260 may be identified by a configuration parameter specified as part of a client profile, within the healthcare transaction 210, or via any other suitable mechanism. In those example embodiments in which the patient eligibility notification 255 is to be communicated to a designated third party recipient 260, the notification 255 may be delivered as part of e-mail message, a message delivered to a pharmacy call center, or via any other suitable mechanism.

Upon communication of the patient eligibility notification message to the healthcare provider computer 104 (either as part of pre-adjudication rejection or in connection with an adjudicated reply), the service provider computer 106 may perform processing to store data indicating that the patient eligibility notification was generated and communicated. The stored data may include an identifier of the healthcare provider (e.g., a healthcare provider ID), patient identifying information (e.g., Cardholder ID, Patient First Name, Person Code, address information, contact information, etc.), an identifier of the sponsor (e.g., a sponsor ID), data indicative of the type of sponsor (e.g., a pharmacy benefit manager (PBM)), data indicative of the type of notification (e.g., pre-adjudication rejection), a date and/or time the notification was sent, and so forth. It should be appreciated that the above-described information that is captured in relation to the patient eligibility notification is merely illustrative and not exhaustive. A prescription number or other identifier may be used to link the stored data relating to a particular patient eligibility notification that has been sent to a patient identifier (e.g., a cardholder ID, a patient identifier generated by the service provider system, etc.) and/or a sponsor ID.

FIG. 2B depicts illustrative data flows that may occur as part of healthcare service eligibility determination processing performed in connection with an electronic prescription order (an “e-prescribing transaction”). A prescriber of medication or healthcare products or services, or an entity acting on behalf of a prescriber, may submit a request 270 to a first healthcare provider computer 104A, which may be, for example, a computer associated with a physician's office or the like. Based on the information included in the request 270, the first healthcare provider computer 104A may generate an e-prescribing transaction 272 and may communicate the e-prescribing transaction 272 to the service provider computer 106.

Upon receipt of the e-prescribing transaction 272, the service provider computer 106 may parse the transaction 272 to determine if the transaction 272 includes override information (e.g., an override code) for bypassing healthcare service eligibility determination processing. If the service provider computer 106 determines that the transaction 272 does not include override information, the service provider computer 106 may transmit the transaction 272, a copy of the transaction 272, or at least some portion of the information included in the transaction 272 to the healthcare service eligibility determination module 116 as part of a request or an instruction to perform healthcare service eligibility determination processing.

Upon receipt of the transaction 272, computer-executable instructions provided as part of the healthcare service eligibility determination module 116 may be executed to perform processing to determine whether information included in the transaction 272 satisfies one or more qualifying criteria for a healthcare service sponsor program. The qualifying criteria may include any of the criteria previously described and/or additional or alternative criteria.

If the healthcare service eligibility determination module 116 determines that the transaction 272 fails to satisfy qualifying criteria for any sponsor program with respect to which the transaction 272 is assessed, the healthcare service eligibility determination module 116 may communicate a message 274 to the service provider computer 106 indicative of this determination and the healthcare service eligibility determination processing may halt. Upon receipt of the message 274, in certain example embodiments, the service provider computer 106 may route the transaction 272 to a second healthcare provider computer 104B such as a pharmacy computer.

In certain other example embodiments, upon receiving the message 274, the service provider computer 106 may route the transaction 272 to an appropriate claims processor computer 108 associated with a claims processor such as, for example, a PBM. The claims processor computer 108 may adjudicate the received transaction 272 and communicate an adjudicated response 276 to the service provider computer 106 that may include information relating to patient eligibility, formulary information, and so forth. The service provider computer 106 may, according to one or more example embodiments of the disclosure, utilize at least a portion of the information included in the transaction 272, such as a BIN Number, a BIN Number and PCN, or a BIN Number and Group ID, to determine the appropriate claims processor computer 108 (or other designated recipient) to which the transaction 272 is to be routed. The service provider computer 106 may also include a routing table, optionally stored in memory, for identifying the designated recipient.

As desired, the service provider computer 106 may optionally perform post-processing on the adjudicated reply 276, which may include any number of post-edits to the reply 276. Thereafter, the service provider computer 106 may route or otherwise direct communication of the adjudicated reply 276 to the first healthcare provider computer 104A. Upon receipt of the adjudicated reply 276, a prescriber associated with the first healthcare provider computer 104A may review the information included in the reply 276 and either complete and authorize the e-prescription as originally submitted or modify the e-prescription in some manner (e.g., prescribe a different drug). The confirmation 278 of the e-prescription transaction 272 or the modified e-prescription transaction 278 may then be communicated from the first healthcare provider computer 104A to the service provider computer 106. The service provider computer 106 may then route the transaction 272 or the modified transaction 278 to the second healthcare provider computer 104B, which may be a pharmacy computer.

If, on the other hand, the healthcare service eligibility determination module 116 determines that the e-prescribing transaction 272 satisfies applicable qualifying criteria for one or more sponsor programs, the healthcare service eligibility determination module 116 may perform additional healthcare service eligibility determination processing to determine whether information included in the transaction 272 indicates that patient eligibility criteria for one or more of the qualified sponsor programs is satisfied. The processing to determine whether patient eligibility criteria for one or more qualified sponsor programs is satisfied may be similar to that described earlier through reference, for example, to FIG. 2A.

If the healthcare service eligibility determination module 116 fails to detect a patient match for any particular sponsor program, or if other eligibility criteria are not met, the module 116 may communicate a message 280 to the service provider computer 106 indicating the results of the healthcare service eligibility determination processing, and the healthcare service eligibility determination processing may halt. Upon receipt of the message 280, the service provider computer 106 may perform operations similar to those that may be performed responsive to receipt of the message 274. That is, the e-prescription transaction 272 may be routed to the second healthcare provider computer 104B without routing the transaction to the claims processor computer 108, or alternatively, the transaction 272 may be routed to the claims processor computer 108 for adjudication, and the adjudicated response 276 may be received by the service provider computer 106 and communicated to the first healthcare provider 104A for confirmation or modification of the transaction 272 as described earlier.

If, on the other hand, the healthcare service eligibility determination module 116 determines that the transaction 272 satisfies patient eligibility criteria for a sponsor program, the healthcare service eligibility determination module 116 may perform further processing to determine a client notification preference for receiving the patient eligibility notification. The client notification preference may be specified as a configuration parameter in a client profile associated with the first healthcare provider (e.g., prescriber) and stored in one or more of the data store(s) 118. As previously noted, the client notification preference may correspond to a pre-adjudication rejection, a post-adjudication message appended to or otherwise associated with an adjudicated reply, a pre-adjudication rejection in combination with a post-adjudication message, a message communicated to a recipient designated by the client, or any other suitable notification mechanism.

The healthcare service eligibility determination module 116 may communicate a message 282 to the service provider computer 106 that includes an indication that the patient is eligible for one or more types of healthcare services under one or more sponsor programs. The message 282 may further include an indication of the client notification preference, an indication of the healthcare service(s) for which the patient is eligible, an indication (e.g., sponsor ID(s)) of the sponsor program(s) that include the healthcare service(s) for which the patient is eligible, and optionally, one or more access tokens if required by the sponsor(s).

In those example embodiments in which the client's notification preference is a pre-adjudication rejection, upon receipt of the message 282, the service provider computer 106 may generate a transaction rejection 284 that may include a rejection code and a patient eligibility notification message that identifies a type of healthcare service for which the patient is eligible (e.g., CMR) and optionally additional information such as an access token. The pre-adjudication rejection 284 may further include override information such as an override code that may be included in a resubmitted e-prescription transaction 286 received from the first healthcare provider computer 104A in order to bypass healthcare service eligibility determination processing in connection with the resubmitted transaction 286. The override code may be provided by the module 116 or another source. Alternatively, the service provider computer 106 may generate the override code.

Upon receipt of the pre-adjudication rejection 284 by the first healthcare provider computer 104A, an employee of the first healthcare provider (e.g., a prescriber such as a physician, nurse practitioner, etc.) may identify the patient eligibility notification included therein. In particular, the type of healthcare service identified in the notification may be identified. As a non-limiting example, the patient eligibility notification may indicate one or more drugs that are typically prescribed for patients that have similar or the same medical conditions as those of the patient identified in the e-prescription transaction 272. Such a notification may inform the prescriber of a potential gap in medical care and lead the prescriber to prescribe one or more additional or alternative prescription drugs to treat the patient's medical condition.

The first healthcare provider computer 104 may generate, potentially responsive to user input, a resubmission 286 of the transaction 272 that includes the override code provided in the received transaction rejection 284. The resubmitted transaction 286 may be transmitted by the first healthcare provider computer 104 to the service provider computer 106 via, for example, one or more of the network(s) 168. Upon receipt of the resubmitted transaction 286, the service provider computer 106 may identify the override code included in the resubmitted transaction 286, compared the included override code to a set of override codes stored in, for example, one or more of the data store(s) 118, to identify a match and determine a function of the included override code, bypass the healthcare service eligibility determination processing in response to determining the function of the included override code, perform any desired pre-processing on the resubmitted transaction 286, and either route the transaction 286 to the second healthcare provider computer 104B or to the claims processor computer 108 for adjudication. Additional data flows that may occur if the transaction 286 is routed to the claims processor computer 108 are similar those described earlier and are not depicted for sake of simplicity.

In those example embodiments in which the client notification preference is indicated in the message 282 to be a post-adjudication message, the service provider computer 106 may perform any desired pre-processing on the transaction 272, and route the transaction 272 to the claims processor computer 108 for adjudication as described earlier. Upon receipt of the adjudicated reply 276 from the claims processor computer 108, the service provider computer 106 may perform optional post-processing on the adjudicated reply 276, generate and append or otherwise associate a patient eligibility notification message with the adjudicated reply 276 (such as, for example, by including the message in one or more data fields of the adjudicated reply 276), and communicate the adjudicated reply and associated patient eligibility notification 288 to the first healthcare provider computer 104. As previously noted with respect to the example embodiment in which the client notification preference is a pre-adjudication rejection, the patient eligibility notification message that is appended to or otherwise associated with the adjudicated reply may include an identification of a type of healthcare service for which the patient is eligible (e.g., TMR) and optionally additional information such as an access token. In certain example embodiments, prior to routing the adjudicated reply and associated patient eligibility notification 288 to the healthcare provider computer 104, the service provider computer 106 may determine whether the adjudicated reply 276 indicates that the transaction 272 was approved or denied and store data indicative of this determination in, for example, one or more of the data store(s) 118.

In each of the client notification preference scenarios noted earlier, upon delivery of the patient eligibility notification to the first healthcare provider computer 104A or to a recipient designated by the first healthcare provider, the service provider computer 106 may perform processing to store data indicating that the patient eligibility notification was generated and communicated in, for example, one or more of the data store(s) 118. The stored data may include an identifier of the healthcare provider (e.g., a healthcare service provider ID), patient identifying information (e.g., cardholder ID, patient name, person code, address information, contact information, etc.), an identifier of the sponsor (e.g., a sponsor ID), data indicative of the type of sponsor (e.g., a pharmacy benefit manager (PBM)), data indicative of the type of notification (e.g., pre-adjudication rejection), a date and/or time the notification was sent, and so forth. It should be appreciated that the above-described information that is captured in relation to the patient eligibility notification is merely illustrative and not exhaustive. A prescription number or other identifier may be used to link the stored data relating to a particular patient eligibility notification that has been sent to a patient identifier (e.g., a cardholder ID, a patient identifier generated by the service provider system, etc.) and/or a sponsor ID.

It will be appreciated that variations of the data flows schematically depicted in FIGS. 2A-2B may be utilized in accordance with various example embodiments. For example, as shown in FIG. 2C, the service provider computer 106 may be comprised of two or more distinct service provider computers 106a and 106b that are in communication with each other. Service provider computer 106a may be operative with one or more healthcare provider computers and/or claims processor computers such as the healthcare provider computer 104 and/or the claims processor computer 108 illustrated in FIG. 1. However, service provider computer 106b may have a data processing arrangement with service provider computer 106a. Under the data processing arrangement, the service provider computer 106a may be permitted to utilize or offer services of the service provider computer 106b, including those of the healthcare service eligibility determination module 116. For example, a first service provider may communicate healthcare transactions and/or other information to a second service provider for processing. It should be appreciated that the data flows and connectivity depicted in FIGS. 2A-2B are merely illustrative and not exhaustive and that numerous variations and alternatives are within the scope of this disclosure.

### Illustrative Processes

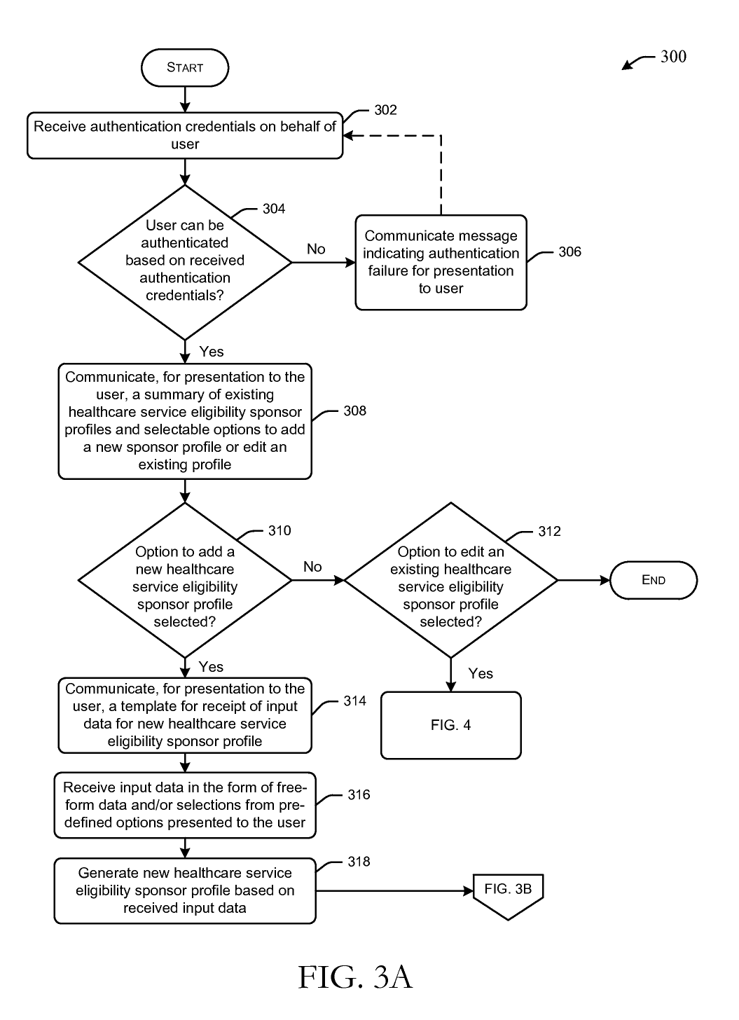

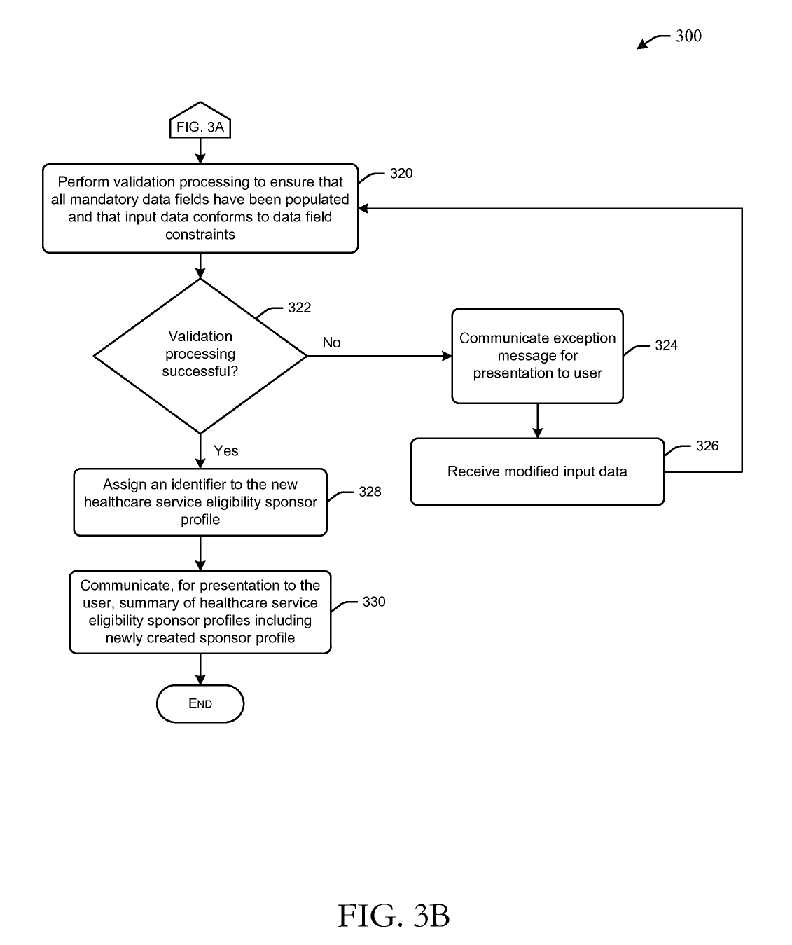

The illustrative methods described below through reference to any of FIGS. 3A-13 may be described in the context of a healthcare transaction that is a healthcare claim transaction; however, this is only by way of example as other healthcare transactions (which may include, for example, predetermination of benefits transactions, other healthcare billing transactions, e-prescription orders, etc.) could be substituted for the healthcare claim transaction and each form of healthcare transaction should each individually be read as being used in the methods described below.

FIGS. 3A-3B depict process flow diagrams of an illustrative method 300 for generating a new healthcare service eligibility sponsor profile for a contracted healthcare service program sponsor in accordance with one or more example embodiments of the disclosure. The new healthcare service eligibility sponsor profile (also referred to herein interchangeably as a “sponsor profile”) may be generated responsive to execution of computer-executable instructions provided as part of one or more program modules executing on the host server 186. In various example embodiments, the host server 186 may form part of a service provider system that may include one or more service provider computers 106 and/or the healthcare service eligibility determination module 116. The host server 186 may interact with the user application 114 to present information to a user of the user application 114 as well as to receive user input provided via the user application 114. While various operations may be described as being performed by the host server 186, it should be appreciated that such operations may be performed, at least in part, responsive to execution of computer-executable instructions provided as part of one or more program modules executing on the host server 186 and/or a service provider computer 106. Additionally, or alternatively, one or more operations of method 300 may be performed, at least in part, by the healthcare service eligibility determination module 116.

Referring now to FIG. 3A, at block 302, the host server 186 may receive authentication credentials from the user application 114 on behalf of a user. At block 304, the host server 186 may determine whether the user can be authenticated based at least in part on the received authentication credentials. In the event that the user has provided incorrect authentication credentials, a negative determination may be made at block 304, and the method 300 may proceed to block 306 where the host server 186 may communicate a message for presentation to the user via the user application 114. The message may provide an indication of authentication failure and may prompt the user to again provide authentication credentials which may be received at block 302.

On the other hand, if the host server 186 is able to authenticate the user based on the authentication credentials received at block 302, a positive determination may be made at block 304, and the method 300 may proceed to block 308 where the host server 186 may communicate, for presentation to the user via the user application 114, a summary of existing sponsor profiles. Selectable options to add a new sponsor profile and/or edit an existing sponsor profile may be presented to the user as well. An existing sponsor profile may include information identifying a program sponsor and various parameters of a sponsor program offered by the program sponsor, and may have been previously generated by the host server 186 responsive to input data received from a user via the user application 114.

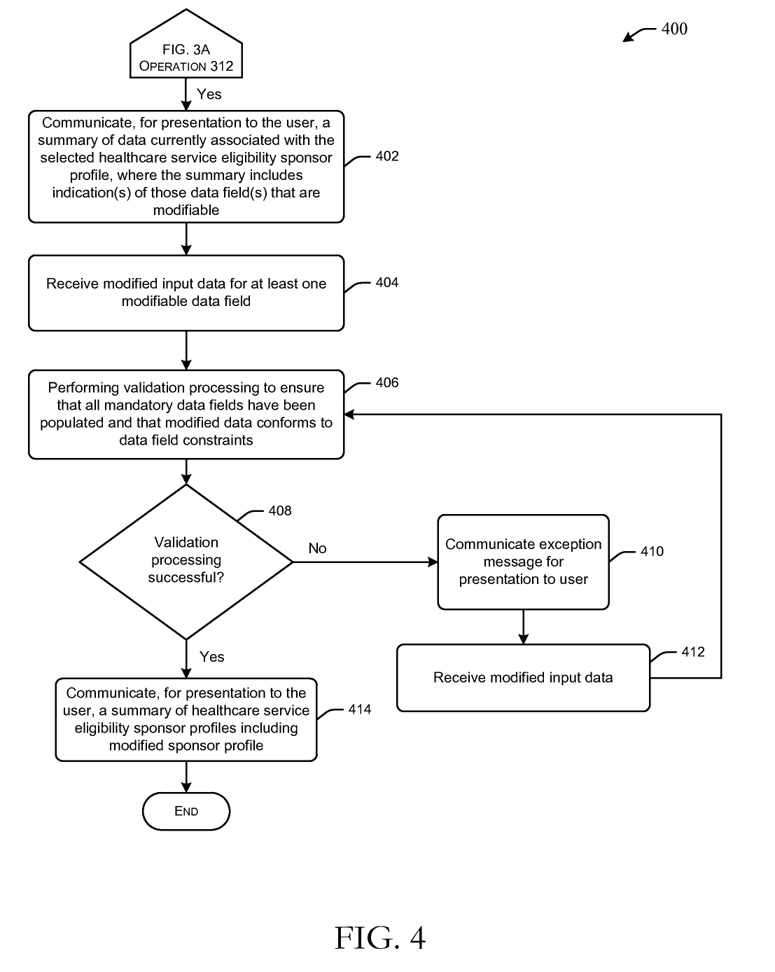

At block 310, the host server 186 may determine whether input has been received from the user indicating selection of the option to add a new sponsor profile. In the event of a negative determination at block 310, the method 300 may proceed to block 312 where the host server 186 may determine whether input has been received from the user indicating selection of the option to edit an existing sponsor profile. The processing may end in response to a negative determination at block 312. On the other hand, in the event of a positive determination at block 312, the operations depicted in FIG. 4 may be performed, which will be described in greater detail later in this disclosure.

Referring again to the determination at block 310, if the host server 186 determines that input has been received from the user indicating selection of the option to add a new sponsor profile, the method 300 may proceed to block 314 where the host server 186 may communicate, for presentation to the user via the user application 114, a template for receiving input data for the new sponsor profile.

At block 316, the host server 186 may receive input data from the user application 114 provided to the user application 114 by the user. The input data may be in the form of free-form data and/or selections of pre-defined options presented to the user. The input data may be entered into data fields presented to the user in a web form or the like via the user application 114. The input data may be provided by a user in accordance with a contract between the program sponsor and a service provider to provide patient eligibility notification services. The input data may include, for example, sponsor identifying information such as a sponsor name, sponsor contact information, and so forth. The input data may further include data identifying the types of healthcare services covered under the sponsor program (e.g., CMR, TMR, etc.), data indicating whether patient medication history may be accessed to determine patient eligibility for healthcare services, data indicating whether an access token is to be provided with a patient eligibility notification, and if so, potentially an expiration date for the access token, and data indicating a date range for the sponsor program.

The input data may further include an indication of those payors qualified to adjudicate claim transactions directed to healthcare services covered under the sponsor program. All payors may be specified or some subset of payors may be specified. Payor identification information such as BIN Numbers and, optionally, PCNs and/or Group IDs may be provided as input data. Payor information may be selected from pre-defined options or entered as free-form data. The input data may further include data that specifies those clients that are eligible to render healthcare services covered under the sponsored program. All clients may be specified or some subset of clients may be specified. Clients may be identified by a healthcare service provider identifier or the like.

At block 318, the host server 186 may generate a new sponsor profile based at least in part on the received input data. Generation of the new sponsor profile may include the creation of one or more data records populated with the input data.

Referring now to FIG. 3B, at block 320, the host server 186 may perform validation processing to ensure that all mandatory data fields have been populated and that the input data conforms to data field constraints. Based on the results of the validation processing, the host server 186 may determine at block 322 whether the validation processing was successful. In the event of a negative determination at block 322, the host server 186 may communicate an exception message for presentation to the user via the user application 114. The validation processing may fail if, for example, the user fails to specify input data for required data fields and/or input data provided for a data field fails to comply with the field definition. From block 324, the method 300 may proceed to block 326 where modified input data may be received from the user via the user application 114. Upon receipt of modified input, the host server 186 may again perform validation processing at block 320.

In the event of a positive determination at block 322, the host server 186 may assign, at block 328, a unique identifier (e.g., a sponsor ID) to the newly generated sponsor profile (and thus to the sponsor program represented by the sponsor profile). At block 330, the host server 186 may communicate, for presentation to the user via the user application 114, a summary of existing sponsor profile, which now includes the newly created sponsor profile.

FIG. 4 depicts a process flow diagram of an illustrative method 400 for editing an existing healthcare service eligibility sponsor profile for a contracted healthcare service program sponsor in accordance with one or more example embodiments of the disclosure. The existing sponsor profile may have been generated in accordance with the illustrative method 300 of FIGS. 3A-3B. While various operations may be described as being performed by the host server 186, it should be appreciated that such operations may be performed, at least in part, responsive to execution of computer-executable instructions provided as part on one or more program modules executing on the host server 186 and/or a service provider computer 106. Additionally, or alternatively, one or more operations of method 300 may be performed, at least in part, by the healthcare service eligibility determination module 116.

At block 402, the host server 186 may communicate, for presentation to a user via the user application 114, a summary of data currently associated with the selected sponsor profile. The summary may include indications of those data fields that may be modifiable and those that may not be modifiable. At block 404, the host server 186 may receive, from the user via the user application 114, modified input data for at least one modifiable data field. For example, the host server 186 may receive modified data for the sponsor name, the sponsor contact information, whether an access token is required, the sponsor program start and/or end dates, payors that are qualified to adjudicate healthcare transactions seeking reimbursement for healthcare service(s) covered under the sponsor program, clients that are authorized to render such healthcare service(s), and so forth. A non-limiting example of a non-modifiable data field is the sponsor ID.

At block 406, the host server 186 may perform validation processing on the modified input data to ensure that all mandatory data fields have been populated and that the modified input data conforms to data field constraints. Based on the results of the validation processing, the host server 186 may determine at block 408 whether the validation processing was successful. In the event of a negative determination at block 408, the host server 186 may communicate an exception message at block 410 for presentation to the user via the user application 114. The validation processing may fail if, for example, the user fails to specify input data for required data fields and/or input data provided for a data field fails to comply with the field definition. From block 410, the method 400 may proceed to block 412 where additional modified input data may be received from the user via the user application 114. Upon receipt of additional modified input data, the host server 186 may again perform validation processing at block 406.

In the event of a positive determination at block 408, the host server 186 may communicate, for presentation to the user via the user application 114, a summary of existing sponsor profiles, including the modified sponsor profile.

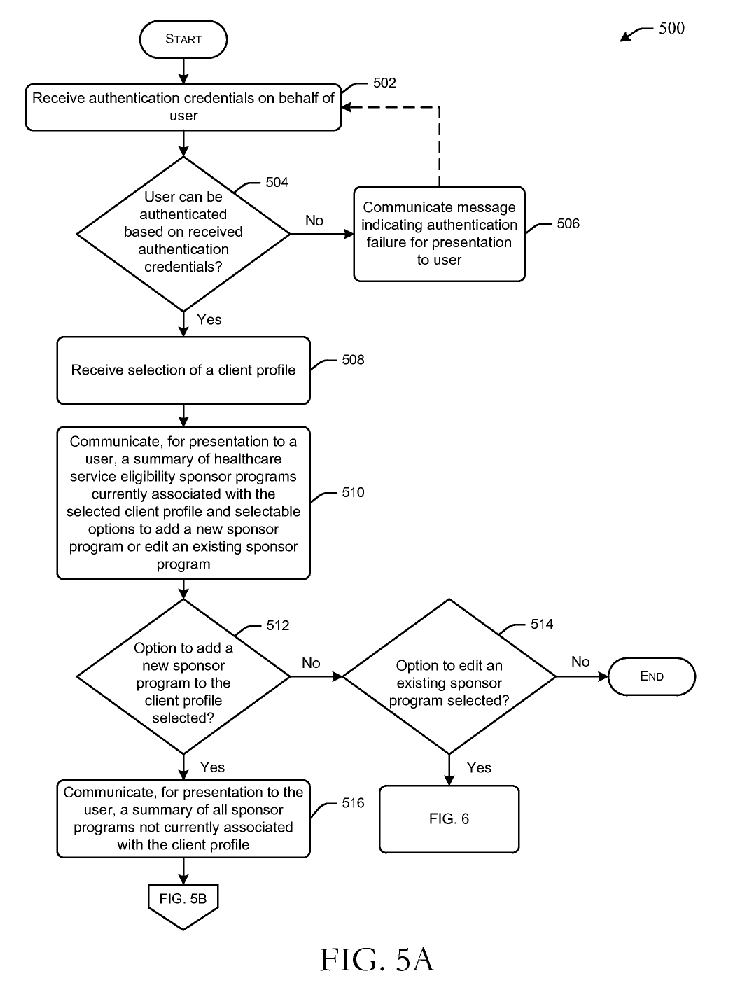

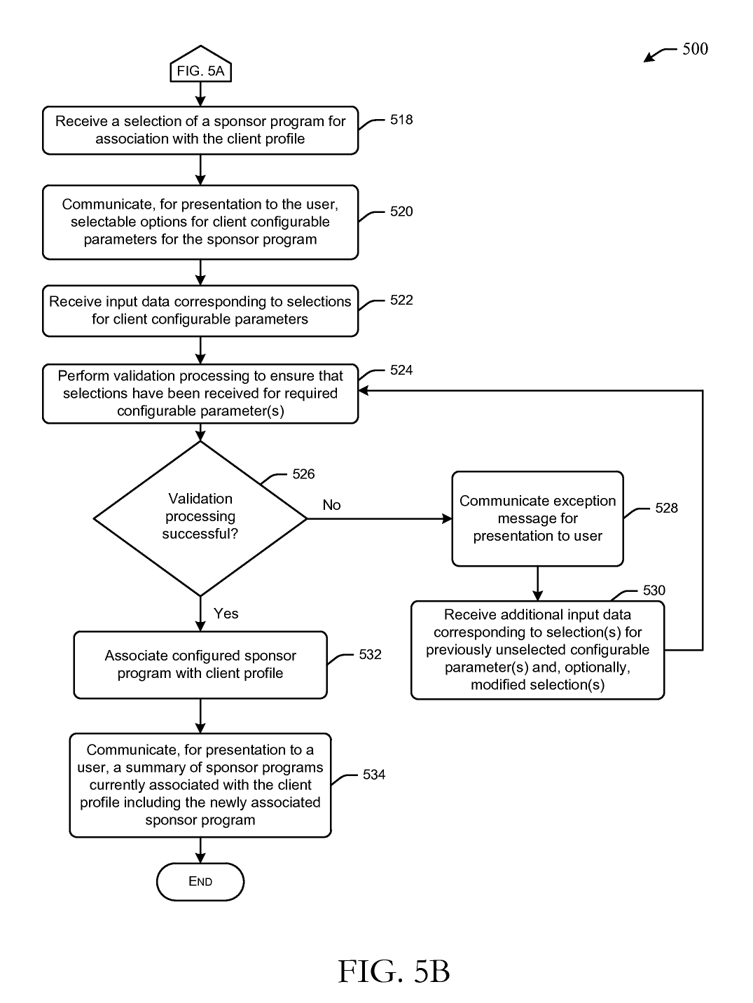

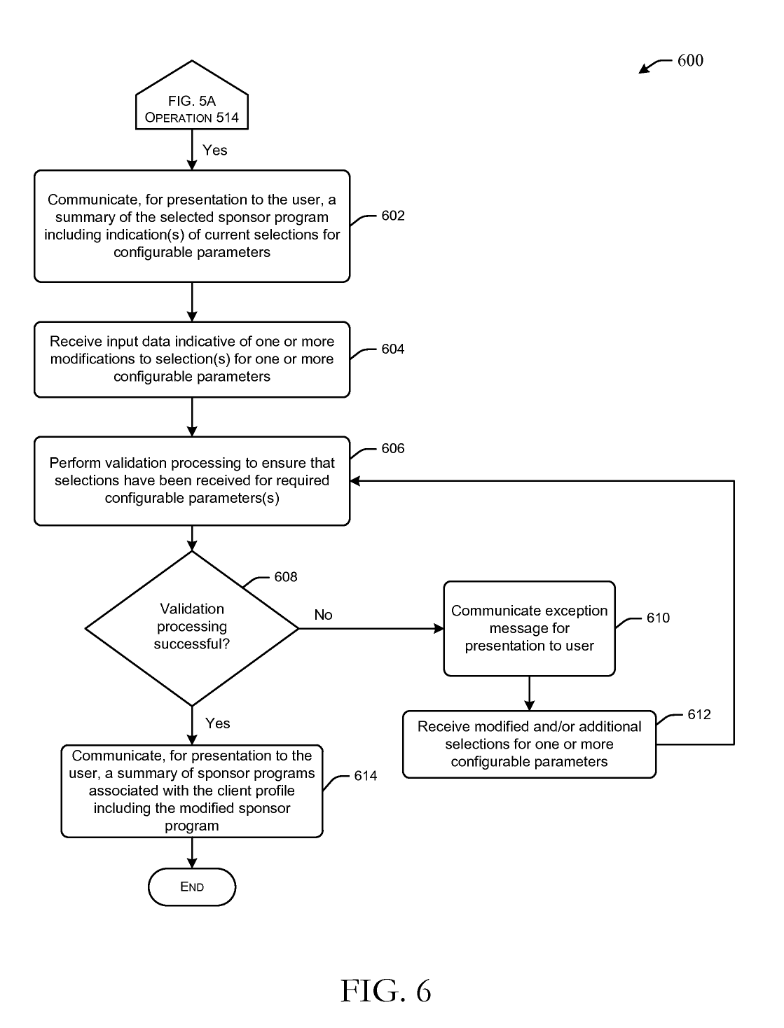

FIGS. 5A-5B depict process flow diagrams of an illustrative method 500 for associating a healthcare service eligibility sponsor program with a client profile in accordance with one or more example embodiments of the disclosure. While various operations may be described as being performed by the host server 186, it should be appreciated that such operations may be performed, at least in part, responsive to execution of computer-executable instructions provided as part on one or more program modules executing on the host server 186 and/or a service provider computer 106. Additionally, or alternatively, one or more operations of method 500 may be performed, at least in part, by the healthcare service eligibility determination module 116.

Referring now to FIG. 5A, at block 502, the host server 186 may receive authentication credentials from the user application 114 on behalf of a user. At block 504, the host server 186 may determine whether the user can be authenticated based at least in part on the received authentication credentials. In the event that the user has provided incorrect authentication credentials, a negative determination may be made at block 504, and the method 500 may proceed to block 506 where the host server 186 may communicate a message for presentation to the user via the user application 114. The message may provide an indication of authentication failure and may prompt the user to again provide authentication credentials which may be received at block 502.

On the other hand, if the host server 186 is able to authenticate the user based on the authentication credentials received at block 502, a positive determination may be made at block 504, and the method 500 may proceed to block 508 where the host server 186 may receive a user selection of a client profile via the user application 114. At block 510, the host server 186 may communicate, for presentation to the user via the user application 114, a summary of sponsor programs that are currently associated with the selected client profile. A selectable option to associate a previously unassociated sponsor program with the selected client profile as well as a selectable option to edit a sponsor program currently associated with the selected client profile may be presented to the user. A sponsor program that is associated with a client profile may include at least some of the information contained in the corresponding sponsor profile (e.g., sponsor identifying information, sponsor program parameters such as whether an access token is required, sponsor program start and end dates, etc.) as well as client configurations of the sponsor program. The client configurations may be specified in accordance with a contract between the client and the service provider providing the patient eligibility notification services.

At block 512, the host server 186 may determine whether input has been received from the user indicating selection of the option to associate a previously unassociated sponsor program with the selected client profile. In the event of a negative determination at block 512, the method 500 may proceed to block 514 where the host server 186 may determine whether input has been received from the user indicating selection of the option to edit a sponsor program currently associated with the selected client profile. The processing may end in response to a negative determination at block 514. On the other hand, in the event of a positive determination at block 514, the operations depicted in FIG. 6 may be performed, which will be described in greater detail later in this disclosure.

Referring again to the determination at block 512, if the host server 186 determines that input has been received from the user indicating selection of the option to associate a previously unassociated sponsor program with the selected client profile, the method 500 may proceed to block 516 where the host server 186 may communicate, for presentation to the user via the user application 114, a summary of all sponsor programs available for association with the sponsor program but not currently associated.

Referring now to FIG. 5B, at block 518, the host server 186 may receive, from the user application 114, an indication of a selection by the user of a sponsor program to associate with the selected client profile. At block 520, the host server 186 may communicate, for presentation to the user via the user application, one or more configurable parameters for the sponsor program. The configurable parameters may include, for example, a client notification preference (e.g., pre-adjudicated rejection, post-adjudication message, a combination of both, or notification to a dedicated recipient specified by the client), a notification frequency, a reject code and/or reject message to include in a pre-adjudication rejection, an approved code and/or message to include in a patient eligibility notification appended to or otherwise associated with an adjudicated response, a notification priority, and so forth.

At block 522, the host server 186 may receive input data from the user application 114 indicative of selections for the client configurable parameters. The selections may be made by the user from pre-defined options presented to the user and/or as free-form input. At block 524, the host server 186 may perform validation processing to ensure that selections were specified for those configurable parameters that are required. In certain example embodiments, the client notification preference parameter, the notification frequency parameter, and/or the reject message parameter (if the pre-adjudication rejection is chosen as the client notification preference) may be required parameters. It should be appreciated that these are merely example parameters that may be required and that in various other example embodiments, more, less, or different parameters may be required.

Based on the results of the validation processing, the host server 186 may determine at block 526 whether the validation processing was successful. In the event of a negative determination at block 526, the host server 186 may communicate an exception message at block 528 for presentation to the user via the user application 114. From block 528, the method 500 may proceed to block 530 where additional input data corresponding to selection(s) for previously unselected configurable parameter(s) and, optionally, modified selection(s) may be received from the user via the user application 114. Upon receipt of the additional input data, and optionally modified input data, the host server 186 may again perform validation processing at block 524.

In the event of a positive determination at block 526, the host server 186 may, at block 532, configure the sponsor program in accordance with the specified selections for the configurable parameters and associate the configured sponsor program with the selected client profile. At block 534, the host server 186 may communicate, for presentation to the user via the user application 114, a summary of sponsor programs currently associated with the selected client profile including the newly associated configured sponsor program.

FIG. 6 depicts a process flow diagram of an illustrative method 600 for modifying one or more client configurable parameters for a healthcare service eligibility sponsor program associated with a client profile in accordance with one or more example embodiments of the disclosure. While various operations of method 600 may be described as being performed by the host server 186, it should be appreciated that such operations may be performed, at least in part, responsive to execution of computer-executable instructions provided as part of one or more program modules executing on the host server 186 and/or a service provider computer 106. Additionally, or alternatively, one or more operations of method 600 may be performed, at least in part, by the healthcare service eligibility determination module 116.

At block 602, the host server 186 may communicate, for presentation to a user via the user application 114, a summary of the selected sponsor program associated with a client profile. The summary may include indication(s) of current selections for configurable parameters. At block 604, the host server 186 may receive, from the user via the user application 114, input data indicative of one or more modifications to selection(s) for one or more configurable parameters. For example, the host server 186 may receive input data indicating a modified client notification preference, notification frequency, etc.

At block 606, the host server 186 may perform validation processing on the received input data to ensure that selections have been received for any required configurable parameter. Based on the results of the validation processing, the host server 186 may determine at block 608 whether the validation processing was successful. In the event of a negative determination at block 608, the host server 186 may communicate an exception message at block 610 for presentation to the user via the user application 114. From block 610, the method 600 may proceed to block 612 where modified and/or additional selections for one or more configurable parameters may be received from the user via the user application 114. Upon receipt of the modified and/or additional input data, the host server 186 may again perform validation processing at block 606.

In the event of a positive determination at block 608, the host server 186 may communicate, for presentation to the user via the user application 114, a summary of sponsor programs currently associated with the selected client profile, where the summary includes the modified sponsor program.

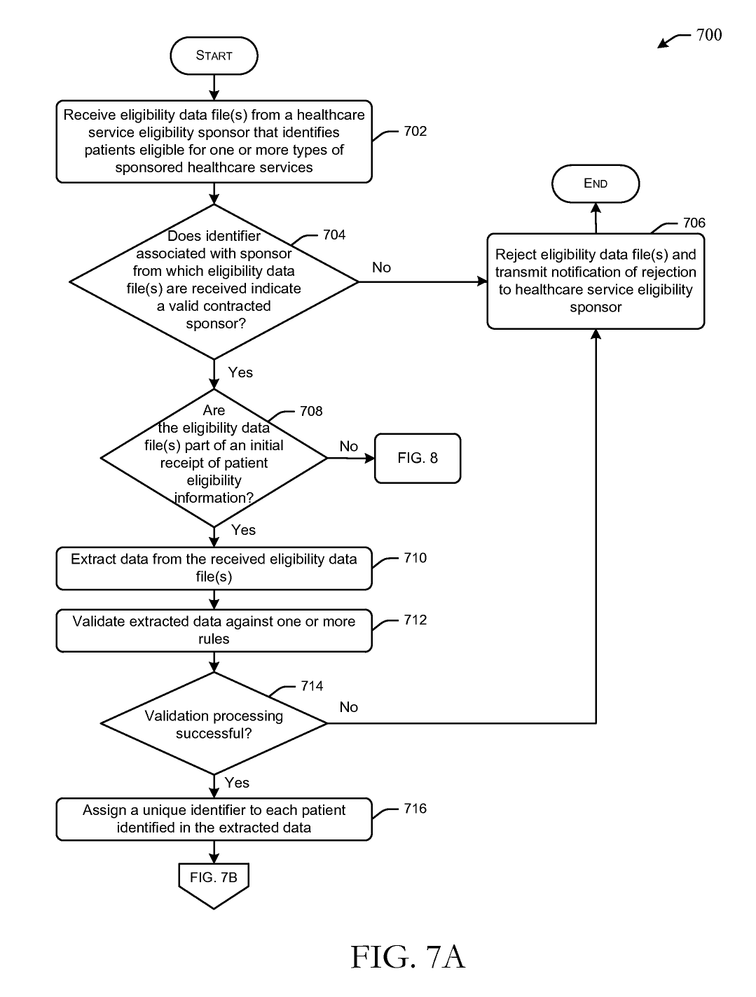

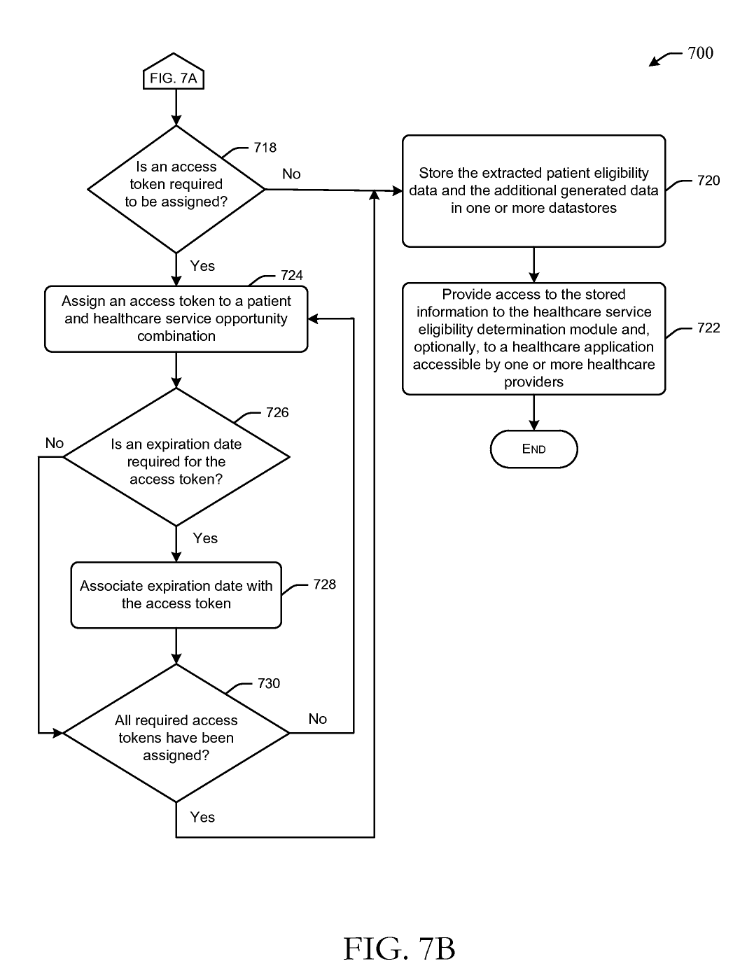

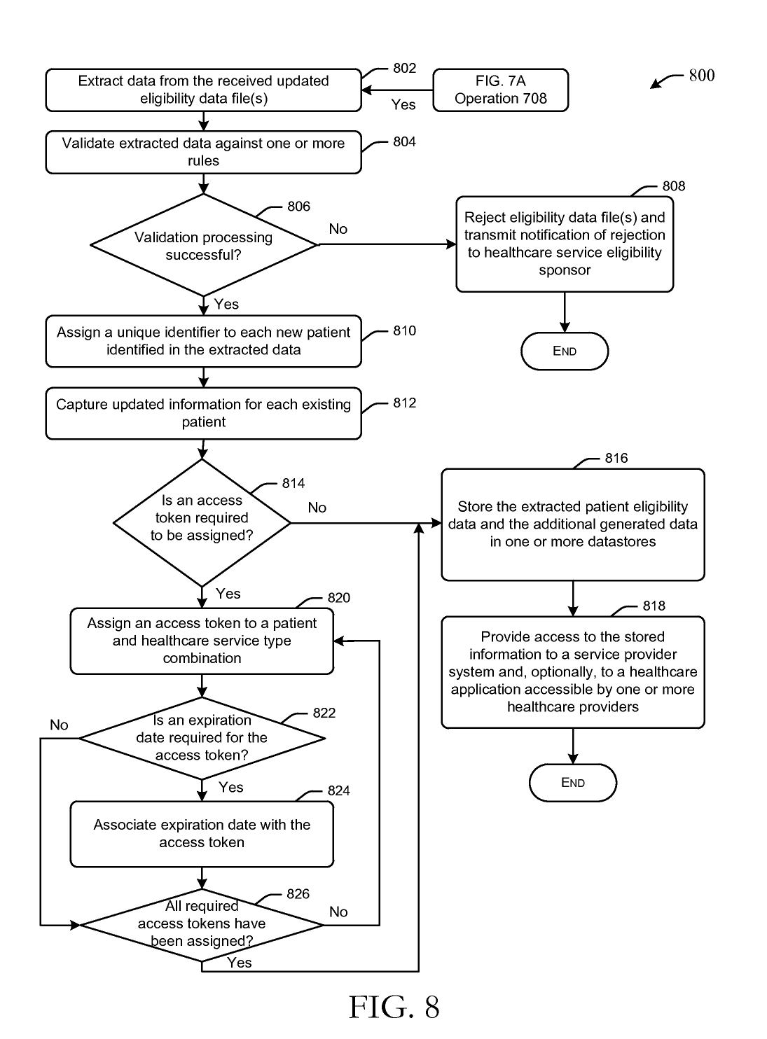

FIGS. 7A-7B depict process flow diagrams of an illustrative method 700 for receiving patient eligibility data file(s) from a healthcare service eligibility sponsor, validating the program sponsor and any data extracted from the patient eligibility data file(s), generating additional data associated with the extracted data, and storing the extracted data and the generated data in one or more data stores in accordance with one or more example embodiments of the disclosure. Various operations may be described as being performed by a service provider system that may include one or more servers, one or more service provider computers 106, and so forth. While operations may be described in this manner, it should be appreciated that such operations may be performed, at least in part, responsive to execution of computer-executable instructions provided as part on one or more program modules executing one or more devices of the service provider system. Additionally, or alternatively, one or more operations of method 700 may be performed, at least in part, by the host server 186 and/or the healthcare service eligibility determination module 116.

At block 702, one or more eligibility data files may be received by the service provider system 106. The eligibility data file(s) may be received, for example, from a sponsor computer 110 associated with a healthcare service eligibility sponsor. The eligibility data file(s) may identify those patients that are eligible to receive healthcare service(s) included in a sponsor program associated with the sponsor. The eligibility data file(s) may be comma delimited files presented in a specified format, and may include information associated with one or more patients eligible for healthcare services under a sponsor program. An illustrative eligibility file may include a header component that includes sponsor-related information such as the sponsor ID, sponsor name, and so forth.

The illustrative eligibility data file may further include respective information pertaining to one or more eligible patients. The information may include patient identifying information (e.g., patient first name, patient last name, patient date of birth, cardholder ID, person code, patient address information, patient contact information, etc.), patient demographic information (e.g., patient gender), eligibility information (e.g., type of healthcare service for which the patient is eligible, patient eligibility initiation date, patient eligibility termination date, patient healthcare service opportunity due date, etc.). In various example embodiments, some information included in the eligibility data file may be required while other information may be optional. In certain example embodiments, the eligibility date file may be received as an encrypted file. The remaining operations of method 700 will be described through reference to a single eligibility data file for ease of explanation; however, it should be appreciated that multiple eligibility data files may be received from a single sponsor.

At block 704, the service provider system may identify a sponsor ID included in the eligibility data file and determine whether the sponsor ID is associated with a valid contracted sponsor. In certain example embodiments, the service provider system may compare the sponsor ID against sponsor IDs of stored sponsor profiles to attempt to identify a match. If a match is not identified, the service provider system may determine at block 704 that the sponsor is not a valid sponsor, and the method 700 may proceed to block 706 where the service provider system may reject the eligibility data file and transmit a notification to the sponsor computer 110 indicating that the file has been rejected.

If, however, a match is identified, the sponsor may be determined to be a valid sponsor, and the method 700 may proceed to block 708 where the service provider system may determine whether the eligibility data file is part of an initial receipt of patient eligibility information for the sponsor. The service provider system may make this determination by attempting to locate previously stored eligibility data for the sponsor based on the sponsor ID. In the event of a negative determination at block 708, the eligibility data file may be deemed to include updated patient eligibility information and the operations of the method depicted in FIG. 8 may be performed, which will be described in greater detail hereinafter.

If, on the other hand, a positive determination is made at block 708 that the eligibility data file is the first receipt of patient eligibility information from the sponsor, the method may proceed to block 710 where data may be extracted from the patient eligibility file. At block 712, the extracted data may be validated against one or more rules which may include an evaluation of the extracted data with respect to one or more thresholds. For example, validation of the extracted data may include determining whether any mandatory information (e.g., patient last name) is included in the eligibility file.

At block 714, a determination may be made as to whether the validation processing performed at block 712 was successful. If a negative determination is made at block 714, the method 700 may proceed to block 706 where the service provider system may reject the eligibility data file and transmit a notification to the sponsor computer 110 indicating that the file has been rejected. If, on the other hand, a positive determination is made at block 714, the method may proceed to block 716 where a unique identifier may assigned to each patient identified in the extracted data.

Referring now to FIG. 7B, at block 718, the service provider system may make a determination as to whether an access token is required to be assigned to each patient and healthcare service opportunity combination. The service provider system may determine whether an access token is required based on a configuration parameter specified in a stored sponsor profile corresponding to the sponsor. For example, a Boolean flag or value in the sponsor profile may indicate whether an access token is required.

If it is determined at block 718 that an access token is not required, the method 700 may proceed to block 720 where the data extracted from the eligibility data file and additional generated data (e.g., patient identifiers) may be stored in one or more data stores such that each generated patient identifier is stored in a same data record as patient eligibility information corresponding to the patient identified by the patient identifier, or in a linked record. At block 722, access to the stored information may be provided by the service provider system to the healthcare service eligibility determination module 116 and, optionally, a healthcare application that provides healthcare providers with access to specific patient healthcare service opportunities.

If, on the other hand, it is determined at block 718 that access token assignment is required, the service provider system may select a particular patient and healthcare service opportunity combination and assign an access token to the combination. At block 726, a determination may be made as to whether an expiration date is required for the access token assigned at block 724. The service provider system may determine whether an expiration date is necessary based, for example, on information included in a sponsor profile corresponding to the sponsor program. If it is determined that no expiration date is required, the method 700 may proceed to block 730 where the service provider system may determine whether all required access tokens have been assigned. More specifically, the service provider system may determine at block 730 whether all patient and healthcare service opportunity combinations have been assigned an access token. If the service provider system determines that at least one patient and healthcare service opportunity combination has not been assigned an access token, the method 700 may proceed from block 730 to block 724, where an access token may be assigned to a patient and healthcare service opportunity combination.

If, on the other hand, it is determined at block 726 that an expiration date is required for the access token assigned at block 724, the method 700 may proceed to block 728 where an expiration date may be stored in association with the access token assigned at block 724. The method 700 may then proceed to block 730, as described above. The operations of blocks 724-730 may be performed iteratively until respective access tokens have been assigned to each patient and healthcare service opportunity combination.

If the service provider determines at block 730 that all required access tokens have been assigned, the method 700 may proceed to block 720, where the extracted patient eligibility data and additional generated data (e.g., patient identifiers) may be stored in one or more data stores. From block 720 the method 700 may proceed to block 722 as described earlier.

FIG. 8 depicts a process flow diagram of an illustrative method 800 for receiving updated eligibility data file(s) from a healthcare service eligibility sponsor, validating data extracted from the updated eligibility data file(s), generating additional data associated with the extracted data, and storing the extracted data and the generated data in one or more data stores in accordance with one or more example embodiments of the disclosure. Various operations may be described as being performed by a service provider system that may include one or more servers, one or more service provider computers 106, and so forth. While operations may be described in this manner, it should be appreciated that such operations may be performed, at least in part, responsive to execution of computer-executable instructions provided as part of one or more program modules executing one or more devices of the service provider system. Additionally, or alternatively, one or more operations of method 700 may be performed, at least in part, by the host server 186 and/or the healthcare service eligibility determination module 116. The operations of method 800 will be described through reference to a single eligibility data file for ease of explanation; however, it should be appreciated that multiple eligibility data files may be received from a single sponsor.

At block 802, the service provider system 106 may extract data from the received updated eligibility data file. The updated eligibility data file may identify those patients that are eligible to receive healthcare service(s) included in a sponsor program associated with the sponsor. The eligibility data file may further include respective information pertaining to one or more eligible patients. The information may include any of the illustrative patient identifying information, patient demographic information, eligibility information, and so forth described earlier. In certain example embodiments, the updated eligibility data file may include newly identified eligible patients and associated eligibility information and/or updated information for patients previously indicated as being eligible for one or more healthcare services under a sponsor program.

At block 804, the service provider system may validate extracted data against one or more rules which may include an evaluation of the extracted data with respect to one or more thresholds. For example, validation of the extracted data may include determining whether any mandatory information (e.g., patient last name) is included in the updated eligibility file.

A determination may then be made at block 806 as to whether the validation processing performed at block 804 was successful. If a negative determination is made at block 806, the method 800 may proceed to block 808 where the service provider system may reject the updated eligibility data file and transmit a notification to the sponsor computer 110 indicating that the file has been rejected. If, on the other hand, a positive determination is made at block 806, the method 800 may proceed to block 810 where a unique identifier may be assigned to each new patient identified in the extracted data. The method 800 may then proceed to block 812, where any updates to eligibility information for existing patients may be identified and stored. For example, updated information for a patient may include a new patient termination date, a new healthcare service opportunity due date for a patient, additional or alternative healthcare services for which a patient is eligible, and so forth.

At block 814, the service provider system may make a determination as to whether an access token is required to be assigned to each patient and healthcare service opportunity combination. The service provider system may determine whether an access token is required based on a configuration parameter specified in a stored sponsor profile corresponding to the sponsor. For example, a Boolean flag or value in the sponsor profile may indicate whether an access token is required.

If it is determined at block 814 that an access token is not required, the method 800 may proceed to block 816 where the data extracted from the updated eligibility data file and additional generated data (e.g., patient identifiers) may be stored in one or more data stores such that each newly generated patient identifier is stored in the same data record as patient eligibility information corresponding to the patient identified by the patient identifier, or in a linked record. At block 818, access to the stored information may be provided by the service provider system to the healthcare service eligibility determination module 116 and, optionally, a healthcare application that provides healthcare providers with access to specific patient healthcare service opportunities.

If, on the other hand, it is determined at block 814 that access token assignment is required, the service provider system may, at block 820, select a particular newly identified patient and a healthcare service opportunity for the patient and assign an access token to the combination. At block 822, a determination may be made as to whether an expiration date is required for the access token assigned at block 820. The service provider system may determine whether an expiration date is necessary based, for example, on information included in a sponsor profile corresponding to the sponsor program. If it is determined that no expiration date is required, the method 800 may proceed to block 826 where the service provider system may determine whether all required access tokens have been assigned. More specifically, the service provider system may determine at block 826 whether all patient and healthcare service opportunity combinations have been assigned an access token. If the service provider system determines that at least one patient and healthcare service opportunity combination has not been assigned an access token, the method 800 may proceed from block 826 to block 820, where an access token may be assigned to a patient and healthcare service opportunity combination.

If, on the other hand, it is determined at block 822 that an expiration date is required for the access token assigned at block 820, the method 800 may proceed to block 824 where an expiration date may be stored in association with the access token assigned at block 820. The method 800 may then proceed to block 826, as described above. The operations of blocks 820-826 may be performed iteratively until respective access tokens have been assigned to each patient and healthcare service opportunity combination.

If the service provider determines at block 826 that all required access tokens have been assigned, the method 800 may proceed to block 816, where the extracted updated eligibility data and additional generated data (e.g., patient identifiers) may be stored in one or more data stores. From block 816 the method 800 may proceed to block 818 as described earlier.

FIGS. 9A-9B depict process flow diagrams of an illustrative method 900 for receiving a healthcare transaction, determining whether the transaction qualifies for a healthcare service eligibility notification, and determining a client notification preference responsive to a determination that the transaction is a qualified transaction in accordance with one or more example embodiments of the disclosure. The various operations of method 900 may be performed, at least in part, by one or more service provider computers 106 and/or the healthcare service eligibility determination module 116. While certain operations may be described as being performed by a service provider computer 106, it should be appreciated that, in various example embodiments, at least a portion of such operations may be performed instead by the healthcare service eligibility determination module 116, and vice versa.

At block 902, a healthcare transaction may be received by a service provider computer 106 from a healthcare provider computer 104. The healthcare transaction may be, for example, a billing transaction such as a healthcare claim transaction, an e-prescribing transaction, or any other suitable transaction. Upon receipt of the healthcare transaction, the service provider computer 106 may optionally parse the transaction in an attempt to identify override information that may be included in the transaction. In the event that override information (e.g., an override code) is identified the transaction, the service provider computer 106 may bypass healthcare service eligibility determination processing, optionally perform other pre-processing on the transaction, and route the transaction to an intended recipient such as a claims processor computer 108 or another healthcare provider computer such as a pharmacy computer if the transaction is an e-prescribing transaction. If no override information is identified in the transaction, the service provider computer may communicate a request or an instruction to the healthcare service eligibility determination module 116 to perform healthcare service eligibility determination processing. As part of the request or instruction, the service provider computer 106 may communicate at least a portion of the information included in the transaction to the healthcare service eligibility determination module 116.

At block 904, the healthcare service eligibility determination module 116 may perform processing to determine whether the transaction qualifies for any sponsor program. As described earlier, in order to perform such processing, the healthcare service eligibility determination module 116 may identify various information included in the transaction (e.g., transaction code, patient identifying information, payor identifying information, etc.) and compare such information against information stored in one or more sponsor profiles.

At block 906, a determination may be made as to whether the transaction qualifies for one or more sponsor programs based on the results of the processing performed at block 904. If the healthcare service eligibility determination module 116 determines, at block 906, that the healthcare transaction does not qualify for any sponsor program, the method 900 may proceed to block 908, where the healthcare transaction may be routed to an appropriate claims processor computer 108 for adjudication, or to another intended recipient such as a pharmacy computer. If, on the other hand, the healthcare service eligibility determination module 116 determines that the transaction satisfies one or more sponsor programs, the method 900 may proceed to block 910, where the healthcare service eligibility determination module 116 may perform processing to determine whether the transaction meets patient eligibility criteria for any of the qualified sponsor programs.

As described earlier, the processing performed at block 910 may include identifying patient identifying information, payor information, or the like from the transaction and comparing such information to patient eligibility data associated with the qualified sponsor program(s) to determine whether the patient identified in the transaction is eligible for one or more types of healthcare services under one or more qualified sponsor programs. The healthcare service eligibility determination module 116 may make a determination at block 912 as to whether the transaction satisfies the patient eligibility criteria for one or more qualified sponsor programs based on the results of the processing performed at block 910.

If the healthcare service eligibility determination module 116 determines that the transaction fails to meet the patient eligibility criteria for any of the qualified sponsor program(s), the method 900 may proceed to block 908, where the healthcare transaction may be routed to an appropriate claims processor computer 108 for adjudication, or to another intended recipient such as a pharmacy computer. If, on the other hand, the healthcare service eligibility determination module 116 determines that the patient eligibility criteria is satisfied for at least one qualified sponsor program, the method 900 may proceed to block 914, where the module 116 may determine whether providing a patient eligibility notification in connection with the received transaction would violate a specified notification frequency for the healthcare provider. More specifically, a client profile associated with the healthcare provider may be accessed and a value specified for the client notification frequency parameter may be identified. This value may be incremented and compared against a counter storing a value indicative of a number of patient eligibility notifications sent to the healthcare provider, potentially over some specified period of time. If the incremented value is less than the counter, a negative determination may be made at block 914. If the incremented value is greater than the counter, a positive determination may be made at block 914.

If a positive determination is made at block 914, the method 900 may proceed to block 908, where the healthcare transaction may be routed to an appropriate claims processor computer 108 for adjudication, or to another intended recipient such as a pharmacy computer. If, on the other hand, a negative determination is made at block 914, the method 900 may proceed to block 916. Referring now to FIG. 9B, at block 916, the healthcare service eligibility determination module 116 may determine whether the transaction meets the patient eligibility criteria for multiple sponsor programs. For example, the healthcare service eligibility determination module 116 may determine whether the transaction meets the patient eligibility criteria for multiple healthcare services. If a negative determination is made at block 916, the method 900 may proceed to block 920, without performing the operation at block 918. On the other hand, if a positive determination is made at block 916, the method 900 may proceed to block 918.

At block 918, the healthcare service eligibility determination module 116 may identify the sponsor program having the highest priority. In various example embodiments, the module 116 may access a client profile associated with the healthcare provider and identify a respective value specified for the notification priority parameter specified for each sponsor program for which the transaction satisfies associated patient eligibility criteria. The module 116 may then identify which sponsor program has the highest value specified by the notification priority parameter. In certain example embodiments, the client profile associated with the healthcare provider may specify an assigned priority for each available healthcare service. The module 116 may then identify the healthcare service, of the multiple healthcare services for which the patient is eligible, having the highest assigned priority.

Upon identifying the highest priority sponsor program (or the highest priority healthcare service) at block 918, the healthcare service eligibility determination module 116 may, at block 920, determine the client notification preference specified for the highest priority sponsor program or the highest priority healthcare service. The client notification preference may be determined by accessing the client profile for the healthcare provider and identifying the notification preference specified for the corresponding configurable parameter for the sponsor program. In certain example embodiments, specific codes, values or the like may be associated with specific client notification types.

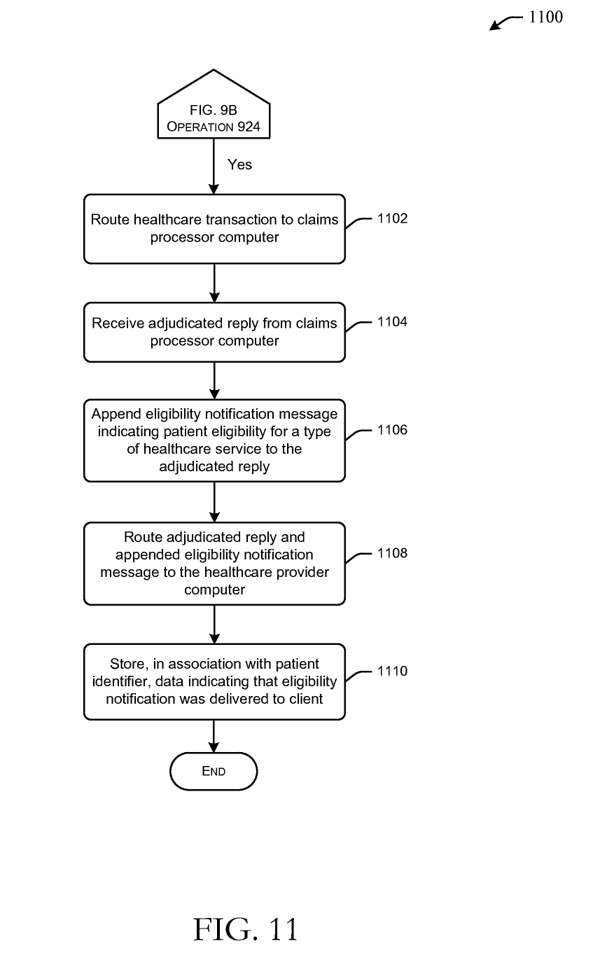

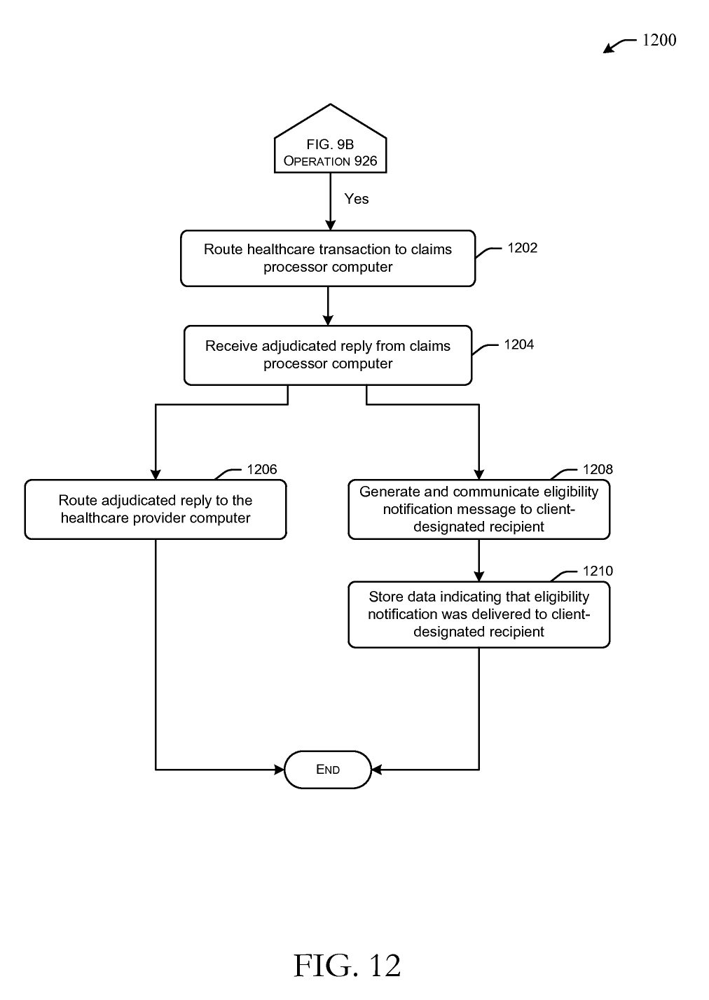

A series of determinations may then be made with respect to the type of notification preference. For example, a determination may be made at block 922 as to whether the client notification preference is a pre-adjudication rejection. In response to a positive determination at block 922, the operations of the illustrative method depicted in FIG. 10 may be performed, as will be described in greater detail hereinafter. In response to a negative determination at block 922, the healthcare service eligibility determination module 116 may determine, at block 924, whether the client notification preference is a post-adjudication message. In response to a positive determination at block 924, the operations of the illustrative method depicted in FIG. 11 may be performed, as will be described in greater detail hereinafter. In response to a negative determination at block 924, the method 900 may proceed to block 926, where a determination may be made as to whether the client notification preference is a notification to be sent to a recipient designated by the healthcare provider. In response to a positive determination at block 926, the operations of the illustrative method depicted in FIG. 12 may be performed, as will be described in greater detail hereinafter. In response to a negative determination at block 926, the method 900 may end. It should be appreciated that in various example embodiments additional types of client notification preferences may be specified and alternate processing may be performed for such additional types of client notification preferences.

FIG. 10 depicts a process flow diagram of an illustrative method 1000 for providing a patient eligibility notification to a healthcare provider as part of a pre-adjudication rejection in accordance with one or more example embodiments of the disclosure. The various operations of method 1000 may be performed, at least in part, by one or more service provider computers 106 and/or the healthcare service eligibility determination module 116. While certain operations may be described as being performed by a service provider computer 106, it should be appreciated that, in various example embodiments, at least a portion of such operations may be performed instead by the healthcare service eligibility determination module 116, and vice versa.

As previously noted, prior to the operations of method 1000 being performed, the healthcare service eligibility determination module 116 may have determined that the client notification preference for a sponsor program is a pre-adjudication rejection. The module 116 may have communicated a message to the service provider computer 106 that includes an indication that the patient is eligible for one or more types of healthcare services under one or more sponsor programs. The message may further include an indication that the client notification preference is a pre-adjudication rejection, an indication of the healthcare service(s) for which the patient is eligible, an indication (e.g., sponsor ID(s)) of the sponsor program(s) that include the healthcare service(s) for which the patient is eligible, and optionally, one or more access tokens if required by the sponsor(s).

At block 1002, the service provider computer 106 may generate a healthcare transaction rejection that may include a rejection code and a patient eligibility notification message that identifies a type of healthcare service for which the patient is eligible (e.g., CMR) and optionally additional information such as an access token. The rejection code may be identified from the client profile associated with the healthcare provider based on a corresponding configured parameter for the sponsor program.

At block 1004, the service provider computer 106 may communicate the rejection to the healthcare provider computer from which the healthcare transaction was received. At block 1006, the service provider computer 106 and/or the healthcare service eligibility determination module 116 may store data indicating that the patient eligibility notification was generated and communicated. The stored data may include an identifier of the healthcare provider (e.g., a healthcare service provider ID), patient identifying information (e.g., Cardholder ID, Patient First Name, Patient Last Name, Person Code, address information, contact information, etc.), an identifier of the sponsor (e.g., a sponsor ID), data indicative of the type of sponsor (e.g., a pharmacy benefit manager (PBM)), data indicative of the type of notification (e.g., pre-adjudication rejection), a date and/or time the notification was sent, and so forth.

At block 1008, the service provider computer 106 may receive a resubmitted healthcare transaction from the healthcare provider computer. For example, in certain example embodiments, upon receipt of the pre-adjudication rejection by the healthcare provider computer, an employee of the healthcare provider may identify the patient eligibility notification included therein. In particular, the type of healthcare service identified in the notification may be identified. The healthcare provider computer may then generate, potentially responsive to user input, a resubmission of the healthcare transaction that potentially includes the override code provided in the received claim transaction rejection.

Upon receipt of the resubmitted healthcare transaction, the service provider computer and/or the healthcare service eligibility determination module may perform processing to determine, at block 1010, whether the resubmitted healthcare transaction includes an override code. In response to a positive determination at block 1010, the healthcare service eligibility determination processing may be bypassed, and the method 1000 may proceed to block 1012, where the service provider computer 106 may perform any desired pre-processing on the resubmitted claim transaction and route the transaction to an appropriate claims processor for adjudication. At block 1014, the service provider computer 106 may receive an adjudicated reply from the claims processor computer. Upon receipt of the adjudicated reply, the service provider computer 106 may perform optional post-processing on the adjudicated reply and communicate the adjudicated reply to the healthcare provider computer at block 1016. On the other hand, in response to a negative determination at block 1010, the method 1000 may proceed to block 904 of the method 900 depicted in FIGS. 9A-9B for initiation of healthcare service eligibility determination processing by the healthcare service eligibility determination module 116, as described earlier.

FIG. 11 depicts a process flow diagram of an illustrative method 1100 for providing a patient eligibility notification to a healthcare provider as part of a post-adjudication message in accordance with one or more example embodiments of the disclosure. The various operations of method 1100 may be performed, at least in part, by one or more service provider computers 106 and/or the healthcare service eligibility determination module 116. While certain operations may be described as being performed by a service provider computer 106, it should be appreciated that, in various example embodiments, at least a portion of such operations may be performed instead by the healthcare service eligibility determination module 116, and vice versa.

In those example embodiments in which the client notification preference is a post-adjudication message, the service provider computer 106 may receive an indication of such from the healthcare service eligibility determination module 116. In particular, as described earlier, the service provider computer 106 may receive a message from the module 116 that includes an indication of the healthcare service(s) for which the patient is eligible, an indication that the client notification preference is a post-adjudication message, an indication (e.g., sponsor ID(s)) of the sponsor program(s) that include the healthcare service(s) for which the patient is eligible, and optionally, one or more access tokens if required by the sponsor(s).

At block 1102, the service provider computer 106 may route the healthcare transaction to an appropriate claims processor computer for adjudication. At block 1104, the service provider computer 106 may receive an adjudicated reply to the healthcare transaction from the claims processor computer. At block 1106, the service provider computer 106 and/or the healthcare service eligibility determination module 116 may append (or otherwise associate) a patient eligibility notification to the adjudicated reply. The patient eligibility notification message may include an identification of a type of healthcare service for which the patient is eligible (e.g., TMR) and optionally additional information such as an access token.

At block 1108, the service provider computer 106 may communicate the adjudicated reply and the patient eligibility notification to the healthcare provider computer. In certain example embodiments, the service provider computer 106 and/or healthcare service eligibility determination module 116 may determine whether the adjudicated reply indicates an approval or denial of the healthcare transaction, and generate and transmit the patient eligibility notification if the transaction was approved.

At block 1110, the service provider computer 106 and/or the healthcare service eligibility determination module 116 may store data indicating that the patient eligibility notification was generated and communicated. The stored data may include any of the types of data previously described through reference to the pre-adjudication rejection example embodiment discussed above.

FIG. 12 depicts a process flow diagram of an illustrative method 1200 for providing a patient eligibility notification to a recipient designated by a healthcare provider in accordance with one or more example embodiments of the disclosure. The various operations of method 1200 may be performed, at least in part, by one or more service provider computers 106 and/or the healthcare service eligibility determination module 116. While certain operations may be described as being performed by a service provider computer 106, it should be appreciated that, in various example embodiments, at least a portion of such operations may be performed instead by the healthcare service eligibility determination module 116, and vice versa.

At block 1202, the service provider computer 106 may route the received healthcare transaction to a claims processor computer for adjudication. At block 1204, the service provider computer 106 may receive an adjudicated reply from the claims processor computer. At block 1206 the service provider computer 106 may communicate the adjudicated reply to the healthcare provider computer.

Operations at blocks 1208 and 1210 may be performed, in various example embodiments, at least partially concurrently with the routing of the adjudicated reply to the healthcare provider computer. At block 1208, the service provider computer 106 and/or healthcare service eligibility determination module 116 may generate a patient eligibility notification message that may include any of the types of information previously described, and may communicate the notification to a recipient designated by the healthcare provider. The intended recipient may be determined based on, for example, a client-configured parameter for the corresponding sponsor program associated with the client profile for the healthcare provider. The notification may be delivered as part of an e-mail message, a message delivered to a pharmacy call center, or via any other suitable mechanism.

At block 1210, the service provider computer 106 and/or the healthcare service eligibility determination module 116 may store data indicating that the patient eligibility notification was generated and communicated. The stored data may include any of the types of data previously described through reference to the pre-adjudication rejection and post-adjudicated message example embodiments discussed above. In certain example embodiments, the service provider computer 106 and/or healthcare service eligibility determination module 116 may determine whether the adjudicated reply indicates an approval or denial of the healthcare transaction, and generate and transmit the patient eligibility notification if the transaction was approved.

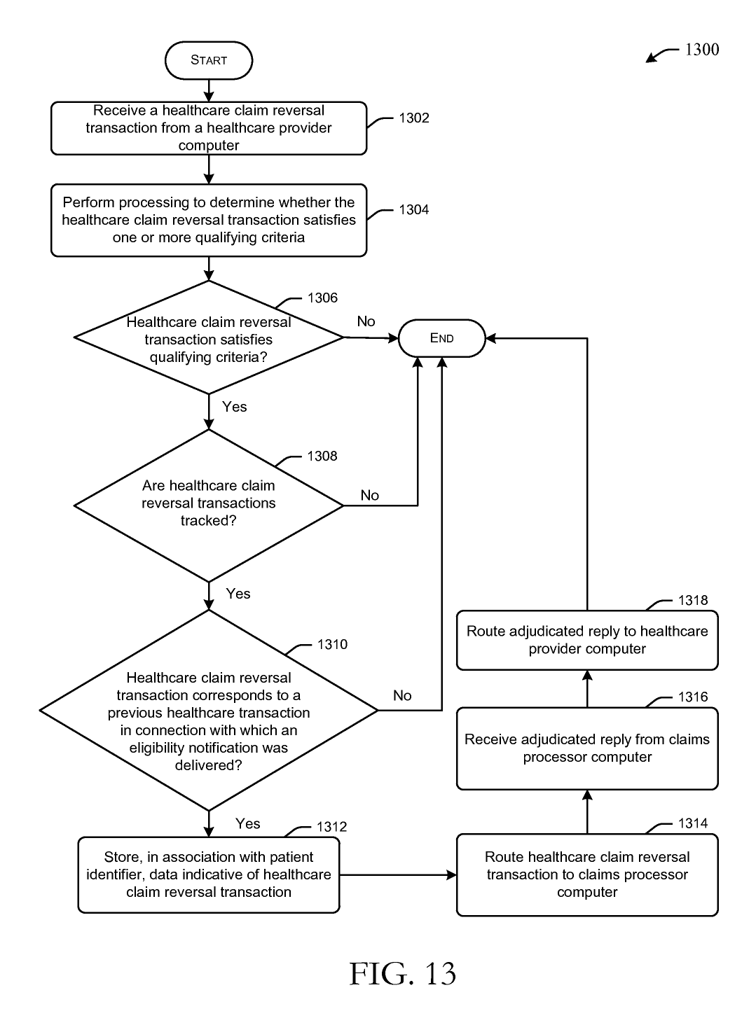

FIG. 13 depicts a process flow diagram of an illustrative method 1300 for determining whether a healthcare claim reversal transaction corresponds to a prior healthcare claim transaction in connection with which a patient eligibility notification was provided and performing processing responsive thereto in accordance with one or more example embodiments of the disclosure. The various operations of method 1300 may be performed, at least in part, by one or more service provider computers 106 and/or the healthcare service eligibility determination module 116. While certain operations may be described as being performed by a service provider computer 106, it should be appreciated that, in various example embodiments, at least a portion of such operations may be performed instead by the healthcare service eligibility determination module 116, and vice versa.

At block 1302, a service provider computer 106 may receive a healthcare claim reversal transaction (e.g., a billing reversal) from a healthcare provider computer. At block 1304, the service provider computer 106 and/or the healthcare service eligibility determination module 116 may perform processing to determine whether the received reversal transaction satisfies one or more qualifying criteria. The qualifying criteria may include, but are not limited to, whether the reversal transaction is formatted in accordance with an appropriate standard (e.g., a NCPDP telecommunication standard); whether the reversal transaction is for a billing reversal request (which may be determined, for example, based on a value (e.g., “B2”) submitted in the Transaction Code field to indicate that the transaction is a reversal transaction); whether the healthcare provider on whose behalf the reversal transaction was submitted has contracted with the service provider to receive patient eligibility notification services (which may be determined, for example, based on a healthcare provider ID included in the transaction); whether the reversal transaction is qualified for one or more third party payor plans (which may be determined, for example, based on a BIN Number, and optionally a PCN and/or Group ID included in the reversal transaction); and so forth.

At block 1306, the service provider computer 106 and/or healthcare service eligibility determination module 116 may determine whether the received reversal transaction satisfies appropriate qualifying criteria based on the results of the processing performed at block 1304. In response to a negative determination at block 1306, the processing may halt. In response to a positive determination at block 1306, a further determination may be made at block 1308 as to whether claim transaction reversals are tracked. For example, the service provider computer 106 and/or the healthcare service eligibility determination module 116 may access stored information to identify the value of parameter (e.g., a Boolean variable) that indicates whether billing reversals are tracked. Responsive to a negative determination at block 1308, the processing may halt.

Responsive to a positive determination at block 1308, the service provider computer 106 and/or the healthcare service eligibility determination module 116 may perform processing to determine whether the reversal transaction corresponds to a previously submitted healthcare claim transaction. More specifically, various information included in the reversal transaction may be identified (e.g., a BIN Number, an identifier associated with the healthcare provider such as a healthcare provider ID, an identifier associated with a prescription product or healthcare service such as a National Drug Code (NDC), a fill number, a date of service, etc.) and compared against data included in previously received healthcare claim transactions in connection with which patient eligibility notifications were sent to determine whether any such healthcare claim transaction includes information that matches the information identified from the reversal transaction. In various example embodiments, a threshold may be specified for determining whether a match exists (e.g., a number of matching data fields). In certain example embodiments, probabilistic matching may be utilized.

In response to a negative determination at block 1310, the processing may halt. On the other hand, if it is determined that the reversal transaction matches a previously received healthcare claim transaction for which a patient eligibility notification was sent, the service provider computer 106 and/or the healthcare service eligibility determination module 116 may store data in association with the client profile and/or the sponsor profile (e.g., as one or more data records included in or linked to the client profile or the sponsor profile) indicating that a reversal transaction has been received for a corresponding claim transaction in connection with which a patient eligibility notification was sent. The stored data may be stored in association with or otherwise linked to the patient via patient identifying information (e.g., Patient First Name, Patient Last Name, Patient ZIP/Postal Code, Cardholder ID, Person Code, or an identifier assigned by the service provider system to the patient, etc.). The stored data may be utilized to determine a frequency with which patient eligibility notifications are to be sent for the patient.

At block 1314, the service provider computer 106 may route the reversal transaction to a claims processor computer for adjudication. At block 1316, the service provider computer 106 may receive an adjudicated reply from the claims processor computer. At block 1318, the service provider computer 106 may route the adjudicated reply to the healthcare provider computer from which the reversal transaction was received.

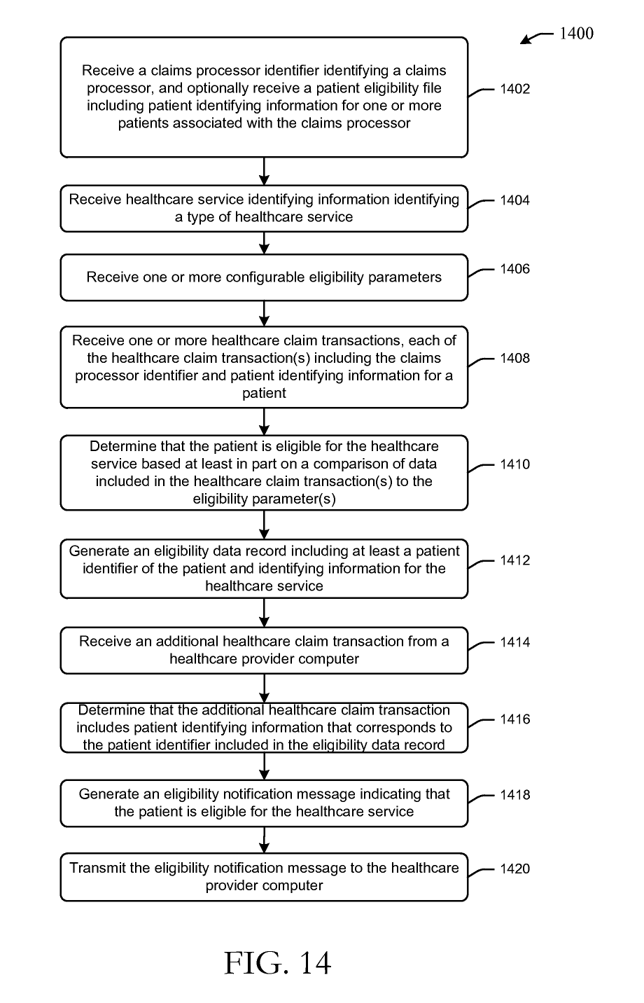

FIG. 14 depicts a process flow diagram of an illustrative method 1400 for determining that a patient is eligible for a healthcare service using healthcare claim transaction data corresponding to one or more healthcare claim transactions, generating an eligibility data record indicating that the patient is eligible for the healthcare service, and generating and transmitting an eligibility notification message in response to receipt of an additional healthcare claim transaction that identifies the patient and the healthcare service for which the patient is eligible in accordance with one or more example embodiments of the disclosure.

At block 1402, the eligibility data generation/modification module 188 may receive a claims processor identifier identifying a claims processor (e.g., a payor, a healthcare service program sponsor, etc.), and may optionally further receive a patient eligibility file including patient identifying information for one or more patients associated with the claims processor. The patient identifying information may correspond to patients who are members of a health plan administered by or otherwise associated with the claims processor. The eligibility data generation/modification module 188 may be configured to map the patient identifying information for each patient to a corresponding patient identifier (e.g., MPI). Alternatively, or additionally, the patient eligibility file may include MPIs for one or more patients. In those example embodiments in which a patient eligibility file is not received, all patients associated with the claims processor may potentially be eligible for healthcare services sponsored in connection with a health plan associated with the claims processor if various eligibility conditions are satisfied.

At block 1404, the eligibility data generation/modification module 188 may further receive a healthcare service identifying information identifying a healthcare service offered under a health plan or sponsor program associated with the claims processor identified by claims processor identifier (or associated with a sponsor of the health plan or sponsor program if different from the claims processor). The healthcare service may include any of the example types of services previously described such as, for example, cash prescription monitoring, immunization messaging, medication adherence counseling, or the like. In addition, at block 1406, the eligibility data generation/modification module 188 may receive information indicative of one or more eligibility conditions that may need to be met in order for a patient to be deemed eligible for the healthcare service identified by the healthcare service identifying information received at block 1404. For example, if the healthcare service is medication adherence counseling, the information received at block 1406 may include a predetermined set of prescription drug identifiers (e.g., NDCs) to monitor healthcare claim transactions for to determine patient eligibility for medication adherence counseling (or a GPI that identifies a therapeutic class of drugs corresponding to the NDCs), a threshold number of days that a patient must be past a next expected refill date for a prescription drug having an identifier included among the predetermined set of identifiers, a PDC threshold for a prescription drug having an identifier included among the predetermined set of identifiers, a PDC trigger threshold for triggering pro-active medication adherence counseling, a number of days that a patient has not been covered by a prescription fill for a prescription drug having an identifier included among the predetermined set of identifiers or that corresponds to the GPI, and so forth. Thus, the information received at block 1406 may indicate one or more configurable parameters (e.g., the threshold number of days late on a prescription refill, the PDC threshold, etc.) and the eligibility data generation/modification module 188 may be configured to evaluate the appropriate condition with respect to a configurable parameter (e.g., determine whether the number of days late on a prescription refill exceeds the threshold number of days). The parameters may be configurable by the claims processor or other healthcare service program sponsor.

At block 1408, the eligibility data generation/modification module 188 may receive healthcare claim transaction data corresponding to one or more healthcare claim transactions. As part of the operations at block 1408, the eligibility data generation/modification module 188 may determine a claims processor identifier included in each of the one or more healthcare claim transactions and may further determine that each of the one or more healthcare claim transactions includes patient identifying information (e.g., a cardholder ID, patient demographic information, etc.) that matches corresponding information and/or that corresponds to a patient identifier (e.g., an MPI) in the patient eligibility file associated with the claims processor identifier. If no patient eligibility file was received, all patients who are members of a health plan may potentially be eligible for the healthcare service identified by the healthcare service identifying information received at block 1404, in which case, the eligibility data generation/modification module 188 may simply determine the claims processor identifier included in each of the healthcare claim transaction(s). t

At block 1410, the eligibility data generation/modification module 188 may determine, based at least in part on a comparison of transaction data included in the healthcare claim transaction(s) to the eligibility parameters, that the patient identified by the patient identifying information in the healthcare claim transaction(s) is eligible for the healthcare service identified by the healthcare service identifying information. In certain example embodiments, the eligibility data generation/modification module 188 may be configured to determine a longitudinal patient medication history for the patient from the transaction data. A longitudinal patient medical history may include, for example, data corresponding to multiple dispenses of a prescription drug over a period of time. For example, the eligibility data generation/modification module 188 may determine a series of dispensing dates corresponding to dispenses of a prescription product to the patient. The series of dispensing dates may indicate periodic prescription refills of the prescription product by the patient. The eligibility data generation/modification module 188 may determine an expected next refill date based on a days supply indicated in a most recent healthcare claim transaction for the prescription drug for the patient. The eligibility data generation/modification module 188 may further determine that more than a threshold period of time has elapsed since the expected next refill date without a prescription refill claim transaction having been received for the prescription drug for the patient. The eligibility data generation/modification module 188 may then determine that the patient is eligible for a medication adherence counseling service. In other example embodiments, the eligibility data generation/modification module 188 may determine the patient is eligible for a medication adherence counseling service if the transaction data indicates that a current PDC for the patient is below an overall threshold PDC specified as an eligibility parameter, if the days uncovered is above a corresponding threshold, and so forth. In yet other example embodiments, the patient may be determined to be eligible even if the patient is not currently past due on a refill or if the patient's current PDC is not below the threshold, but there is greater than a threshold likelihood that the patient may become non-adherent in the future. The eligibility data generation/modification module 188 may determine that there is a greater than threshold likelihood that the patient may become non-adherent in the future if a current PDC (or an extrapolated PDC) for the patient is less than a PDC trigger threshold (which may be a threshold that is higher than the minimum PDC threshold that must be maintained but which is close enough to the minimum PDC threshold so as to present a risk of non-adherence). It should be appreciated that medication adherence counseling is merely an example healthcare service. The eligibility data generation/modification module 188 may, for example, determine from the transaction data corresponding to the healthcare transaction(s) received at block 1408 that more than a threshold period of time (e.g., more than one year) has elapsed since the most recent immunization healthcare claim transaction was received for the patient. More generally, it should be appreciated that the eligibility data generation/modification module 188 may determine the patient's eligibility for any suitable type of healthcare service at block 1410. The healthcare service may include aspects provided by the healthcare provider (e.g., pharmacist) to a patient (e.g., medication adherence counseling, immunization, requesting consent from patient to reroute a cash prescription claim to a third-party, submission of a diagnosis code to enable coordination of benefits, etc.) and/or aspects provided by the service provider computer 106 (e.g., the eligibility data generation/modification module 188) such as, for example, cash prescription monitoring and messaging to inform a healthcare provider to request consent from a patient for rerouting a cash prescription claim, immunization messaging to inform a healthcare provider that a patient is eligible for a vaccination, high-risk medication monitoring, ESRD messaging to inform a healthcare provider to submit a diagnosis code to enable coordination of benefits, messaging to inform a healthcare provider that a healthcare claim transaction should be routed to a different payor, monitoring of prescription claim abuse (e.g., prescription identity theft with respect to the prescriber and/or the patient), and so forth.

At block 1412, the eligibility data generation/modification module 188 may generate an eligibility data record indicating eligibility of the patient for the healthcare service. The eligibility data record may include a patient identifier identifying the particular patient (e.g., an MPI corresponding to the patient), healthcare service identifying information (e.g., a textual description) indicating the healthcare service (e.g., medication adherence counseling, immunization service, high-risk medication intervention, etc.) for which the patient is eligible, the claims processor identifier and/or a text-based identification of the claims processor or program sponsor (if different from the claims processor), and so forth. The eligibility data record may further optionally include various metrics that may be included in an eligibility notification message to be communicated to a healthcare provider such as, for example, the number of days late on a prescription refill, the current PDC, and so forth.

At block 1414, the eligibility data generation/modification module 188 may receive a subsequent healthcare claim transaction from a healthcare provider computer 104. At block 1416, the eligibility data generation/modification module 188 may determine that the healthcare claim transaction includes patient identifying information that matches the patient identifier stored in the eligibility data record generated at block 1412. For example, the eligibility data generation/modification module 188 may determine that a cardholder ID and/or patient demographic information included in the healthcare claim transaction corresponds to the MPI included in the eligibility data record. At block 1418, the eligibility data generation/modification module 188 may generate an eligibility notification message that indicates the eligibility of the patient for the healthcare service. The eligibility notification message may include the claims processor identifier and/or other identifying information (e.g., a name) for the healthcare program sponsor (which may the same or a different entity than the claims processor), descriptive text indicative of the healthcare service for which the patient is eligible, a name or identifier of the prescription drug for which the patient is non-adherent, a current PDC, a number of days late on a prescription refill, and so forth. At block 1418, the eligibility data generation/modification module 188 may transmit the eligibility notification message to the healthcare provider computer 104 from which the healthcare claim transaction was received at block 1412.

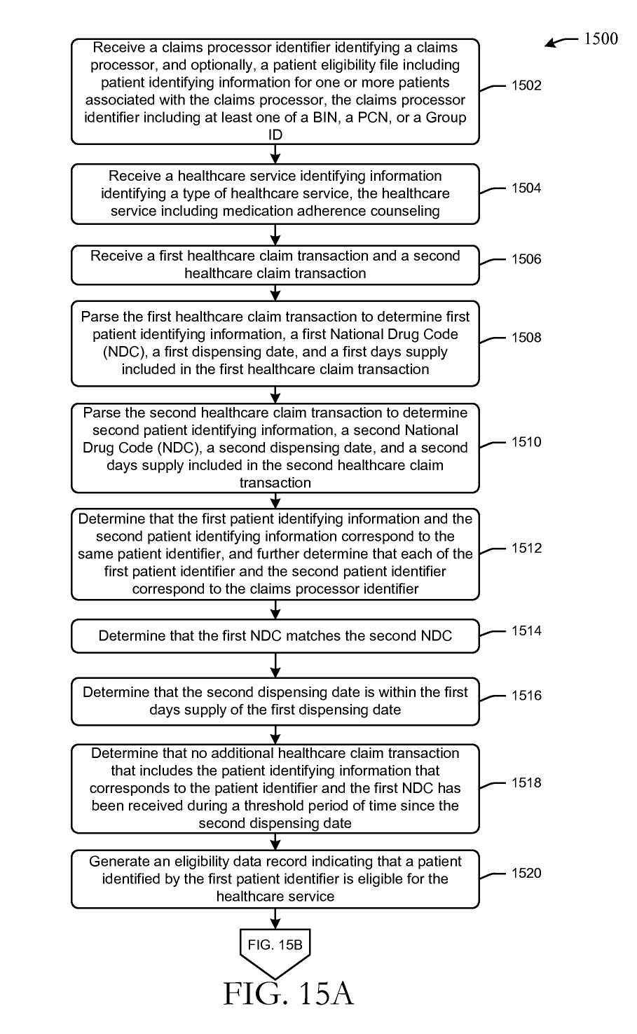

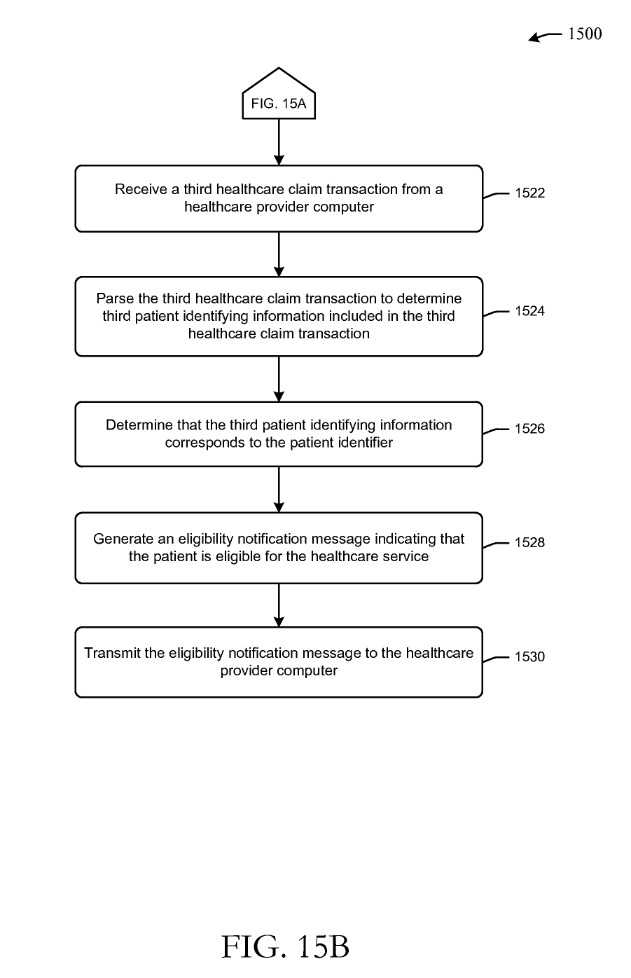

FIGS. 15A-15B depict process flow diagrams of an illustrative method 1500 for determining that a patient is eligible for medication adherence counseling using healthcare claim transaction data corresponding to a plurality of healthcare claim transactions, generating an eligibility data record indicating that the patient is eligible for the medication adherence counseling, and generating and transmitting an eligibility notification message in response to receipt of an additional healthcare claim transaction that identifies the patient in accordance with one or more example embodiments of the disclosure. The method 1500 includes operations associated with an example scenario in which the healthcare service is a medication adherence counseling service.

Referring initially to FIG. 15A, at block 1502, the eligibility data generation/modification module 188 may receive a claims processor identifier identifying a claims processor (e.g., a payor, a healthcare service program sponsor, etc.), and optionally, a patient eligibility file including patient identifying information corresponding to one or more patients associated with the claims processor identifier. The patient identifying information may include, for example, a cardholder ID, patient demographic information, and so forth. The patient eligibility file may additionally, or alternatively, include one or more MPIs or other identifies identifying one or more patients associated with the claims processor. The claims processor identifier may include a BIN, PCN, and/or Group ID. In certain example embodiments, the claims processor identifier may include a BIN and at least one of a PCN or Group ID. The patient identifying information and/or identifier(s) may correspond to patients who are members of a health plan administered by or otherwise associated with the claims processor. In those example embodiments in which a patient eligibility file is not received, all patients associated with the claims processor may potentially be eligible for healthcare services sponsored in connection with a health plan associated with the claims processor. It should be appreciated that any example embodiments discussed herein in which patient identifying information is utilized or included in a data file, a patient identifier (e.g., an MPI) may additionally, or alternatively, be utilized or included in the data file.

At block 1504, the eligibility data generation/modification module 188 may further receive healthcare service identifying information identifying a medication adherence counseling service offered under a health plan or sponsor program associated with the claims processor identifier. At block 1506, the eligibility data generation/modification module 188 may receive healthcare claim transaction data corresponding to a first healthcare claim transaction and a second healthcare claim transaction. In certain example embodiments, the eligibility data generation/modification module 188 may be configured to determine a longitudinal patient medication history for the patient from transaction data included in the first healthcare claim transaction and transaction data included in the second healthcare claim transaction. For example, based on an analysis of at least the transaction data included in the first healthcare claim transaction and the transaction data included in the second healthcare claim transaction, the eligibility data generation/modification module 188 may determine a series of dispensing dates associated with refills of the prescription drug dispensed to the patient. The eligibility data generation/modification module 188 may then determine whether the refill period since the most recent prescription refill for the patient has expired by more than a threshold period of time.

More specifically, at block 1508, the eligibility data generation/modification module 188 may parse the first healthcare claim transaction to determine first patient identifying information, a first NDC, a first dispensing date, and a first days supply included in the first healthcare claim transaction. In certain example embodiments, the eligibility data generation/modification module 188 may determine a patient identifier (e.g., an MPI) that corresponds to the first patient identifying information. Similarly, the eligibility data generation/modification module 188 may determine, at block 1510, second patient identifying information, a second NDC, a second dispensing date, and a second days supply included in the second healthcare claim transaction. As similarly described above, the eligibility data generation/modification module 188 may further determine a patient identifier (e.g., an MPI) that corresponds to the second patient identifying information.

At block 1512, the eligibility data generation/modification module 188 may determine that the first patient identifying information and the second patient identifying information correspond to the same patient identifier. For example, the eligibility data generation/modification module 188 may determine that the same MPI corresponds to both the first patient identifying information and the second patient identifying information. At block 1512, the eligibility data generation/modification module 188 may further determine that each of the first patient identifying information and the second patient identifying information (which are determined to correspond to the same patient identifier) correspond to the claims processor identifier. If a patient eligibility file was received, the eligibility data generation/modification module 188 may determine that the first patient identifying information or the second patient identifying information (or a patient identifier such as an MPI) is present in the patient eligibility file.

At block 1514, the eligibility data generation/modification module 188 may determine that the first NDC matches the second NDC or an NDC of a generic alternative that is within the same therapeutic class as the prescription drug identified by the second NDC. Alternatively, the eligibility data generation/modification module 188 may determine that the second NDC matches an NDC of a generic alternative that is within the same therapeutic class as the prescription drug identified by the first NDC. In certain example embodiments, determining that the first NDC matches the second NDC or an NDC of a generic alternative (or vice versa) may include determining that both the first NDC and the second NDC correspond to a GPI received from the claims processor (or a program sponsor if different from the claims processor).

At block 1516, the eligibility data generation/modification module 188 may determine that the second dispensing date is within the first days supply of the first dispensing date. For example, if the first dispensing date is March 1, the first days supply is 30 days, and the second dispensing date is March 29, the eligibility data generation/modification module 188 may determine that the patient received a prescription refill for the prescription drug identified by the first NDC (which is the same as the second NDC or an NDC of a generic alternative) within the refill period specified by the first days supply. In this manner, the eligibility data generation/modification module 188 may determine a series of dispenses for the patient that indicate that the patient has received periodic prescription refills of the prescription product in a timely manner. The prescription drug may be used to treat a chronic condition or other type of condition that typically requires periodic prescription refills for the prescription drug. It should be appreciated that the eligibility data generation/modification module 188 may determine the series of dispenses constituting a patient's prescription refill historical pattern using any number of healthcare claim transactions.

At block 1518, the eligibility data generation/modification module 188 may determine that no additional healthcare claim transaction that includes the first NDC and patient identifying information that corresponds to the patient identifier has been received during a threshold period of time since the second dispensing date. More specifically, the eligibility data generation/modification module 188 may determine a next expected refill date using the second dispensing date and the second days supply. The eligibility data generation/modification module 188 may then determine whether a threshold period of time has elapsed since the next expected refill date without having received a prescription refill transaction that includes the first NDC and patient identifying information that corresponds to the patient identifier.

Based on the determination at block 1518, the eligibility data generation/modification module 188 may determine that the patient identified by the patient identifying information is eligible for the healthcare service (e.g., medication adherence counseling) identified by the healthcare service identifying information and may generate, at block 1520, an eligibility data record indicating eligibility of the patient for medication adherence counseling. The eligibility data record may include the patient identifier identifying the particular patient, the prescription drug identifier (e.g., the first NDC) identifying the prescription drug for which the refill period has expired by more than the threshold period of time, a GPI identifying a therapeutic class of drugs to which the first NDC belongs, the healthcare service identifying information identifying the healthcare service (e.g., medication adherence counseling) for which the patient is eligible, etc.

Referring now to FIG. 15B, the eligibility data generation/modification module 188 may receive a third healthcare claim transaction at block 1522. At block 1524, the eligibility data generation/modification module 188 may parse the third healthcare transaction to determine third patient identifying information included in the third healthcare claim transaction. At block 1526, the eligibility data generation/modification module 188 may determine that the third patient identifying information corresponds to the patient identifier, and at block 1528, the eligibility data generation/modification module 188 may generate an eligibility notification message that indicates the eligibility of the patient for the medication adherence counseling. The eligibility notification message may include the prescription drug identifier (e.g., the first NDC) identifying the prescription drug for which the refill period has expired by more than the threshold period of time and/or the name of the prescription drug, healthcare service identifying information identifying the healthcare service (e.g., medication adherence counseling) for which the patient is eligible, and so forth. At block 1530, the eligibility data generation/modification module 188 may transmit the eligibility notification message to the healthcare provider computer 104 from which the third healthcare claim transaction was received.

In certain example embodiments, the third healthcare claim transaction may include a prescription drug identifier corresponding to a different prescription drug than the drug for which the patient is eligible for medication adherence counseling. In other example embodiments, the third healthcare claim transaction may include a third NDC that matches the first NDC or the second NDC (or an NDC of a generic alternative to the prescription drug identified by the first NDC or the prescription drug identified by the second NDC). In such example embodiments, the eligibility data record may be modified to indicate that the patient is no longer eligible for the particular instance of medication adherence counseling to which the eligibility data record relates. For example, a flag, code, or other identifier may be included in the eligibility data record to indicate that the healthcare service opportunity has expired or is obsolete.

FIGS. 15A-15B depict a method for determining that a patient is eligible for medication adherence counseling based on a determination that the patient is more than a threshold number of days past due on a prescription refill. It should be appreciated, however, that in other example embodiments, the patient may be determined to be eligible for medication adherence counseling if a current PDC for the patient falls below a minimum threshold PDC value, if the number of days covered falls below a minimum threshold number of days (or alternatively if the number of uncovered days passes a threshold value), and so forth. It should further be appreciated that, in certain example embodiments, a patient may be determined to be eligible for pro-active medication adherence counseling if, for example, a current PDC or extrapolated PDC for the patient falls below a PDC trigger threshold. As previously noted, the PDC trigger threshold may be a PDC that is above the minimum threshold PDC, but that is close enough to the minimum threshold PDC so as to pose a threshold level of risk that the patient may become non-adherent in the future if the patient's current PDC falls below the PDC trigger threshold.

As previously noted, the service provider computer 106 may also include or otherwise be in communication with a high-risk medication (HRM) module 190. As will be described in more detail hereinafter, the HRM module 190 may include any combination of hardware and software components configured to perform monitoring of the dispensing of high-risk medications. A high-risk medication or prescription drug may be any medication identified as having the potential to cause serious side effects when taken to treat a condition for which the medication is designated. In certain example embodiments, a high-risk prescription drug may be identified as having the potential to cause serious side effects in a particular patient population (e.g., an elderly population). Despite being identified as high-risk, a significant percentage of the Medicare patient population receives multiple prescription fills of a high-risk drug each year. Some payors or claims processors (e.g., pharmacy benefit managers (PBMs)) utilize a prior authorization mechanism in an attempt to prevent the dispensing of high-risk prescription drugs. However, such prior authorization schemes may be circumvented if a patient pays in cash for a prescription. Further, a patient may abandon the prescription and not receive a dispensing of the drug which may cause the patient's condition to become exacerbated. In addition, prior authorization schemes do not allow for comprehensive tracking of HRM intervention to determine whether an alternative medication was dispensed or whether the patient abandoned the prescription and did not receive the high-risk medication. Some vendor solutions provide an indication of dispenses of high-risk medications after they have occurred. However, these solutions do not allow for real-time monitoring of the dispensing of high-risk medications, and thus, do not provide the capability to prevent the dispensing of a high-risk drug before it occurs.

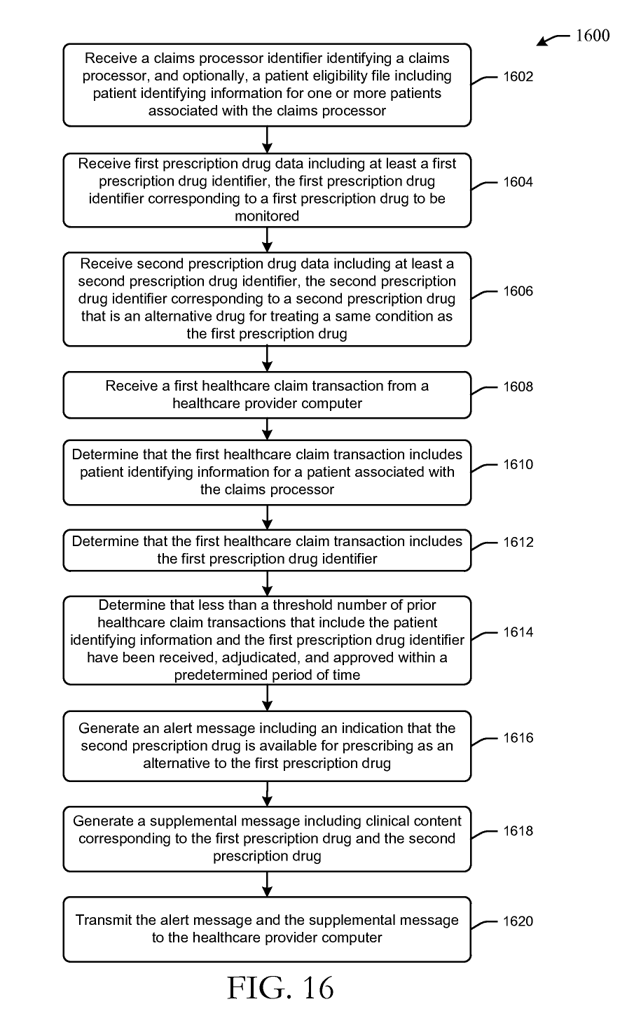

FIG. 16 depicts a process flow diagram of an illustrative method 1600 for monitoring the dispensing of a high-risk prescription drug in accordance with one or more example embodiments of the disclosure.

At block 1602, the HRM module 190 may receive a claims processor identifier (e.g., a payor ID, a healthcare program sponsor ID, etc.) identifying a claims processor (e.g., a payor, a healthcare service program sponsor, etc.), and optionally, a patient eligibility file including patient identifying information one or more patients associated with the claims processor. The patient identifying information may correspond to patients who are members of a health plan administered by or otherwise associated with the claims processor. As previously described, the patient eligibility file may include one or more patient identifiers (e.g., MPIs) for one or more patients in addition to, or in lieu of, the patient identifying information. In those example embodiments in which a patient eligibility file is not received, high-risk medication monitoring may be performed for all patients associated with the claims processor.

At block 1604, the HRM module 190 may receive from, for example, a claims processor or other healthcare service program sponsor, first prescription drug data including prescription drug identifiers for one or more prescription drugs identified as high-risk drugs. For example, the HRM module 190 may receive a first prescription drug identifier corresponding to a first prescription drug to be monitored (e.g., a first high-risk prescription drug). At block 1606, as part of the same data feed or a separate data feed, the HRM module 190 may also receive second prescription drug data including prescription drug identifiers for one or more prescription drugs designated as alternative drugs for treating the same health conditions for which the high-risk prescription drugs are designated. For example, the HRM module 190 may receive a second prescription drug identifier corresponding to a second prescription drug that is an alternative drug for treating a same condition that the first prescription is designated to treat.

The HRM module 190 may then monitor healthcare claim transactions received over a claims transaction network. At block 1608, the HRM module 190 may receive a first healthcare claim transaction from a healthcare provider computer. At block 1610, the HRM module 190 may determine that the first healthcare claim transaction includes patient identifying information for a patient associated with the claims processor. In certain example embodiments, the HRM module 190 may determine that the patient identifying information is included in a patient eligibility file received from the claims processor or that the patient identifying information corresponds to a patient identifier (e.g., an MPI) included in the patient eligibility file. If no patient eligibility file is available, the HRM module 190 may determine that the patient identifying information corresponds to the claims processor identifier based on one or more stored data records indicating that the patient identifying information corresponds to a patient identifier that identifies a patient who is member of a health plan, sponsor program, or the like associated with a claims processor or other entity identified by the claims processor identifier and on whose behalf the high-risk medication monitoring is being provided.

At block 1612, the HRM module 190 may further parse the first healthcare claim transaction to determine a prescription drug identifier included in the first healthcare transaction. As part of the operations at block 1612, the HRM module 190 may further determine that the prescription drug identifier included in the first healthcare claim transaction matches an identifier included in the first prescription drug data (e.g., the first prescription drug identifier). If a match is detected, the HRM module 190 may perform additional processing to determine whether various conditions are met for generating an HRM alert message.

At block 1614, the HRM module 190 may determine that less than a threshold number of prior healthcare claim transactions that include patient identifying information that corresponds to a same patient identifier as the patient identifying information included in the first healthcare claim transaction, and that further include the first prescription drug identifier have been received, adjudicated, and approved with a predetermined period of time. More specifically, the HRM module 190 may determine a number of prior healthcare claim transactions that were received that included the patient identifying information and the first prescription drug identifier corresponding to the first prescription drug (e.g., the high-risk drug). Of these prior healthcare claim transactions, the HRM module 190 may determine which (if any) transaction(s) were received within a predetermined period of time (e.g., within the current calendar year, within the last 365 days, within the last 6 months, etc.). If any prior healthcare claim transactions were received that satisfy these criteria, the HRM module 190 may further determine whether any such transaction(s) were adjudicated and approved. The HRM module 190 may then compare the number of prior healthcare transactions that satisfy these criteria against a predetermined threshold.

Responsive to the determination that the number prior healthcare transactions satisfying the aforementioned criteria is less than the threshold, the HRM module 190 may generate, at block 1616, an alert message that includes the second prescription drug identifier identifying the second prescription drug that is an alternative to the first prescription drug (e.g., the high-risk prescription drug) identified in the first healthcare claim transaction. In certain example embodiments, the HRM alert message may include multiple prescription drug identifiers corresponding to multiple prescription drugs that are alternatives to the first prescription drug. The alert message may further include the first prescription drug identifier and/or a name of the first prescription drug identified by the first prescription drug identifier. The alert message may further include a specific indication that the second prescription drug is an alternative drug for treating a condition for which the first high-risk prescription drug is designated. In addition, the alert message may include an override reason code to include in a resubmission of the first healthcare claim transaction if the high-risk medication intervention is not successful.

At block 1618, the HRM module 190 may transmit or direct the transmission of the alert message as part of a pre-adjudication rejection of the first healthcare transaction or as a separate message. In certain example embodiments, the HRM module 190 may also generate, at block 1620, a supplemental message that includes clinical content corresponding to the first high-risk prescription drug and the second alternative prescription drug. The clinical content may include information detailing why the first prescription drug has been designated as a high-risk drug and why the second prescription drug is considered a safer alternative. In certain example embodiments, the supplemental message may be transmitted as part or in association with the HRM alert message or may be transmitted to a contact identifier associated with a healthcare provider location (e.g., a pharmacy location of a pharmacy chain) with which the healthcare provider computer is associated. For example, the supplemental message may be transmitted to a designated e-mail address, facsimile number, or the like.

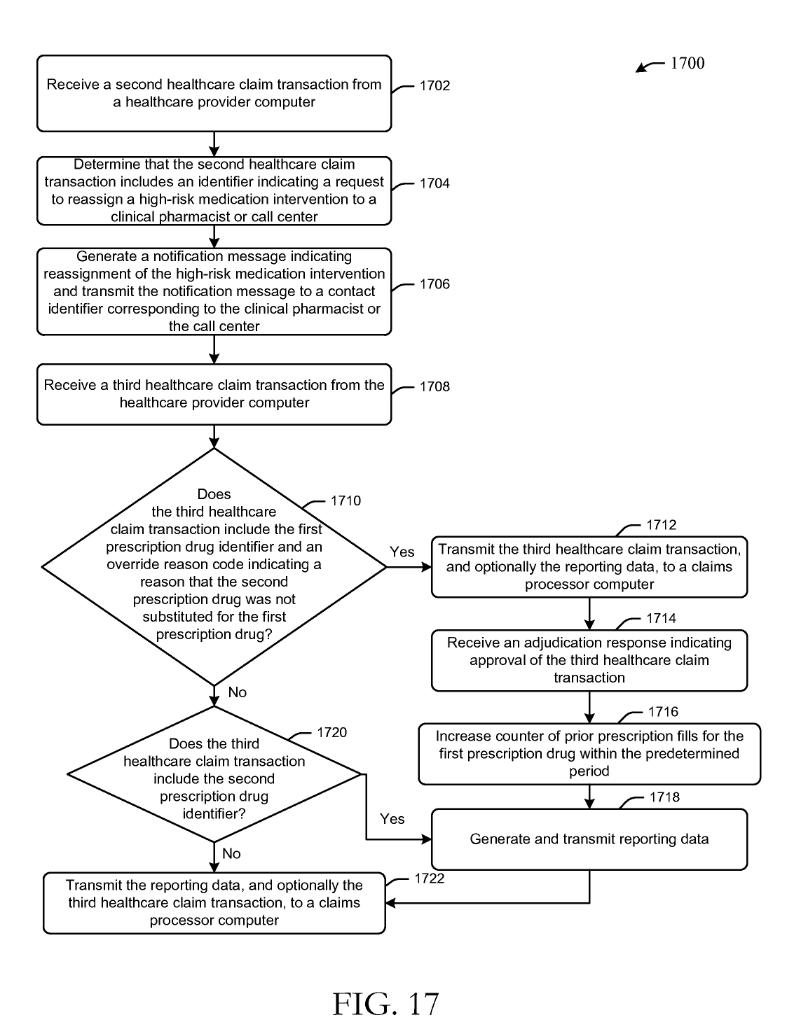

FIG. 17 depicts a process flow diagram of an illustrative method 1700 for initiating a patient counseling session in connection with the monitoring of the dispensing of a high-risk prescription drug, receiving a resubmitted healthcare claim transaction including an override reason code indicating a reason that an alternative prescription drug was not substituted for the high-risk prescription drug or receiving an alternative healthcare claim transaction that identifies the alternative prescription drug, and performing appropriate processing based on whether the resubmitted healthcare claim transaction or the alternative healthcare claim transaction is received in accordance with one or more example embodiments of the disclosure.

Upon receipt of the HRM alert message transmitted at block 1618 of FIG. 16, and optionally, the supplemental message transmitted at block 1620 of FIG. 16, a healthcare provider (e.g., a pharmacist) may facilitate interaction between the patient and the prescriber of the first high-risk drug to attempt to cause the prescriber to prescribe the second alternative prescription drug in lieu of the first drug. In certain example embodiments, the healthcare provider may provide input to the healthcare provider computer 104 to generate a second healthcare claim transaction that may be received by the HRM module 190 at block 1702. For example, the healthcare provider computer 104 may transmit the second healthcare transaction to the service provider computer 106 which may, in turn, communicate the second healthcare transaction (or at least a portion of the data included therein) to the HRM module 190. The second healthcare claim transaction may be a resubmission of the first healthcare transaction (e.g., may include the same patient identifying information, prescription drug identifier for the high-risk prescription drug, prescriber identifier, etc.).

At block 1704, the HRM module 190 may determine that the second healthcare transaction includes an identifier (e.g., a code) that indicates that a patient counseling session is to be initiated between the patient and a clinical pharmacist, a call center, or the like. For example, the code may indicate that a high-risk medication intervention initiated by the pharmacist in response to the HRM alert message is to be reassigned to a clinical pharmacist, call center, or the like. Upon determining that the second healthcare claim transaction includes the code, the HRM module 190 may generate, at block 1706, a notification message indicating that the patient counseling session is to be initiated and may transmit or direct transmission of the notification message to a contact identifier associated with the clinical pharmacist, the call center, or the like. The notification message may be an e-mail message delivered to an e-mail address, an automated voice message delivered to a voicemail inbox, a facsimile message delivered to a facsimile number, or the like.

In certain example embodiments, the patient counseling session may be successful in persuading the patient to switch to the alternative prescription drug and obtain a prescription from the prescriber for the alternative prescription drug. In such example embodiments, the healthcare provider may provide input to the healthcare provider computer 104 to generate a third healthcare claim transaction for the second prescription drug. The third healthcare claim transaction for the second prescription drug may include the second prescription drug identifier, patient identifying information corresponding to the same patient identifier as the patient identifying information in the first healthcare claim transaction, a prescriber identifier (e.g., Prescriber ID), a healthcare provider identifier (e.g., an NABP, an NPI, etc.), and so forth.

In other example embodiments, the patient counseling session may be unsuccessful in persuading the patient to switch to the alternative drug and/or in persuading the patient or the prescriber to obtain a prescription for the alternative drug from the prescriber. In such example embodiments, the healthcare provider may provide input to the healthcare provider computer 104 to generate a third healthcare claim transaction for the first high-risk prescription drug. The third healthcare claim transaction may be a resubmission of the first healthcare claim transaction and may include an override reason code indicating a reason that the high-risk medication intervention was unsuccessful. For example, the override reason code included in the third healthcare claim transaction may correspond to a predefined reason that the second prescription drug was not substituted for the first drug (e.g., the patient did not approve the switch, the prescriber did not issue a prescription for the second prescription drug, etc.).

At block 1710, the HRM module 190 may determine whether the third healthcare claim transaction includes the first prescription drug identifier and an override reason code indicating a reason that the second prescription drug was not substituted for the first prescription drug. Specifically, the HRM module 190 may determine whether the third healthcare claim transaction is a resubmission of the first healthcare transaction and whether the third healthcare claim transaction includes the override reason code. The HRM module 190 may determine whether the third healthcare claim transaction is a resubmission of the first healthcare claim transaction for the first high-risk prescription drug by determining that various data included in the third healthcare claim transaction (e.g., the patient identifying information, the prescriber identifier, the healthcare provider identifier, a dispensing date, etc.) matches data in corresponding data fields of the first healthcare claim transaction. In other example embodiments, the third healthcare claim transaction may include a transaction code that indicates that it is a resubmission of the first healthcare claim transaction.

If the HRM module 190 determines that the third healthcare claim transaction is a resubmission of the first healthcare transaction and that the third healthcare claim transaction includes the override reason code, the HRM module 190 may, at block 1712, transmit or direct the transmission of the resubmitted healthcare claim transaction to a claims processor computer 108 for adjudication. The claims processor computer 108 may be determined using a claims processor identifier included in the third healthcare claim transaction. At block 1714, the HRM module 190 may receive an adjudication response from the claims processor computer 108 indicating that the third healthcare claim transaction has been approved. For example, the adjudication response may include an approval code. Then, at block 1716, the HRM module 190 may increment a counter representative of prior prescription fills for the first prescription drug within the predetermined period of time based on receipt of the adjudication response indicating approval. At block 1718, the HRM module 190 may generate reporting data indicating that the high-risk medication intervention was unsuccessful in causing the second alternative prescription drug to be substituted for the first high-risk prescription drug. In addition, at block 1718, the HRM module 190 may transmit or direct transmission of the reporting data to a claims processor computer or a system/device associated with another entity (e.g., a healthcare service program sponsor) on whose behalf the high-risk medication monitoring is performed. It should be appreciated that the claims processor computer that adjudicates the third healthcare claim transaction and the computer/system to which the reporting data is transmitted may correspond to a same entity.

If, on the other hand, the HRM module 190 determines that the third healthcare claim transaction is not a resubmission of the first healthcare transaction and/or does not include the override reason code, the method 1700 may proceed to block 1720 where the HRM module 190 may determine whether the third healthcare claim transaction includes the second prescription drug identifier. As part of the operations at block 1720, the HRM module 190 may determine whether the third healthcare claim transaction corresponds to the first healthcare claim transaction by further determining that one or more of the patient identifying information, the prescriber identifier, the healthcare provider identifier, or the like included in the third healthcare claim transaction match data populated in corresponding data fields in the first healthcare claim transaction. In addition, as part of the operations at block 1720, the HRM module 190 may determine whether the third healthcare claim transaction corresponds to a completion of the healthcare service opportunity identified in the HRM alert message by further determining whether the third healthcare claim transaction was received within a threshold number of days from when the HRM alert message was sent.

In response to a positive determination at block 1720, the HRM module 190 may then generate, at block 1718, reporting data indicating that the high-risk medication intervention was successful in causing the second alternative prescription drug to be substituted for the first high-risk prescription drug. In addition, at block 1718, the HRM module 190 may transmit or direct transmission of the reporting data to a claims processor computer or a system/device associated with another entity (e.g., a healthcare service program sponsor) on whose behalf the high-risk medication monitoring is performed. At block 1722, the HRM module 190 may further transmit or direct the transmission of the healthcare claim transaction for the alternative drug to a claims processor computer for adjudication. It should be appreciated that the claims processor computer that adjudicates the healthcare claim transaction for the alternative prescription drug and the computer/system to which the reporting data is transmitted may correspond to a same entity or different entities. In response to a negative determination at block 1714, the third healthcare claim transaction may be routed to the claims processor computer for adjudication without generating reporting data. This may occur if, for example, the third healthcare claim transaction includes patient identifying information corresponding to a different patient identifier than the patient identifying information included in the first healthcare claim transaction, a prescription drug identifier other than the first prescription drug identifier or the second prescription drug identifier, or the like.

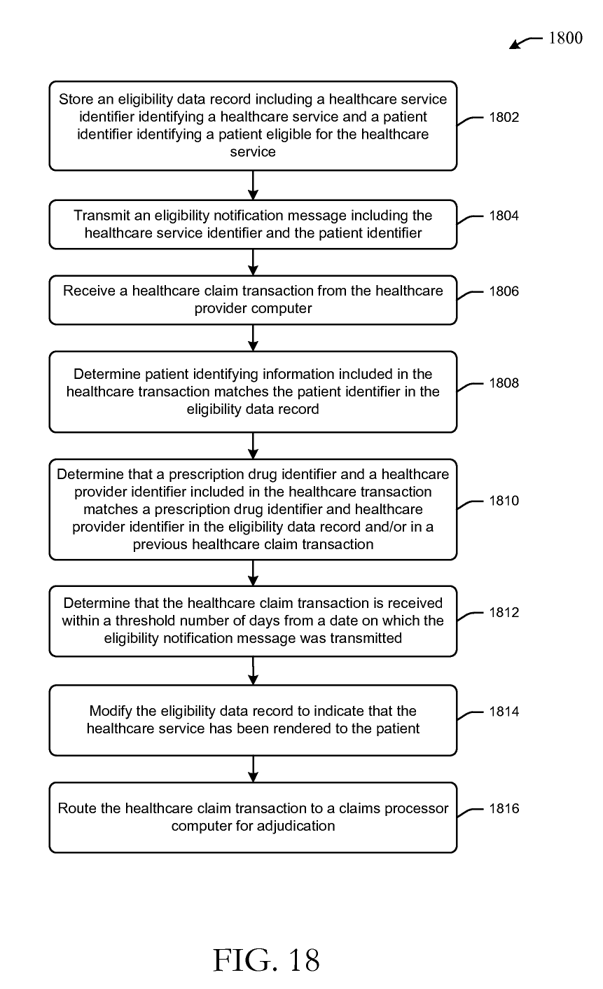

FIG. 18 depicts a process flow diagram of an illustrative method 1800 for storing an eligibility data record including a patient identifier of a patient and healthcare service identifying information identifying a healthcare service, transmitting an eligibility notification message indicating that the patient is eligible for the healthcare service, receiving a healthcare claim transaction, determining that the healthcare claim transaction corresponds to a completion of the healthcare service opportunity, and modifying the eligibility data record to indicate that the healthcare service has been rendered to the patient in accordance with one or more example embodiments of the disclosure. While operations of method 1800 may be described illustratively as being performed by the service provider computer 106, it should be appreciated that one or more operations may be performed by the healthcare service eligibility determination module 116, the eligibility data generation/modification module 188, and/or HRM module 190.

At block 1802, the service provider computer 106 may store an eligibility data record including a patient identifier (e.g., an MPI) identifying a patient and healthcare service identifying information (e.g., descriptive text) identifying a healthcare service for which the patient is eligible. The healthcare service may be a medication adherence counseling service, an immunization service, a high-risk intervention, or the like. Depending on the healthcare service, the eligibility data record may include additional information. For example, if the healthcare service is medication adherence counseling, the eligibility data record may further include a GPI identifying a therapeutic class of drugs for which medication adherence counseling may be provided. At block 1804, the service provider computer 106 may transmit an eligibility notification message including at least the healthcare service identifying information. The eligibility notification message may further include an NDC or a GPI identifying a prescription drug or class of drugs for which medication adherence counseling may be provided to the patient, an NDC or GPI identifying a vaccine or vaccine class for which the patient is eligible, an NDC of a prescription drug that may be prescribed as an alternative to a high-risk drug, or the like. The eligibility notification message may be transmitted to a healthcare provider computer 104 in response to receipt of a first healthcare claim transaction from the healthcare provider computer 104 as part of, for example, a pre-adjudication rejection of the first healthcare claim transaction, a post-adjudication response, a separate email, facsimile, or other electronic communication, or the like.

At block 1806, the service provider computer 106 may receive a second healthcare claim transaction from the healthcare provider computer 104. At block 1808, the service provider computer 106 may determine that patient identifying information included in the second healthcare transaction matches corresponding information (e.g., corresponding patient identifying information, a patient identifier (an MPI), etc.) included in the eligibility data record. At block 1810, the service provider computer 106 may determine that a prescription drug identifier (e.g., NDC) and a healthcare provider identifier (e.g., an NABP, an NPI, etc.) included in the healthcare claim transaction match corresponding identifiers included in the eligibility data record and/or included in a previous healthcare claim transaction associated with the eligibility notification message. At block 1812, the service provider computer 1812 may determine that the healthcare claim transaction was received within a threshold number of days from a date on which the eligibility notification message was transmitted. At block 1814, the service provider computer 106 may modify the eligibility data record to indicate that the healthcare service has been rendered to the patient. For example, the service provider computer 106 may store a flag, identifier, or the like in the eligibility data record indicating that the patient is no longer eligible for the particular instance of the healthcare service identified by the healthcare service identifying information included in the eligibility data record. In certain example embodiments, modifying the eligibility data record may include making the record inaccessible for further messaging.

As an example, in certain example embodiments, a healthcare provider (e.g., a pharmacist) may provide medication adherence counseling services to a patient and may provide input to a healthcare provider computer to generate the second healthcare claim transaction for the rendered services. Upon receipt of the second healthcare claim transaction, the eligibility data generation/modification module 188 may determine that the second healthcare claim transaction includes patient identifying information, a prescription drug identifier, and a healthcare provider identifier included in the eligibility data record and/or in a previous healthcare claim transaction and that the second healthcare transaction was received within a threshold number of days from a date on which the eligibility notification message was transmitted, and may modify the eligibility data record to indicate that the patient is no longer eligible for the specific instance of the healthcare service to which the eligibility data record relates. However, it should be appreciated that the patient may again become eligible for the healthcare service (e.g., medication adherence counseling) if subsequent healthcare claim transaction data for the patient indicates a failure to adhere to a prescription drug refill regimen. While the example scenario discussed above involves medication adherence counseling, it should be appreciated that healthcare claim transaction data may be used to determine a patient's eligibility for any type of healthcare service, including any of those previously described.

It should be appreciated that the operations described and shown in FIGS. 3A-13 may be carried out or performed in any suitable order. Additionally, in certain example embodiments, at least a portion of the operations may be carried out in parallel. Furthermore, in certain example embodiments, fewer than or more than the operations described in FIGS. 3A-13 may be performed.

Although example embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with example embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program modules, or other data transmitted within a data signal, such as a carrier wave, or other transmission. However, as used herein, CRSM does not include CRCM.

Although example embodiments have been described in language specific to structural features and/or methodological acts, it is to be understood that the disclosure is not necessarily limited to the specific features or acts described. Rather, the specific features and acts are disclosed as illustrative forms of implementing the example embodiments. Conditional language, such as, among others, “can,” “could,” “might,” or “may,” unless specifically stated otherwise, or otherwise understood within the context as used, is generally intended to convey that certain example embodiments could include, while other example embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A system, comprising:
at least one memory storing computer-executable instructions; and
at least one processor configured to access the at least one memory and execute the computer-executable instructions to:
receive a first claims processor identifier identifying a claims processor, wherein the first claims processor identifier comprises at least one of a Bank Identification Number (BIN), a Processor Control Number (PCN), or a Group Identifier (ID);
receive first prescription drug data including a first National Drug Code (NDC) corresponding to a first prescription drug classified as a high-risk medication for treatment of health condition;
receive second prescription drug data including a second NDC corresponding to a second prescription drug, wherein the second prescription drug is an alternative drug for treating the health condition;
receive, from a healthcare provider computer, a healthcare claim transaction;
parse the healthcare claim transaction to determine a second claims processor identifier, a third NDC, and patient identifying information included in the healthcare claim transaction;
determine that the second claims processor identifier matches the first claims processor identifier;
determine that the third NDC matches the first NDC;
determine a number of one or more prior healthcare claim transactions corresponding to one or more dispenses of the first prescription drug, wherein the at least one processor is configured to determine that the one or more prior healthcare claim transactions by executing the computer-executable instructions to determine that each of the one or more prior healthcare claim transactions a) includes at least a portion of the patient identifying information, b) includes the first NDC, c) was received during a predetermined period of time, and d) was adjudicated and approved;
determine that the number of one or more prior healthcare claim transactions is less than a threshold number;
generate an alert message including an indication of the first prescription drug, an indication of the second prescription drug, and an indication that the second prescription drug is available for dispensing as an alternative to the first prescription drug; and
transmit the alert message to the healthcare provider computer.

2. The system of claim 1, wherein the at least one processor is configured to generate the alert message by executing the computer-executable instructions to generate a pre-adjudication rejection of the healthcare claim transaction that includes the alert message and at least one override reason code.

3. The system of claim 2, wherein the healthcare claim transaction is a first healthcare claim transaction, and wherein the at least one processor is further configured to execute the computer-executable instructions to:
determine first patient identifying information, a first healthcare provider identifier, a first prescription identifier, and a first date of service included in the first healthcare claim transaction;
receive a second healthcare claim transaction from the healthcare provider computer;
parse the second healthcare claim transaction to determine second patient identifying information, a fourth NDC, a second healthcare provider identifier, a second prescription identifier, and a second date of service included in the second healthcare claim transaction;
determine that the second healthcare claim transaction is a resubmission of the first healthcare claim transaction by executing the computer-executable instructions to:
determine that the first patient identifying information and the second patient identifying information correspond to a same patient identifier;
determine that the fourth NDC matches the first NDC;
determine that the second healthcare provider identifier matches the first healthcare provider identifier;
determine that the second prescription identifier matches the first prescription identifier; and
determine that the second date of service matches the first date of service;
determine that the second healthcare claim transaction includes an override reason code indicating a reason that the second prescription drug was not selected for dispensing to the patient;
generate reporting data including the override reason code;
transmit the second healthcare claim transaction to a claims processor computer for adjudication; and
transmit the reporting data to a sponsor computer associated with a healthcare service program sponsor sponsoring a dispensing monitoring service for the first prescription drug.

4. The system of claim 3, wherein the at least one processor is further configured to execute the computer-executable instructions to:
receive an adjudication response from the claims processor computer;
determine that the adjudication response includes an approval code indicating approval of the second healthcare claim transaction; and
increment a counter indicative of the number of prior healthcare transactions corresponding to dispensing of the first prescription drug.

5. The system of claim 1, wherein the at least one processor is further configured to execute the computer-executable instructions to:
generate a supplemental message including clinical content corresponding to the first prescription drug and the second prescription drug; and
transmit the supplemental message to a contact identifier corresponding to a pharmacy location associated with the healthcare provider computer.

6. The system of claim 1, wherein the healthcare claim transaction is a first healthcare claim transaction, and wherein the at least one processor is further configured to execute the computer-executable instructions to:
determine first patient identifying information and a first healthcare provider identifier included in the first healthcare claim transaction;
receive a second healthcare claim transaction from the healthcare provider computer;
parse the second healthcare claim transaction to determine second patient identifying information, a fourth NDC, a second healthcare provider identifier, and a third claims processor identifier included in the second healthcare claim transaction;
determine that the second healthcare claim transaction is a substitute transaction for the first healthcare claim transaction by executing the computer-executable instructions to:
determine that the first patient identifying information and the second patient identifying information correspond to a same patient identifier;
determine that the fourth NDC matches the second NDC;
determine that the second healthcare provider identifier matches the first healthcare provider identifier;
determine that the third claims processor identifier matches the second claims processor identifier; and
determine that the second healthcare claim transaction is received within a threshold number of days from a date of transmission of the alert message;
generate reporting data indicating that the second prescription drug was selected for dispensing to the patient in lieu of the first prescription drug;
transmit the second healthcare claim transaction to a claims processor computer for adjudication; and
transmit the reporting data to a sponsor computer associated with a healthcare service program sponsor sponsoring a dispensing monitoring service for the first prescription drug.

7. A system, comprising:
at least one memory storing computer-executable instructions; and
at least one processor configured to access the at least one memory and execute the computer-executable instructions to:
receive a claims processor identifier identifying a claims processor;
receive first prescription drug data including a first prescription drug identifier corresponding to a first prescription drug designated for treatment of a health condition;
receive second prescription drug data including a second prescription drug identifier corresponding to a second prescription drug, wherein the second prescription drug is an alternative drug for treating the health condition;
receive, from a healthcare provider computer, a healthcare claim transaction;
determine that the healthcare claim transaction includes the claims processor identifier;
determine that the healthcare claim transaction includes the first prescription drug identifier;
determine patient identifying information included in the healthcare claim transaction;
determine a number of one or more prior healthcare claim transactions corresponding to dispensing of the first prescription drug, wherein each of the one or more prior healthcare claim transactions includes at least a portion of the patient identifying information;
determine that the number of prior healthcare claim transactions is less than a threshold number;
generate an alert message including an indication of the first prescription drug, an indication of the second prescription drug, and an indication that the second prescription drug is available for prescribing as an alternative to the first prescription drug; and
transmit the alert message to the healthcare provider computer.

8. The system of claim 7, wherein the at least one processor is configured to generate the alert message by executing the computer-executable instructions to generate a pre-adjudication rejection of the healthcare claim transaction that includes the alert message and an override reason code.

9. The system of claim 8, wherein the healthcare claim transaction is a first healthcare claim transaction, and wherein the at least one processor is further configured to execute the computer-executable instructions to:
determine first patient identifying information, a healthcare provider identifier, a prescription identifier, and a date of service included in the first healthcare claim transaction;
receive a second healthcare claim transaction from the healthcare provider computer;
determine that the second healthcare claim transaction is a resubmission of the first healthcare claim transaction by executing the computer-executable instructions to:
determine second patient identifying information included in the second healthcare claim transaction;
determine that the first patient identifying information and the second patient identifying information correspond to a same patient identifier; and
determine that the second healthcare claim transaction includes the first prescription drug identifier, the healthcare provider identifier, the prescription identifier, and the date of service;
determine that the second healthcare claim transaction includes an override reason code indicating a reason that the second prescription drug was not selected for dispensing to the patient;
generate reporting data including the override reason code;
transmit the second healthcare claim transaction to a claims processor computer for adjudication; and
transmit the reporting data to a sponsor computer associated with a healthcare service program sponsor sponsoring a dispensing monitoring service for the first prescription drug.

10. The system of claim 9, wherein the at least one processor is further configured to execute the computer-executable instructions to:
receive an adjudication response from the claims processor computer;
determine that the adjudication response includes an approval code indicating approval of the second healthcare claim transaction; and
increment a counter indicative of the number of prior healthcare transactions corresponding to dispensing of the first prescription drug.

11. The system of claim 7, wherein the at least one processor is further configured to execute the computer-executable instructions to:
generate a supplemental message including clinical content corresponding to the first prescription drug and the second prescription drug; and
transmit the supplemental message to a contact identifier corresponding to a pharmacy location associated with the healthcare provider computer.

12. The system of claim 7, wherein the healthcare claim transaction is a first healthcare claim transaction, and wherein the at least one processor is further configured to execute the computer-executable instructions to:
determine first patient identifying information and a healthcare provider identifier included in the first healthcare claim transaction;
receive a second healthcare claim transaction from the healthcare provider computer;
determine that the second healthcare claim transaction corresponds to the first healthcare claim transaction by executing the computer-executable instructions to:
determine second patient identifying information included in the second healthcare claim transaction;
determine that the first patient identifying information and the second patient identifying information correspond to a same patient identifier;
determine that the second healthcare claim transaction includes the healthcare provider identifier and the claims processor identifier; and
determine that the second healthcare claim transaction is received within a threshold number of days from a date of transmission of the alert message;
determine that the second healthcare claim transaction includes the second prescription drug identifier;
generate reporting data indicating that the second prescription drug was selected for dispensing to the patient in lieu of the first prescription drug;
transmit the second healthcare claim transaction to a claims processor computer for adjudication; and
transmit the reporting data to a sponsor computer associated with a healthcare service program sponsor sponsoring a dispensing monitoring service for the first prescription drug.

13. The system of claim 7, wherein the at least one processor is configured to determine the number of one or more prior healthcare claim transactions by executing the computer-executable instructions to determine that each of the prior healthcare claim transactions a) includes the first prescription drug identifier, b) was received during a predetermined period of time, and c) was adjudicated and approved.

14. The system of claim 7, wherein the healthcare claim transaction is a first healthcare claim transaction, and wherein the at least one processor is further configured to execute the computer-executable instructions to:
determine first patient identifying information, a healthcare provider identifier, a prescription identifier, and a date of service included in the first healthcare claim transaction;
receive, from the healthcare provider computer, a second healthcare claim transaction;
determine that the second healthcare claim transaction is a resubmission of the first healthcare claim transaction by executing the computer-executable instructions to:
determine second patient identifying information included in the second healthcare claim transaction;
determine that the first patient identifying information and the second patient identifying information correspond to a same patient identifier; and
determine that the second healthcare claim transaction includes the first prescription drug identifier, the healthcare provider identifier, the prescription identifier, and the date of service;
determine that the second healthcare claim transaction includes a code corresponding to initiation of a patient counseling session;
generate a notification message indicative of the patient counseling session; and
transmit the notification message to a contact identifier associated with an entity designated to perform the patient counseling session.

15. A method, comprising:
receiving, by a service provider system comprising one or more computers, a claims processor identifier identifying a claims processor;
receiving, by the service provider system, first prescription drug data including a first prescription drug identifier corresponding to a first prescription drug designated for treatment of a health condition;
receiving, by the service provider system, second prescription drug data including a second prescription drug identifier corresponding to a second prescription drug, wherein the second prescription drug is an alternative drug for treating the health condition;
receiving, by the service provider system, from a healthcare provider computer, a healthcare claim transaction;
determining, by the service provider system, that the healthcare claim transaction includes the claims processor identifier;
determining, by the service provider system, that the healthcare claim transaction includes the first prescription drug identifier;
determining, by the service provider system, patient identifying information included in the healthcare claim transaction;
determining, by the service provider system, a number of one or more prior healthcare claim transactions corresponding to dispensing of the first prescription drug, wherein each of the one or more prior healthcare claim transactions includes at least a portion of the patient identifying information;
determining, by the service provider system, that the number of prior healthcare claim transactions is less than a threshold number;
generating, by the service provider system, an alert message including an indication of the first prescription drug, an indication of the second prescription drug, and an indication that the second prescription drug is available for prescribing as an alternative to the first prescription drug; and
transmitting, by the service provider system, the alert message to the healthcare provider computer.

16. The method of claim 15, wherein the healthcare claim transaction is a first healthcare claim transaction and generating the alert message comprising generating a pre-adjudication rejection of the first healthcare claim transaction that includes the alert message and an override reason code, the method further comprising:
determining, by the service provider system, first patient identifying information, a healthcare provider identifier, a prescription identifier, and a date of service included in the first healthcare claim transaction;
receiving, by the service provider system, a second healthcare claim transaction from the healthcare provider computer;
determining, by the service provider system, that the second healthcare claim transaction is a resubmission of the first healthcare claim transaction by:
determining second patient identifying information included in the second healthcare claim transaction;
determining that the first patient identifying information and the second patient identifying information correspond to a same patient identifier; and
determining that the second healthcare claim transaction includes the first prescription drug identifier, the healthcare provider identifier, the prescription identifier, and the date of service;
determining, by the service provider system, that the second healthcare claim transaction includes the override reason code, wherein the override reason code indicates a reason that the second prescription drug was not selected for dispensing to the patient;
generating, by the service provider system, reporting data including the override reason code;
transmitting, by the service provider system, the second healthcare claim transaction to a claims processor computer for adjudication; and
transmitting, by the service provider system, the reporting data to a sponsor computer associated with a healthcare service program sponsor sponsoring a dispensing monitoring service for the first prescription drug.

17. The method of claim 16, further comprising:
receiving, by the service provider system, an adjudication response from the claims processor computer;
determining, by the service provider system, that the adjudication response includes an approval code indicating approval of the second healthcare claim transaction; and
incrementing, by the service provider system, a counter indicative of the number of prior healthcare transactions corresponding to dispensing of the first prescription drug.

18. The method of claim 15, wherein the healthcare claim transaction is a first healthcare claim transaction, the method further comprising:
determining, by the service provider system, first patient identifying information and a healthcare provider identifier included in the first healthcare claim transaction;
receiving, by the service provider system, a second healthcare claim transaction from the healthcare provider computer;
determining, by the service provider system, that the second healthcare claim transaction corresponds to the first healthcare claim transaction by:
determining second patient identifying information included in the second healthcare claim transaction;
determining that the first patient identifying information and the second patient identifying information correspond to a same patient identifier;
determining that the second healthcare claim transaction includes the healthcare provider identifier and the claims processor identifier; and
determining that the second healthcare claim transaction is received within a threshold number of days from a date of transmission of the alert message;
determining, by the service provider system, that the second healthcare claim transaction includes the second prescription drug identifier;
generating, by the service provider system, reporting data indicating that the second prescription drug was selected for dispensing to the patient in lieu of the first prescription drug;
transmitting, by the service provider system, the second healthcare claim transaction to a claims processor computer for adjudication; and
transmitting, by the service provider system, the reporting data to a sponsor computer associated with a healthcare service program sponsor sponsoring a dispensing monitoring service for the first prescription drug.

19. The method of claim 15, wherein determining the number of one or more prior healthcare claim transactions comprises determining that each of the prior healthcare claim transactions a) includes the first prescription drug identifier, b) was received during a predetermined period of time, and c) was adjudicated and approved.

20. The method of claim 15, wherein the healthcare claim transaction is a first healthcare claim transaction, the method further comprising:
determining, by the service provider system, first patient identifying information, a healthcare provider identifier, a prescription identifier, and a date of service included in the first healthcare claim transaction;
receiving, by the service provider system, from the healthcare provider computer, a second healthcare claim transaction;
determining, by the service provider system, that the second healthcare claim transaction is a resubmission of the first healthcare claim transaction by:
determining second patient identifying information included in the second healthcare claim transaction;
determining that the first patient identifying information and the second patient identifying information correspond to a same patient identifier; and
determining that the second healthcare claim transaction includes the first prescription drug identifier, the healthcare provider identifier, the prescription identifier, and the date of service;
determining, by the service provider system, that the second healthcare claim transaction includes a code corresponding to initiation of a patient counseling session;
generating, by the service provider system, a notification message indicative of the patient counseling session; and
transmitting, by the service provider system, the notification message to a contact identifier associated with an entity designated to perform the patient counseling session.
